(19) United States
(12) Patent Application Publication
(10) Pub. No.: US 2007/0259282 A1
(43) Pub. Date: Nov. 8, 2007

(54) Electrophotographic toner, image forming method, dye and metal chelate dye

(76) Inventors: Keiko Ishidai, Tokyo (JP); Hidetaka Ninomiya, Tokyo (JP)

Correspondence Address: CANTOR COLBURN, LLP, 55 GRIFFIN ROAD SOUTH, BLOOMFIELD, CT, 06002, US

(21) Appl. No.: 11/800,480

(22) Filed: May 4, 2007

(30) Foreign Application Priority Data
May 8, 2006 (JP) JP2006-128949
Aug. 28, 2006 (JP) JP2006-230264

(51) Int. Cl. G03G 9/08

(52) U.S. Cl. 430/108.21; 430/108.2; 430/108.3

(57) ABSTRACT

An electrophotographic toner is disclosed. The toner is composed of a dye chelatable with a metal represented by the formula (1) and a copper compound represented by the formula (2) and a thermoplastic resin:

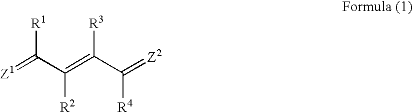

In the formula, R¹, R², R³, and R⁴ each represents a hydrogen atom or a substituent. Z¹ represents a 5 or 6-membered heterocyclic ring containing at least one nitrogen atom, which heterocyclic ring may have a substituent or form a condensed ring. Z² represents a 5 or 6-membered heterocyclic ring which heterocyclic ring may have a substituent or form a condensed ring.

Cu²⁺(X₁)ₘ(X₂)ₙ.W₁ formula (2)

wherein X₁ and X₂ are each a monodentate or didentate ligand, provided that X₁ and X₂ may link with each other which may be the same or different from each other; n and m are each an integer of 0 to 2; W₁ is a counter ion when a counter ion is required for neutralization of charge.

This application claims priority from Japanese Patent Applications No. JP2006-128949 filed on May 8, 2006 and JP2006-230264 filed on Aug. 28, 2006, which are incorporated hereinto by reference.

### FIELD OF THE INVENTION

The present invention relates to toners for use in electrophotography, an image forming method by use thereof, a dye and a metal chelate dye.

### BACKGROUND OF THE INVENTION

Recently, color copying was put to practical use, in which electrostatic latent images of an original are formed through spectral light exposure and are developed with an individual color toner to obtain a colored copy image. Alternatively, respective color copy images are superimposed to obtain a full color copy image. As color toners used therein, there are manufactured color toners of yellow, magenta, cyan and the like, formed of an individual color pigment and/or dye dispersed in a binder resin.

In the foregoing electrophotography, image formation is generally performed according to the following steps. First, light information corresponding to image information is exposed onto a photoreceptor comprised of a photoconductive material through various methods to form an electrostatic latent image on the photoreceptor. Then, the electrostatic latent image formed on the photoreceptor is developed with a charged toner to form a toner image. The toner image is transferred onto an image recording medium (which is usually paper or an intermediate transfer material). The transferred image is fixed on plain paper using a thermal fixing apparatus.

In the image forming method using electrophotography as described above, an electrostatic latent image formed on the photoreceptor corresponds to image information separated to an individual colors of yellow, magenta, cyan and black and are developed with a toner having the same color as the respective image data. The development is repeated for each color to form a full color image, namely up to four repetitions.

Commonly known organic pigments and dyes have been used as coloring material used for electrophotographic toners but they exhibit various defects. For instance, organic pigments, compared to dyes, are generally superior in heat resistance and light resistance, and exist in a toner in the form of a particle dispersion, resulting in enhanced covering power, leading to lowered transparency. Dispersibility of a pigment is generally poor so that transparency is vitiated and hue is lowered, resulting in deteriorated color reproduction of images.

To make it possible to visually recognize color of the lowest layer of overlaid toner layers without being concealed by upper toner layers, transparency of a fixed toner is required, and dispersibility or coloring power of a coloring agent is needed to maintain color reproducibility of the original.

To overcome defects of pigments as described above, there were proposed, for example, a means for enhancing transparency whereby primary particles exhibited a pigment dispersion diameter of the sub-micrometer order without forming aggregated secondary particles, by using a flashing method as a means for dispersing a pigment, as disclosed in JP-A No. 9-26673 and JP-A No. 11-160914 (hereinafter, the term, JP-A refers to Japanese Patent Application Laid Open to Public Publication) and also a means for improving the electrostatic-charging property, fixability and image uniformity by covering pigment particles with a binding resin and a shelling resin.

However, even when outputted by using the proposed toners, it is difficult to obtain sufficient transparency in the case of a toner using pigments.

In a color image forming apparatus, all of color reproduction is theoretically feasible through subtractive mixture of the three primary colors of yellow, magenta and cyan. However, the color-reproducible region or hue is lowered by spectral characteristics of a pigment dispersed in a thermoplastic resin or by color mixing property when overlaying different color toners, so that there still remain many problems to achieve faithful color reproduction of an original.

There were also disclosed toners using dyes, and toners using a mixture of dyes and pigments as described in JP-A No. 5-11504 and JP-A No. 5-34980.

In a toner using a dye, the dye exists in a state of being dissolved in a binding resin for the toner, resulting in superior transparency and hue but exhibiting defects such as inferior light resistance and heat resistance of the pigments. With respect to heat resistance, in addition to lowering in density due to degradation of a dye, problems were produced such that the dye sublimed and easily stained the machine and additionally the dye was dissolved in silicone oil used for fixing and finally melted onto the heated roller, causing the off-setting phenomenon while fixing toner images by a heated roller.

To overcome such defects of dyes, there were proposed, for example, a technique of using metal chelate dyes to allow light resistance or sublimation property to be compatible with color reproduction, as described in JP-A No. 10-20559.

The toner containing the metal chelate dye mentioned above is excellent in stability against light, but is insufficient in color reproduce ability because the reflection spectrum becomes different after coating on OHP or paper caused by coagulation, and further improvement of chroma is expected.

A means for compatible color reproduction with stability against light is proposed by employing a metal chelate dye of tetramethine dye for the colorant of toner to improve color reproduce ability of metal chelate dye in, for example, JP-A 2001-159832, Patent document No. 6. However the disperse property and light stability are not sufficient and further improvement is expected.

### SUMMARY OF THE INVENTION

It is an object of the invention to overcome the foregoing problems.

Thus, it is an object of the invention to provide an electrophotographic toner achieving superior coloring without exhibiting any difficulty in dispersibility in thermoplastic resin, while exhibiting superior transparency and color reproducibility and enhanced heat resistance, electrostatic-charging property and off-set resistance and an image forming method by use of the electrophotographic toner.

It is also an object of the invention to provide a novel dye capable of chelating with a metal and a metal chelate dye.

Preferable embodiments are described.
1. An electrophotographic toner comprising a dye chelatable with a metal represented by the formula (1) and a copper compound represented by the formula (2) and a thermoplastic resin:

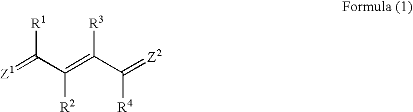

In the formula, R¹, R², R³, and R⁵ each represents a hydrogen atom or a substituent. Z¹ represents a 5 or 6-membered heterocyclic ring containing at least one nitrogen atom, which heterocyclic ring may have a substituent or form a condensed ring. Z² represents a 5 or 6-membered heterocyclic ring which heterocyclic ring may have a substituent or form a condensed ring.

Cu²⁺(X₁)ₘ(X₂)ₙ.W₁ formula (2)

wherein X₁ and X₂ are each a monodentate or didentate ligand, provided that X₁ and X₂ may link with each other which may be the same or different from each other; n and m are each an integer of 0 to 2; W₁ is a counter ion when a counter ion is required for neutralization of charge.
2. The electrophotographic toner of item 1 described above, wherein Z¹ is represented by formula (3) or formula (4)

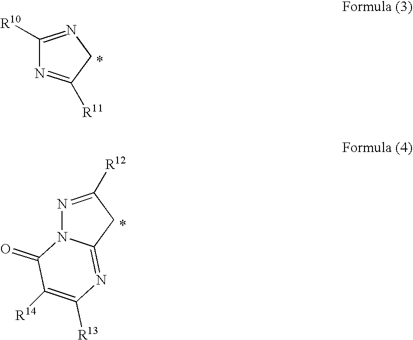

In the formula, R¹⁰, R¹¹, R¹², R¹³ and R¹⁴ each represents a hydrogen atom or a substituent, and at least one of R¹⁰ and R¹¹ is a group capable of forming a two- or more-dentate bond with a nitrogen atom in the formula (3), at least one of R¹² and R¹³ is a group capable of forming a two- or more-dentate bond with a nitrogen atom in the formula (4), * shows a position to bond with a carbon atom bonding to the dye represented by formula (1).
3. The electrophotographic toner of item 1 described above, wherein Z¹ is represented by formula (5) or (6).

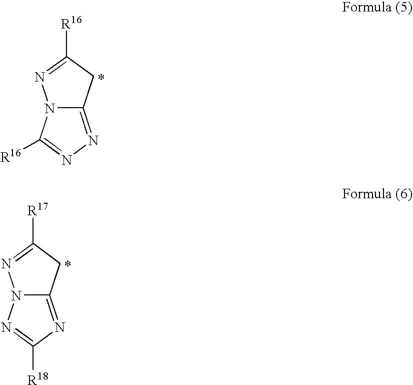

In the formula, R¹⁵, R¹⁶, R¹⁷ and R¹⁸ each represents a hydrogen atom or a substituent, and at least one of R¹⁵ and R¹⁶ is a group capable of forming a two- or more-dentate bond with a nitrogen atom in the formula (5), at least one of R¹² and R¹³ is a group capable of forming a two- or more-dentate bond with a nitrogen atom in the formula (6), * shows a position to bond with a carbon atom bonding to the dye represented by formula (1).
4. The electrophotographic toner of item 1 described above, wherein Z¹ is represented by formula (5) or (6).

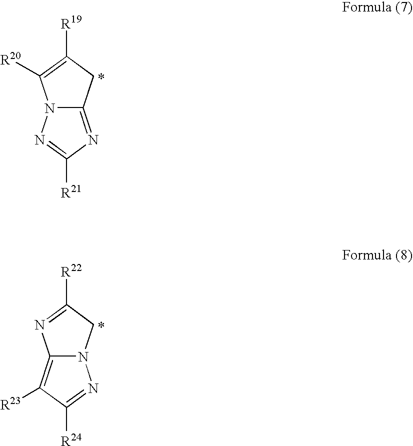

In the formula, R¹⁹, R²⁰, R²¹, R²², R²⁴ and R²⁴ each represents a hydrogen atom or a substituent, and at least one of R²⁰ and R²¹ is a group capable of forming a two- or more-dentate bond with a nitrogen atom in the formula (7), at least one of R²², R²³ and R²⁴ is a group capable of forming a two- or more-dentate bond with a nitrogen atom in the formula (6), * shows a position to bond with a carbon atom bonding to the dye represented by formula (1).
5. The electrophotographic toner of item 1 described above, wherein Z¹ is represented by formula (9).

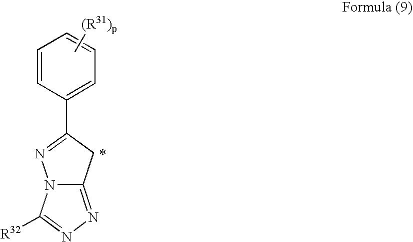

In the formula, R³¹ and R³² each represents a hydrogen atom or a substituent, and at least one of R³¹ and R³² is a group capable of forming a two- or more-dentate bond with a nitrogen atom in the formula (9), p is an integer of 0 to 5, and * shows a position to bond with a carbon atom bonding to the dye represented by formula (1).
6. The electrophotographic toner of item 2 described above, wherein the group capable of forming a two- or more-dentate bond with the nitrogen atom mentioned above is represented by formula (10) or (11).

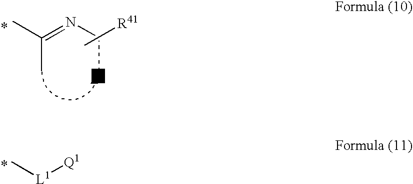

In the formula, Z³ is an atomic group necessary to form a 5- or 6-membered nitrogen-containing heterocyclic ring together with a nitrogen atom, R⁴¹ represents a hydrogen atom or a substituent, L¹ is a linkage group having one or two carbon atoms or a part of a ring structure, Q¹ is a hydroxyl, alkoxy, aryloxy, alkylsulfonylamino, or arylsulfonylamino group.
7. The electrophotographic toner of item 2 described above, wherein Z² in the formula (1) is represented by the following formula (12) to (16).

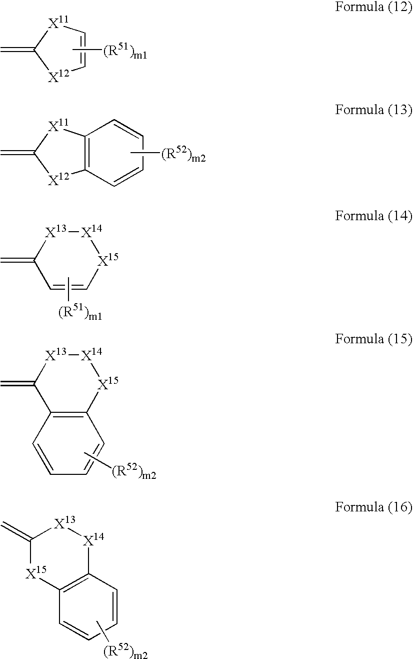

In the formulae, R⁵¹ and R⁵² are each a hydrogen atom or a substituent; m1 is an integer of 0 to 2, and m2 is an integer of 0 to 4. X¹¹ and X¹² are each an oxygen or sulfur atom, —(NR⁵³)— or —CR⁵⁴R⁵⁵—, at least one of X¹¹ and X¹² is —(NR⁵³)—, and R⁵³, R⁵⁴ and R⁵⁵ each a hydrogen atom or a substituent. X¹³, X¹⁴ and X¹⁵ are each an oxygen or sulfur atom, —(NR⁵⁶)— or —C(R⁵⁷)═, at least one of X¹¹ and X¹² is an oxygen or sulfur atom, or —(NR⁵⁶)—. R⁵⁶ and R⁵⁷ are each a hydrogen atom or a substituent.
8. The electrophotographic toner of item 1 described above, wherein at least one of X1 and X2 is represented by the formula (17).

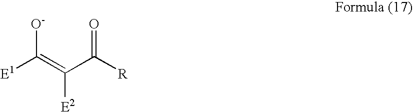

In the formula E₁ and E₂ are each an electron-withdrawing group exhibiting a Hammett substituent constant (σp) of 0.1 to 0.9; and R is an alkyl group, an aryl group, a heterocyclic group, an alkoxy group or an amino group, which may be substituted with a substituent.
9. An electrophotographic toner containing colored micropartiles containing a dye dispersed in a thermoplastic resin, wherein the colored microparticles contain the dye chelatable with a metal represented by one of the formula (1) described above and the copper compound represented by the formula (2) described above.
10. The electrophotographic toner of item 9 described above, wherein the colored microparticles further contains a resin different from the thermoplastic resin.
11. The electrophotographic toner of item 9 described above, wherein the colored microparticles comprises;

a core containing the colored microparticles containing the dye chelatable with a metal represented by one of the formula (1) described above, the copper compound represented by the formula (2) described above, and a resin having different composition from the thermoplastic resin, and

a shell resin covering the core.
12. An image forming method comprising: developing an electrostatic latent image formed on an electrostatic latent image carrying body with a toner to form a toner image and transferring the toner image to a transfer material, wherein the toner as described above is employed.
13. A dye chelatable with metal represented by formula (18).

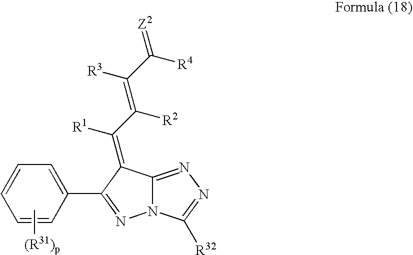

In the formula, R¹-R⁴ and Z¹² are same as R¹-R⁴ and Z² defined in the formula (1), R³¹ and R³² are each a substituent and at least one of R³¹ and R³² is a group capable of forming a two- or more-dentate bond with a nitrogen atom in the formula (18), and p is an integer of 0-5.
14. A metal chelate dye which contains the dye chelatable with metal represented by the formula (18) as at least one of a ligand.

### BRIEF EXPLANATION OF THE DRAWINGS

FIG. 1 illustrates the section of a toner particle containing colored microparticles dispersed in thermoplastic resin.

FIG. 2 illustrates the section of a colored microparticle having a core/shell structure comprising an interior (core) covered with resin (shell).

FIG. 3 shows an absorption wave spectrum of the dye MD-16 according to the invention.

### DETAILED DESCRIPTION OF THE INVENTION

The toner of the invention, hereinafter sometimes simply referred to as toner, is composed of microparticles, comprising a thermoplastic resin, hereinafter referred to as a binder resin, and a dye having a specified structure and a copper compound having a specified structure. The dye and the copper compound are incorporated in the binder resin and, preferably dispersed in the binder resin. According to one of the preferable embodiment, the dispersing is carried out by emulsion dispersing in an aqueous medium.

In one of the another embodiment, the electrophotographic toner of the invention comprise a colored particle dispersed in the thermoplastic resin, and the colored particle is prepared by emulsion dispersing a resin different in the composition from the thermoplastic resin, the dye having the specified structure and the copper compound in the aqueous medium, which is different from usually known one composed of a binder resin and a dye directly dispersed or dissolved in the binder resin.

As a result of investigation for dissolving the above problems, it is found that the toner is excellent in the color and the fastness of image, which comprises the thermoplastic resin and, containing therein, the dye having the specified structure and the copper compound having the specified structure.

A dye chelatable with a metal represented by the formula (1) is described.

The substituent represented by R¹, R², R³ and R⁴ is each a hydrogen atom or a substituent. Examples of such a substituent include an alkyl group (e.g., methyl, ethyl, propyl, isopropyl, butyl, tert-butyl, pentyl, iso-pentyl, hexyl, octyl, 2-ethylhexyl, dodecyl, tridecyl, tetradecyl, pentadecyl), a cycloalkyl group (e.g., cyclopentyl, cyclohexyl), an alkenyl group (e.g., vinyl, allyl), an alkynyl group (e.g., ethynyl, propargyl), an aryl group (e.g., phenyl, naphthyl), a heteroallyl group (e.g., furyl, thienyl, pyrrolyl, pyridyl, pyridazyl, pyrimidyl, pyrazyl, triazyl, imidazolyl, pyrazolyl, thiazolyl, benzimidazolyl, benzoxazolyl, quinazolyl, phthalazyl), a heterocyclic group (e.g., pyrrolidyl, imidazolidyl, morpholyl, oxazolidyl), an alkoxy group (e.g., methoxy, ethoxy, propoxy, pentyloxy, hexyloxy, octyloxy, dodecyloxy), a cycloalkoxy group (e.g., cyclopentyloxy, cyclohexyloxy), an aryloxy group (e.g., phenoxy, naphthyloxy), an alkylthio group (e.g., methylthio, ethylthio, propylthio, pentylthio, hexylthio, octylthio, dodecylthio), a cycloalkylthio group (e.g., cyclopentylthio, cyclohexylthio), an arylthio group (e.g., phenylthio, naphthylthio), an alkoxycarbonyl group (e.g., methyloxycarbonyl, ethyloxycarbonyl, butyloxycarbonyl, octyloxycarbonyl, dodecyloxycarbonyl), an aryloxycarbonyl group (e.g., phenyloxycarbonyl, naphthyloxycarbonyl), a sulfamoyl group (e.g., aminosulfonyl, methylaminosulfonyl, dimethylaminosulfonyl, butylaminosulfonyl, hexylaminosufonyl, cyclohexylaminosulfonyl, octylaminosulfonyl, dodecylaminosulfonyl, phenylaminosulfonyl, naphthylaminosulfonyl, 2-pyridylaminosulfonyl), an acyl group (e.g., acetyl, ethylcarbonyl, propylcarbonyl, pentylcarbonyl, cyclohexylcarbonyl, octylcarbonyl, 2-ethylhexylcarbonyl, dodecylcarbonyl, benzoyl, naphthylcarbonyl, pyridylcarbonyl), an acyloxy group (e.g., acetyloxy, ethylcarbonyloxy, butylcarbonyloxy, octylcarbonyloxy, dodecylcarbonyloxy, phenylcarbonyloxy), an amido group (e.g., methylcarbonylamino, ethylcarbonylamino, dimethylcarbonylamino, propylcarbonylamino, pentylcarbonylamino, cyclohexylcarbonylamino, 2-ethylhexylcarbonylamino, octylcarbonylamino, dodecylcarbonylamino, trifluoromethylcarbonylamino, phenylcarbonylamino, naphthylcarbonylamino), a carbamoyl group (e.g., aminocarbonyl, methylaminocarbonyl, dimethylaminocarbonyl, propylaminocarbonyl, pentylaminocarbonyl, cyclohexylaminocarbonyl, octylaminocarbonyl, 2-ethylhexylaminocarbonyl, dodecylaminocarbonyl, phenylaminocarbonyl, naphthylaminocarbonyl, 2-pyridylaminocarbonyl), a ureido group (e.g., methylureido, ethylureido, pentylureido, cyclohexylureido, octylureido, dodecylureido, phenylureido, naphthylureido, 2-pyridylureido), a sufinyl group (e.g., methylsulfinyl, ethylsulfinyl, butylsulfinyl, cyclohexylsulfinyl, 2-ethylhexylsulfinyl, dodecysulfinyl, phenylsufinyl, naphthylsulfinyl, 2-pyridylsulfiny), an alkylsulfonyl group (e.g., methylsulfonyl, ethylsulfonyl, butylsulfinyl, cyclohexylsulfinyl, 2-ethylhexylsulfinyl, dodecylsufonyl), an arylsulfonyl group (e.g., phenylsulfonyl, naphthylsulfonyl, 2-pyridylsulfonyl), an amino group (e.g., amino, ethylamino, dimethylamino, diethylamino, butylamino, cyclopentylamino, 2-ethylhexylamino, dodecylamino, anilino, naphthylamino, 2-pyridylamino), cyano group, nitro group and a halogen atom (e.g., fluorine atom, chlorine atom, bromine atom), a halogen alkyl group (e.g., fluoromethyl, trifluoromethyl, chloromethyl, trichloromethyl, perfluoromethyl).

The preferable examples are a halogen atom (e.g., fluorine atom, chlorine atom, bromine atom), an alkyl group having 1-8 carbon atoms (e.g., methyl, ethyl, propyl, butyl, pentyl, iso-pentyl, 2-ethylhexyl, octyl), an aryl group (e.g., phenyl, naphthyl), a heteroaryl group (e.g., imidazolyl, thiazolyl, benzoxyazolyl, pyridyl, pyrrolyl, pyrimidyl), an acyl group (e.g., acetyl, benzyl), an amino group (e.g., amino, dimethylamino, diethylamino), and alkoxy group (e.g., methoxy, ethoxy, propoxy) among the above mentioned substituents.

In Formula 1, Z′ is a group of atoms necessary for forming a 5- or 6-member heterocyclic ring containing a nitrogen atom, which may have a substituent and may form a condensed ring together with the substituent. In concrete, a group represented by Formulas 3 to 9 is preferable.

In Formula 3, R¹⁰ and R¹¹ are each independently a hydrogen atom or a substituent. As the substituent, groups the same as those represented by the foregoing R¹ to R⁴ can be cited.

At least one of R¹l and R¹² is a group capable of forming a bi- or more-dentate coordination bond together with the nitrogen atom in Formula 3. The group capable of forming the coordination bond is a group containing an atom having an unshared electron pare. Concrete examples of such the substituent include a heterocyclic group, a hydroxyl group, a carbonyl group, an oxycarbonyl group, a carbamoyl group, an alkoxyl group, a heterocycloxy group, a carbonyloxy group, a urethane group, a sulfonyloxy group, an amino group, an imino group, a sulfonylamino group, an acylamino group, an ureido group, a sulfonyl group, an alkylthio group and a heterocyclothio group. The group capable of forming a bi- or more-dentate coordination bond together with the nitrogen atom in Formula 3 is one capable of forming a 5- or 6-member ring together with the nitrogen atom of Formula 3 and a metal ion by coordination bond.

As the group capable of forming the bi- or more-dentate bond is preferably a group represented by Formula 10 or 11.

In Formula 10, Z³ represents an atomic group capable of forming a 5- or 6-member nitrogen containing aromatic heterocyclic ring. Concrete examples of that include a pyrrole ring, a pyrazole ring, an imidazole ring, a triazole ring, a thiazole ring, an isothiazole ring, an oxazole ring, an isooxazole ring, a pyridine ring, a pyrazine ring, a pyrimidine ring, a pyridazine ring and a triazine ring. Among them, the pyrazole ring, pyridine ring and pyrazine ring are preferable. These nitrogen-containing aromatic heterocyclic rings may have a substituent. As the substituent, groups the same as those foregoing substituents represented by R¹ to R⁴ are applicable. Among them, a hydrogen atom, a halogen atom, an alkyl group and an alkoxyl group are preferable.

In Formula 11, Q¹ is a hydroxyl group, an alkoxy group, an aryloxy group, an amino group, an alkylsulfonylamino group or an arylsulfonylamino group, and preferably the hydroxyl group, alkoxy group or alkylsulfonylamino group. L¹ is a linking group or a part of a ring structure each having one or two carbon atoms such as a substituted on unsubstituted methylene, ethylene or ethine group or a group represented by the following Formula 19.

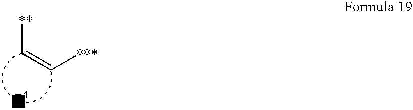

In Formula 19, Z⁴ is a 5- or 6-member aromatic or heterocyclic ring which may have a substituent and is bonded with the carbon atom adjacent to Z¹ in Formula 1 at the position of ** and with Q¹ at the position of * * * .

L¹ is preferably a methylene group and the ring represented by Z⁴ in Formula 19 is preferably a benzene ring or a pyridine ring. The ring structure may have a substituent. As the substituent, a halogen atom, an alkoxy group, an amino group, an acylamino group, a sulfonylamino group and a ureido group are preferable and the halogen atom, alkoxyl group, amino group and acylamino group are more preferable.

In Formula 3, both of R¹⁰ and R¹¹ are preferably the group capable of forming a bi- or more-dentate coordination bond together with the nitrogen atom in Formula 3

When one of R¹⁰ and R¹¹ is not the group capable of forming bi- or more-dentate coordination bond, such the group is preferably a hydrogen atom, an alkyl group, an aryl group, a heterocyclic group, a carbamoyl group, an alkoxycarbonyl group, a cyano group, a sulfamoyl group, an alkylsulfonyl group or an arylsulfonyl group, and more preferably the aryl group, heterocyclic group, carbamoyl group, alkoxycarbonyl group or cyano group.

In Formula 4, R¹² to R¹⁴ are each independently a hydrogen atom or a substituent. As the substituent, groups the same as the substituents represented by the fore going R¹ to R⁴ are applicable.

In Formula 4, at least one of R¹² and R¹³ is a group capable of forming a bi- or more-dentate coordination bond together with the nitrogen atom in Formula 4. The group capable of forming the coordination bond is synonymous for that in Formula 3 and preferably a group represented by the foregoing Formula 10 or 11.

When one of R¹² and R¹³ is not the group capable of forming bi- or more-dentate coordination bond, such the group is preferably a hydrogen atom, an alkyl group, an aryl group, a heterocyclic group, a carbamoyl group, an alkoxycarbonyl group, a cyano group, a sulfamoyl group, an alkylsulfonyl group or an arylsulfonyl group, and more preferably the aryl group, heterocyclic group, carbamoyl group, alkoxycarbonyl group, or cyano group.

In Formula 5, R¹⁵ and R¹⁶ are each independently a hydrogen atom or a substituent. As the substituent, groups the same as those represented by the forgoing R¹ to R⁴ are applicable. The substituent further may have a substituent the same as those represented by R¹ to R⁴.

At least one of R¹⁵ and R¹⁶, preferably R¹⁶, is a group capable of forming a bi- or more dentate coordination bond together with the nitrogen atom in Formula 5. The group capable of forming the coordination bond is synonymous for that in Formula 3 and preferably a group having the structure represented by Formula 10 or 11.

When one of R¹⁵ and R¹⁶ is not the group capable of forming bi- or more-dentate coordination bond, such the group is preferably a hydrogen atom, an alkyl group, an alkenyl group, an aryl group, a heterocyclic group, an acylamino group, an alkylsulfonylamino group, an arylsulfonylamino group, an amino group, an alkylthio group, an arylthio group, an alkoxy group, an aryloxy group, a ureido group, an alkoxycarbonylamino group, a carbamoyl group, a carboxyl group or an alkoxycarbonyl group, and more preferably the alkyl group particularly a methyl group, a t-butyl group or a trifluoromethyl group, aryl group, carbamoyl group or alkoxycarbonyl group, and further preferably the aryl group.

In Formula 6, R¹⁷ and R¹⁸ are each independently a hydrogen atom or a substituent. As the substituent, groups the same as those represented by the forgoing R¹ to R⁴ are applicable. The substituent further may have a substituent the same as those represented by R¹ to R⁴.

At least one of R¹⁷ and R¹⁸, preferably R¹⁸, is a group capable of forming a bi- or more-dentate coordination bond together with the nitrogen atom in Formula 5. The group capable of forming the coordination bond is synonymous for that in Formula 3 and preferably a group having the structure represented by Formula 10 or 11.

When one of R¹⁷ and R¹⁸ is not the group capable of forming bi- or more-dentate coordination bond, such the group is preferably a hydrogen atom, an alkyl group, an alkenyl group, an aryl group, a heterocyclic group, an acylamino group, an alkylsulfonylamino group, an arylsulfonylamino group, an amino group, an alkylthio group, an arylthio group, an alkoxy group, an aryloxy group, a ureido group, an alkoxycarbonylamino group, a carbamoyl group, a carboxyl group or an alkoxycarbonyl group, and more preferably the alkyl group particularly a methyl group, a t-butyl group or a trifluoromethyl group, aryl group, carbamoyl group or alkoxycarbonyl group, and further preferably the aryl group.

In Formula 7, R¹⁹ to R²¹ are each independently a hydrogen atom or a substituent. As the substituent, groups the same as those represented by the forgoing R¹ to R⁴ are applicable.

At least one of R²⁰ and R²¹, preferably R²¹, is a group capable of forming a bi- or more-dentate coordination bond together with the nitrogen atom in Formula 5. The group capable of forming the coordination bond is synonymous for that in Formula 3 and preferably a group having the structure represented by Formula 10 or 11.

When one of R¹⁷ and R¹⁸ is not the group capable of forming bi- or more-dentate coordination bond, such the group and R¹⁹ are each preferably a hydrogen atom, an alkyl group, an aryl group, a heterocyclic group, a carbamoyl group, an alkoxycarbonyl group, an aryloxycarbonyl group or a nitro group, and more preferably the alkoxy carbonyl group or a cyano group.

In Formula 8, R²² to R²⁴ are each independently a hydrogen atom or a substituent. As the substituent, groups the same as those represented by the forgoing R¹ to R⁴ are applicable.

R²² to R²⁴ are each a group capable of forming a bi- or more-dentate coordination bond together with the nitrogen atom in Formula 5 and R²⁴ is preferably the group capable of forming the coordination bond. The group capable of forming the coordination bond is synonymous for that in Formula 3 and preferably a group having the structure represented by Formula 10 or 11.

When one or two of the groups represented by Formula 8 is not the group capable of forming bi- or more-dentate coordination bond, such the group or groups are preferably a hydrogen atom, an alkyl group, an aryl group, a heterocyclic group, a carbamoyl group, an alkoxycarbonyl group, an aryloxycarbonyl group or a nitro group, and more preferably the alkoxy carbonyl group or a cyano group.

Among the metal and the dye capable of chelating the metal of the invention represented by Formula 1, ones having a structure in which Z¹ is represented by Formula 5 are preferable. Among them, the structure represented by Formula 9 is more preferable, such the compound singularly improves the light fastness.

As the substituent represented by R³¹ and R³² in Formula 9, groups the same as those represented by the foregoing R¹ to R⁴ are applicable. At least one of R³¹ and R³² is a group capable of forming a bi- or more-dentate coordination bond together with the nitrogen atom of Formula 9 and R³² is preferably such the group.

The group capable of forming a bi- or more-dentate together with the nitrogen atom in Formula 9 is a group synonymous for the group capable of forming a coordination bond in the foregoing Formula 3 and preferably has the structure represented by Formula 10 or 11. p is an integer of from 0 to 5 and preferably 0, 1 or 2.

In Formula 1, Z² is a 5- or 6-member heterocyclic group which may be substituted or unsubstituted. As the substituent, groups the same as those represented by R¹ to R⁴ are applicable.

Z² is preferably a group represented by Formulas 12 to 16.

In Formulas 12 to 16, R⁵¹ and R⁵² are each independently a hydrogen atom or a substituent. As the substituent, groups the same as those represented by R¹ to R⁴ are applicable. R⁵¹, R⁵² and R⁵³ are each preferably a hydrogen atom, a halogen atom, an alkyl group, an aryl group, an aryl group, an alkoxy group, an aryloxy group, a thioalkyl group, a thioaryl group, an amino group, an alkylamino group, a dialkylamino group and anilino group, and more preferably the hydrogen atom, alkyl group, alkoxy group and thioalkyl group.

m1 is an integer of from 0 to 2, and plural R⁵¹s may be the same with or different from each other when m1 is 2 or more. m1 is preferably 1 or 2 and more preferably 2. m2 is an integer of from 0 to 4, and plural R⁴¹s may be the same with or different from each other when m2 is 2 or more. Plural R⁵²S may be form a condensed ring by linking with together. m2 is preferably an integer of from 0 to 2.

X¹¹ and X¹² are each an oxygen atom, a sulfur atom, an —(NR⁵³)— group or a —CR⁵⁴R⁵⁵— group and at least one of X¹¹ and X¹² is the —(NR⁵³)— group. R⁵³, R⁵⁴ and R⁵⁵ are each independently a hydrogen atom or a substituent. As the substituent, groups the same as those represented by R¹ to R⁴ are applicable. The substituent further may have a substituent the same as those represented by R¹ to R⁴. R⁵³ is preferably an alkyl group having 1 to 18 carbon atoms and more preferably an unsubstituted alkyl group having 1 to 12 carbon atoms. At least one of R⁵⁴ and R⁵⁵ is preferably an alkyl group and more preferably both of them are an alkyl group. It is more preferable that at least one of X¹¹ and X¹² is the —(NR⁵³)— group and the other is the sulfur atom or —CR⁵⁴R⁵⁵— group.

X¹³, X¹⁴ and X¹⁵ is an oxygen atom, a sulfur atom, an —(NR⁵⁶)— group or a —C(R⁵⁷)═ group and at least one of X¹³ to X¹⁵ is the oxygen atom, sulfur atom, or —(NR⁵⁶)— group. R⁵⁶ and R⁵⁷ are each independently a hydrogen atom or a substituent. As the substituent, groups the same as those represented by R¹ to R⁴ are applicable. R⁵⁶ is preferably an alkyl group and more preferably an unsubstituted alkyl group. R⁵⁷ is preferably a hydrogen atom, a halogen atom, an alkyl group, an aryl group or an alkoxy group.

Typical concrete examples of the dye capable of chelating with metal according to the invention are shown below, but the invention is not limited to the following examples. When the compound has position isomers, one of them is described below as a typical form, and the position isomers other than the described one are included in the compounds of the invention. Dyes in which Z¹ is one represented by Formula 9 correspond to D-85 to D-120.

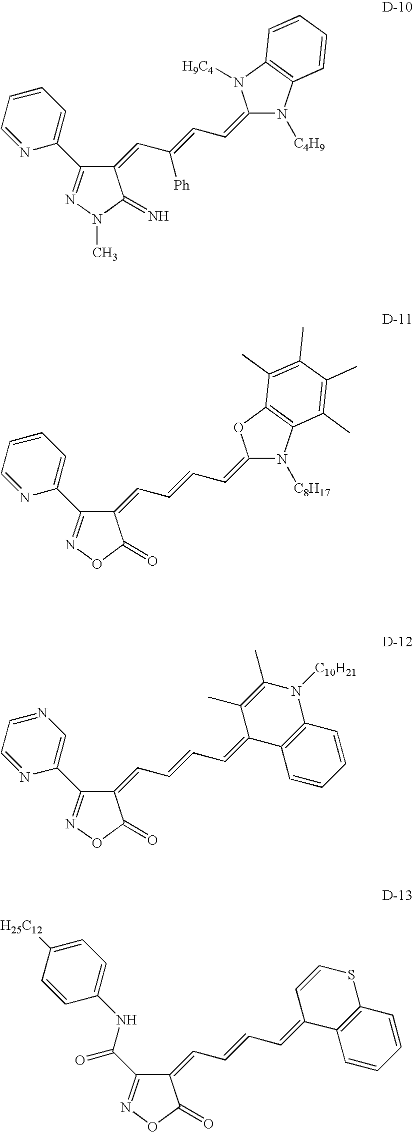

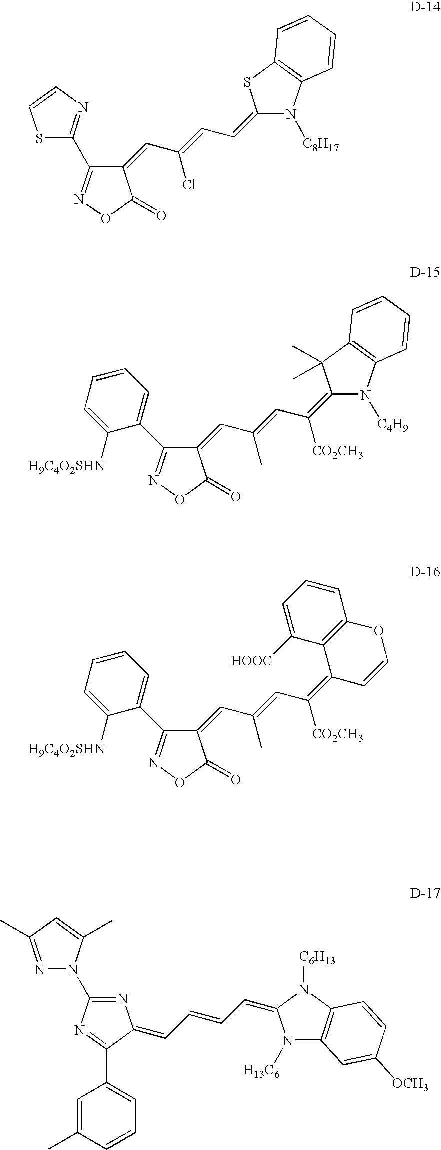

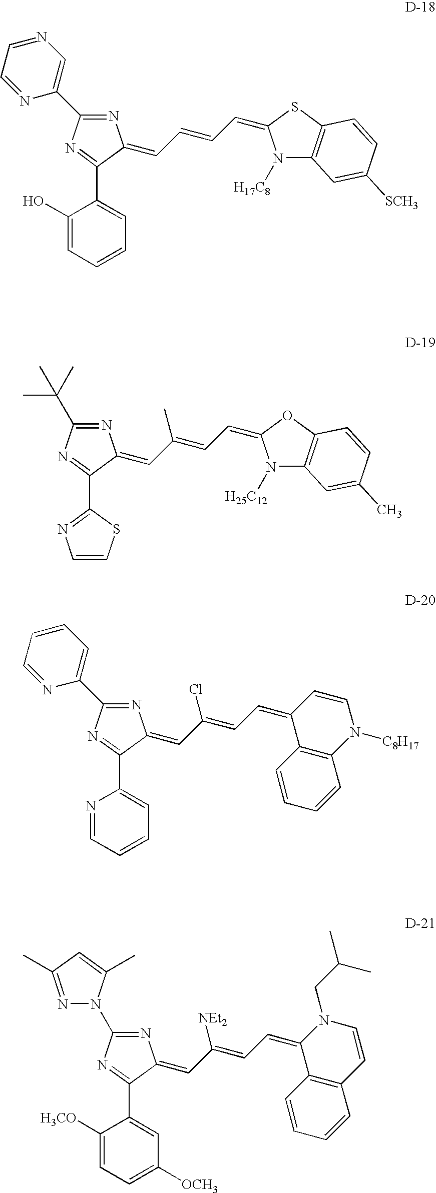

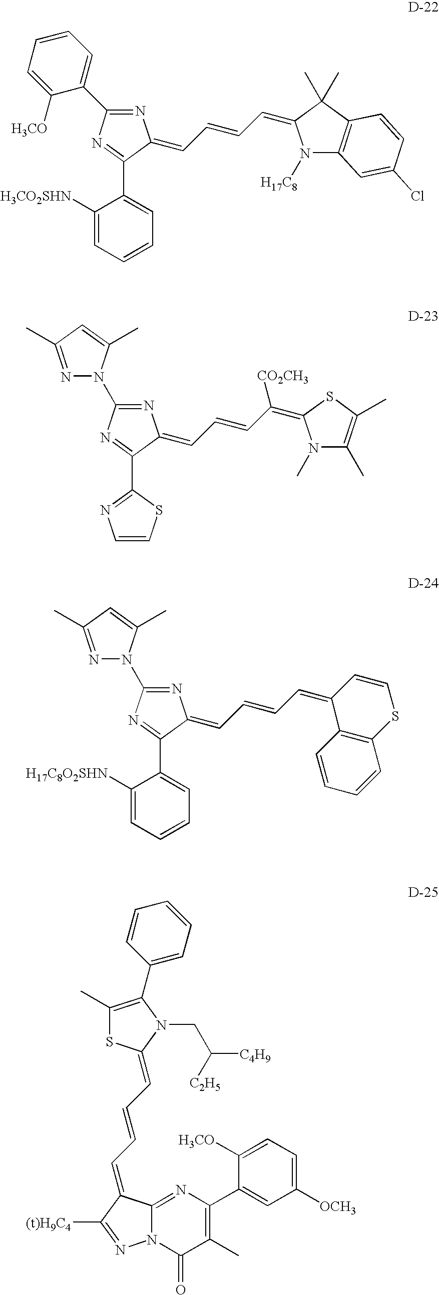

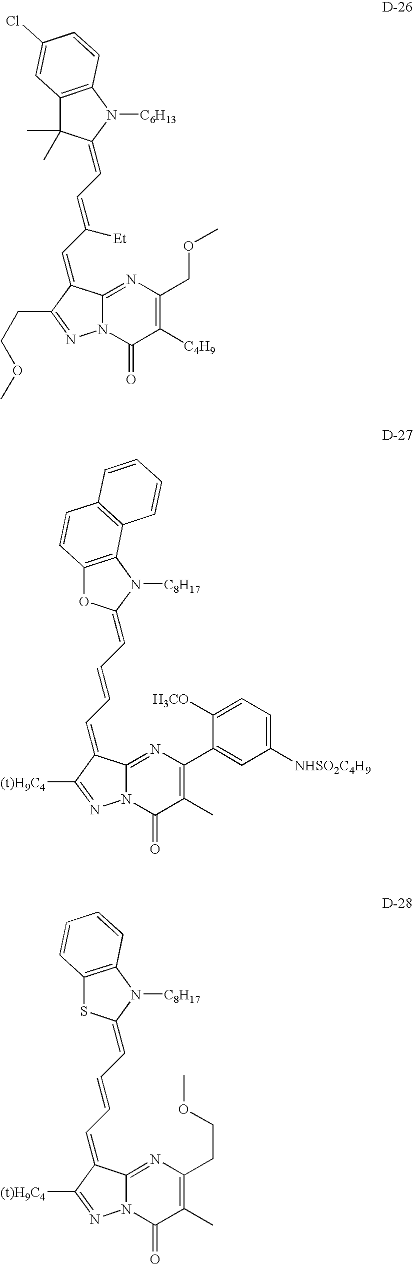

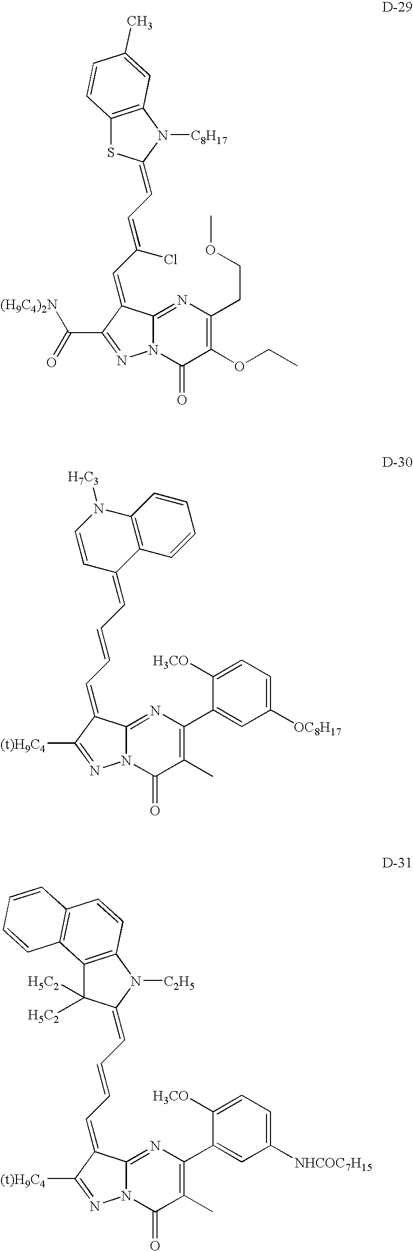

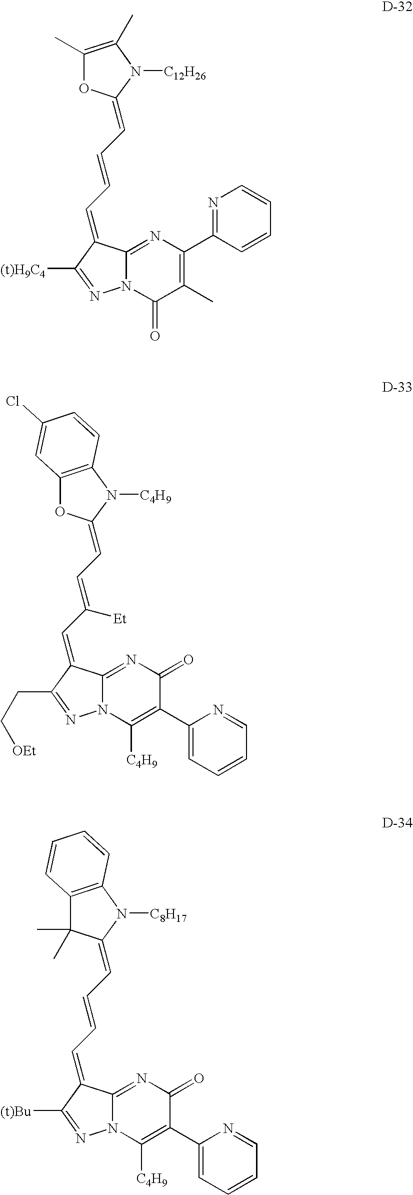

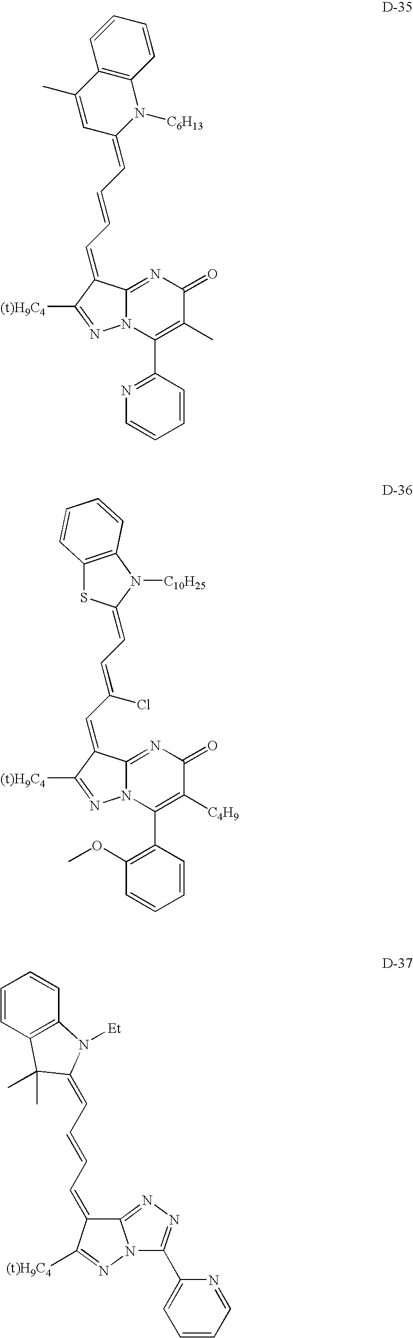

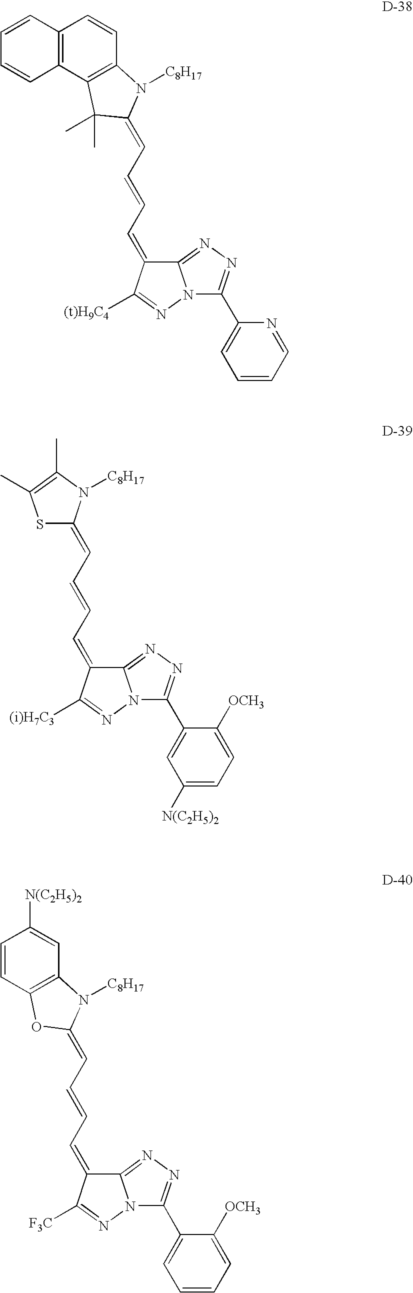

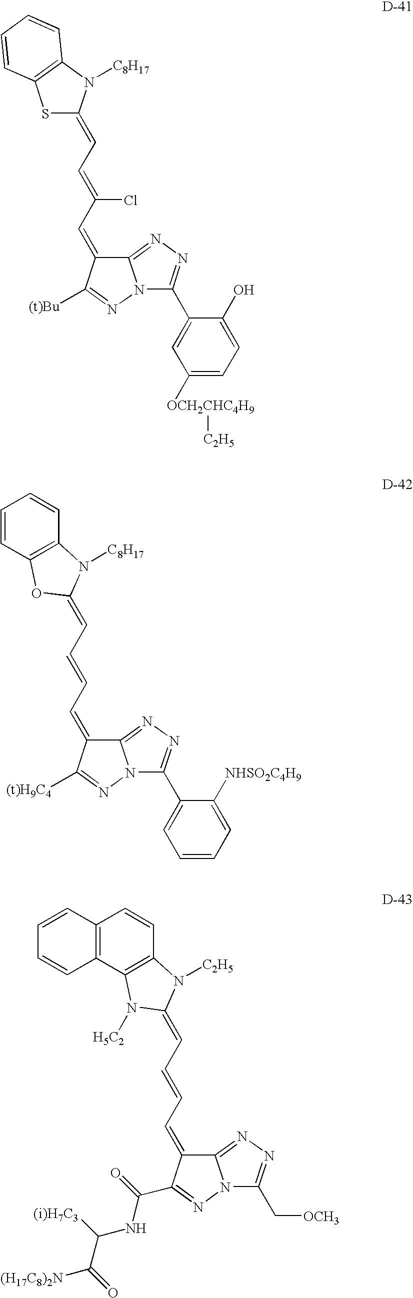

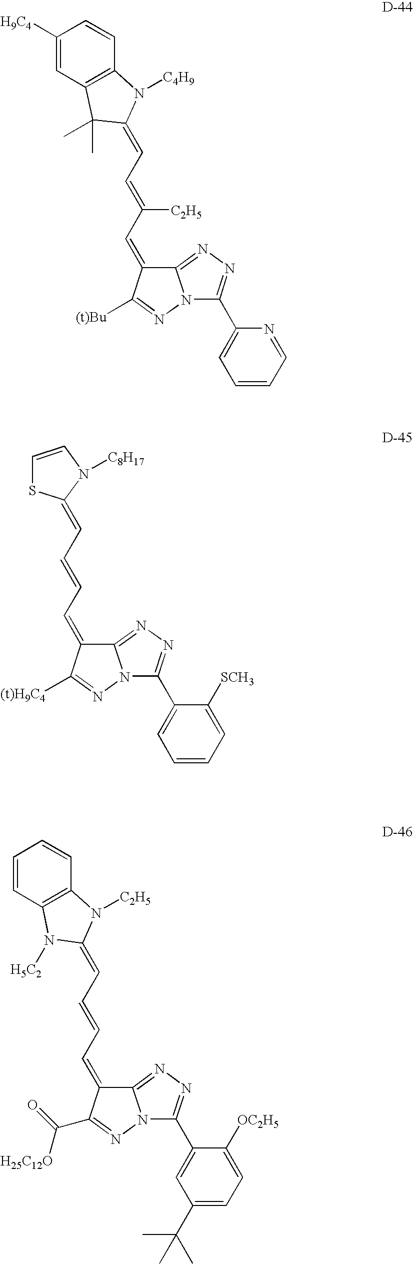

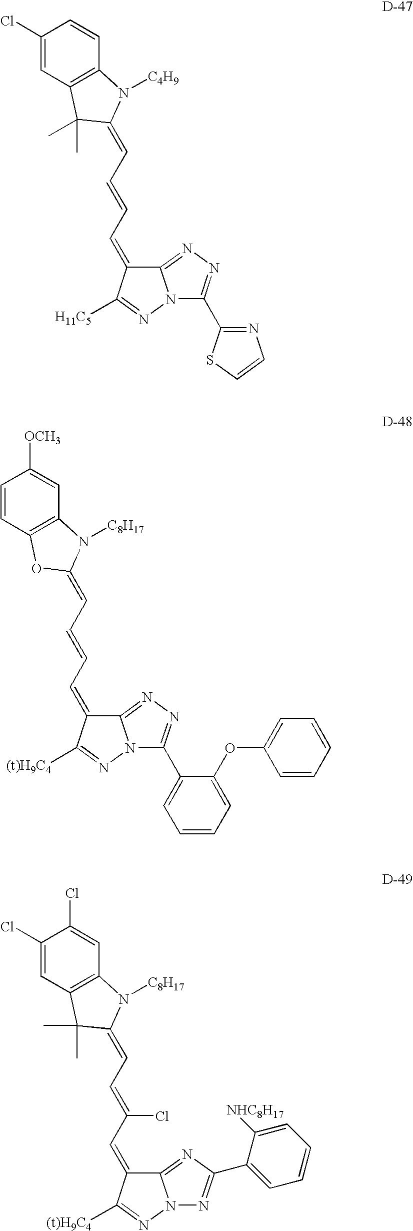

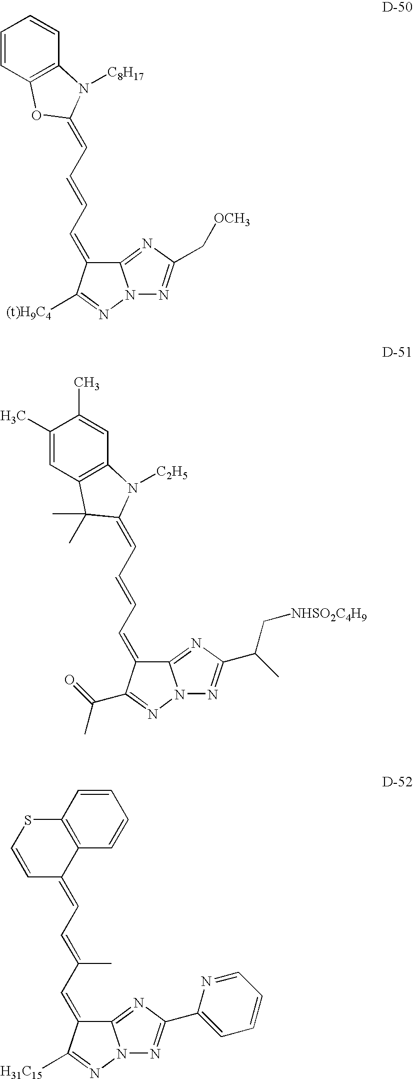

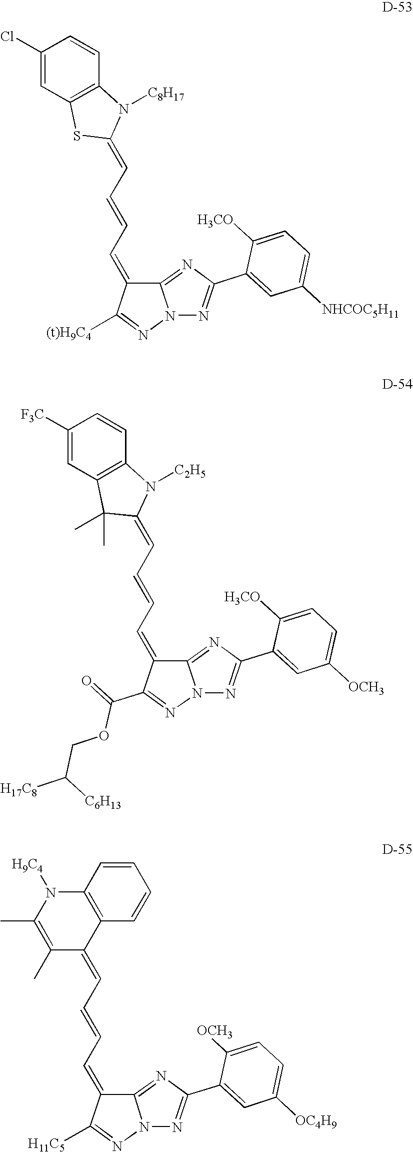

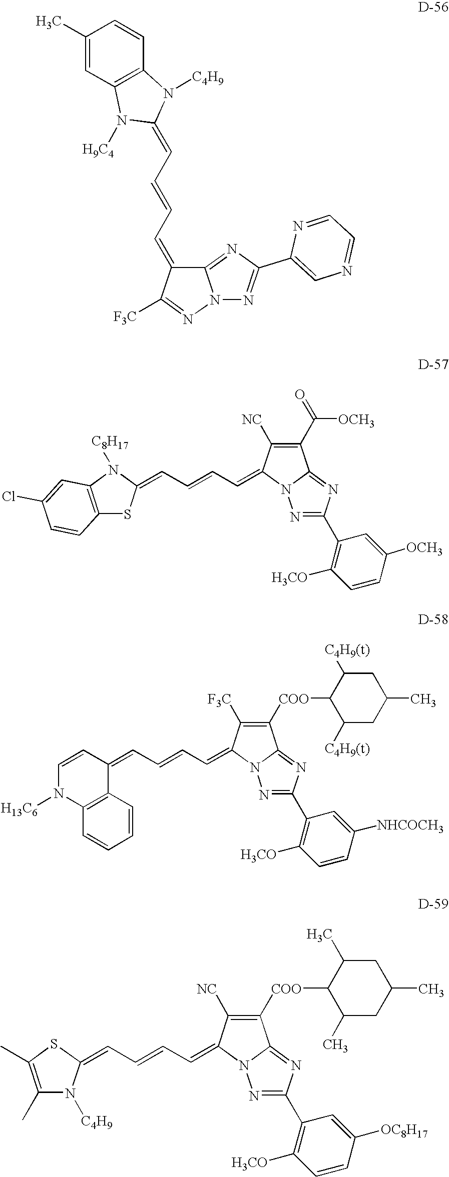

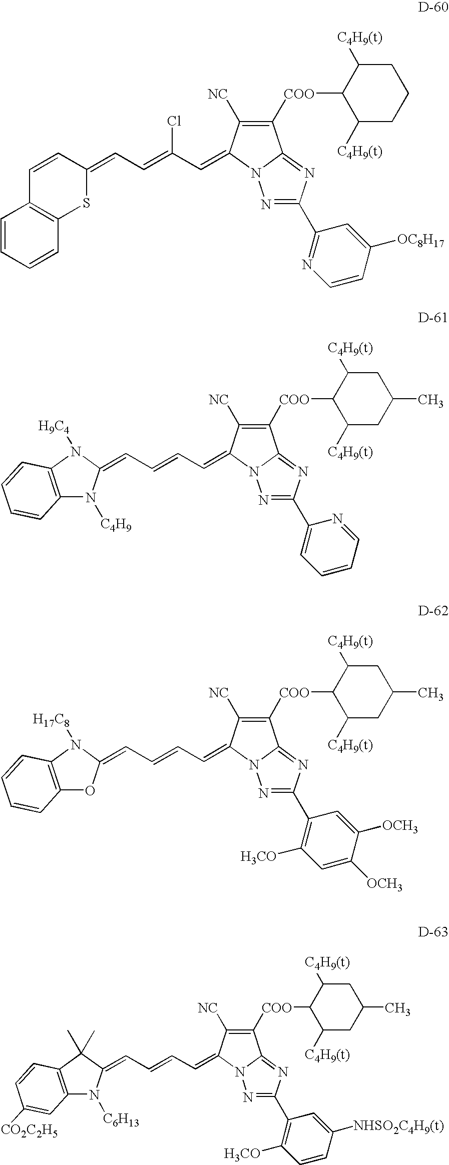

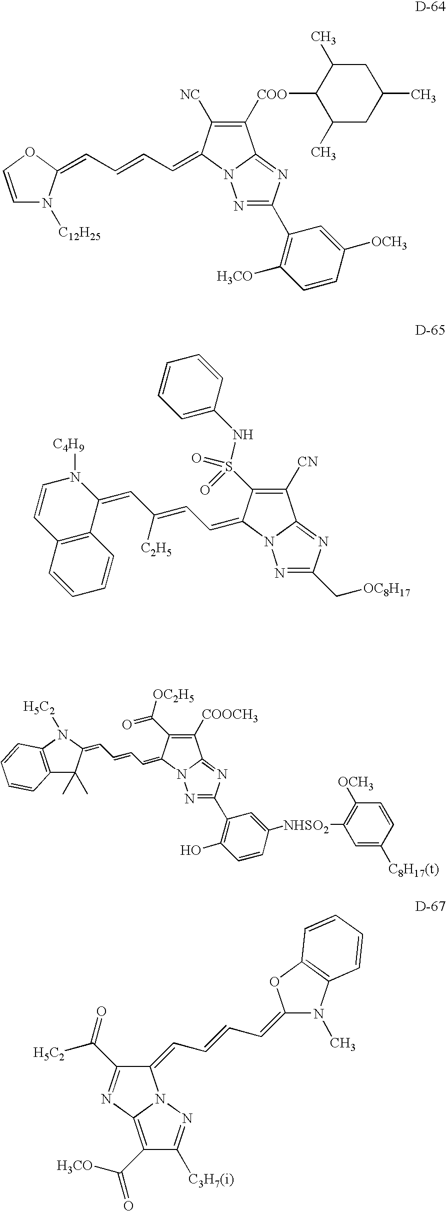

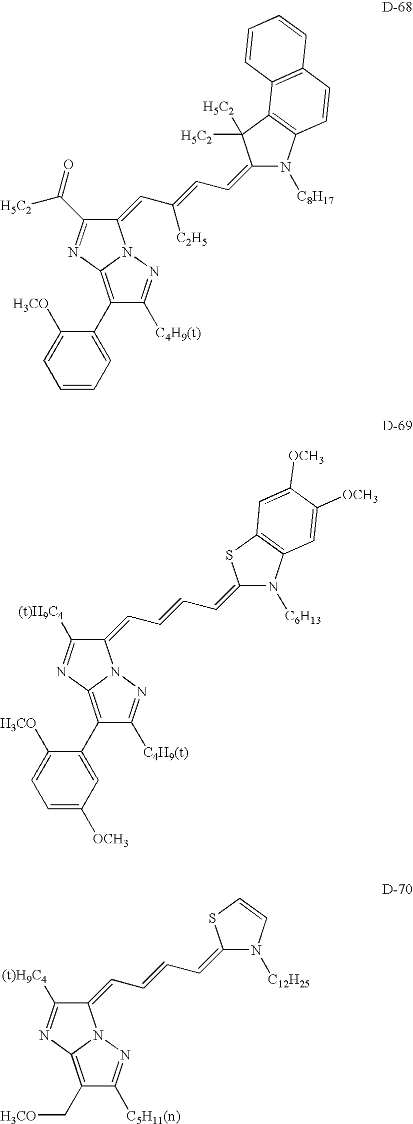

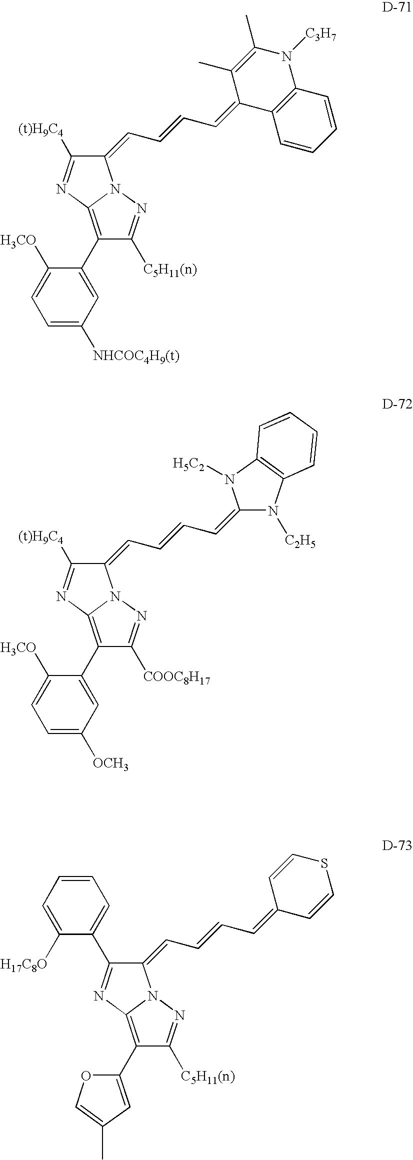

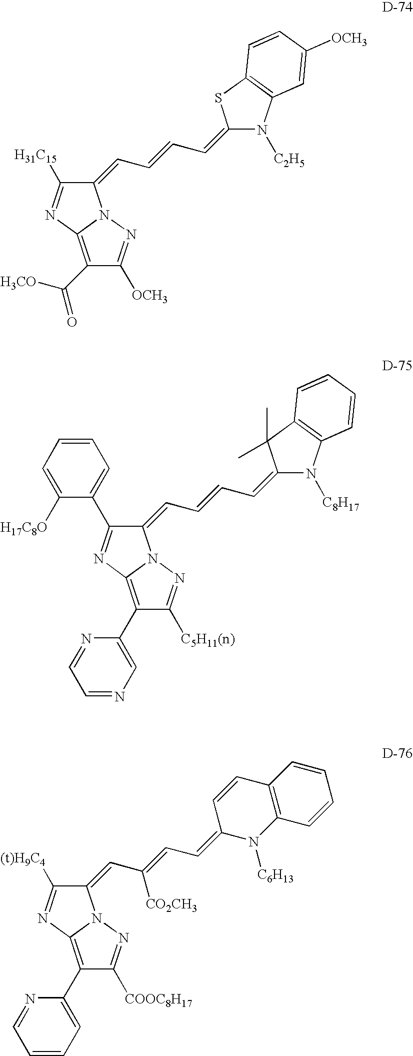

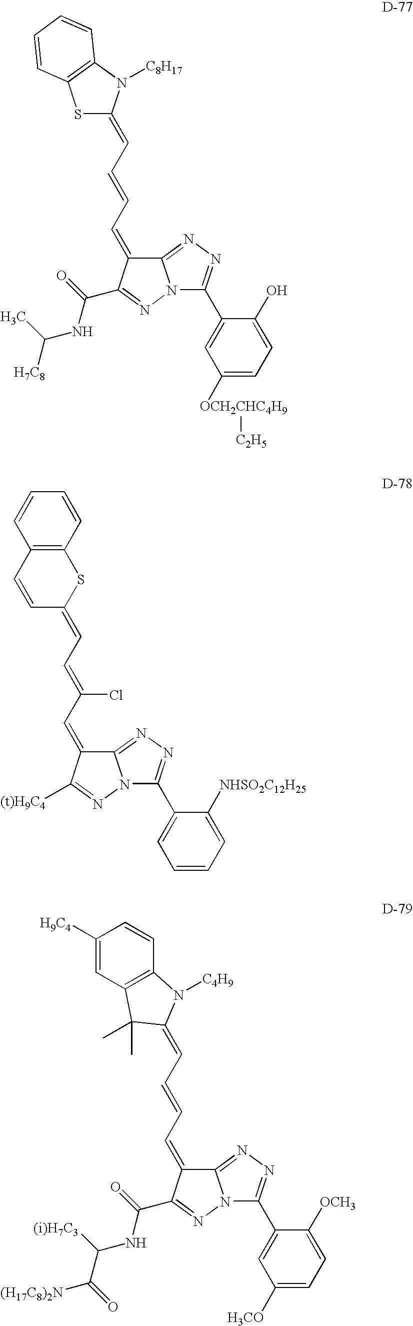

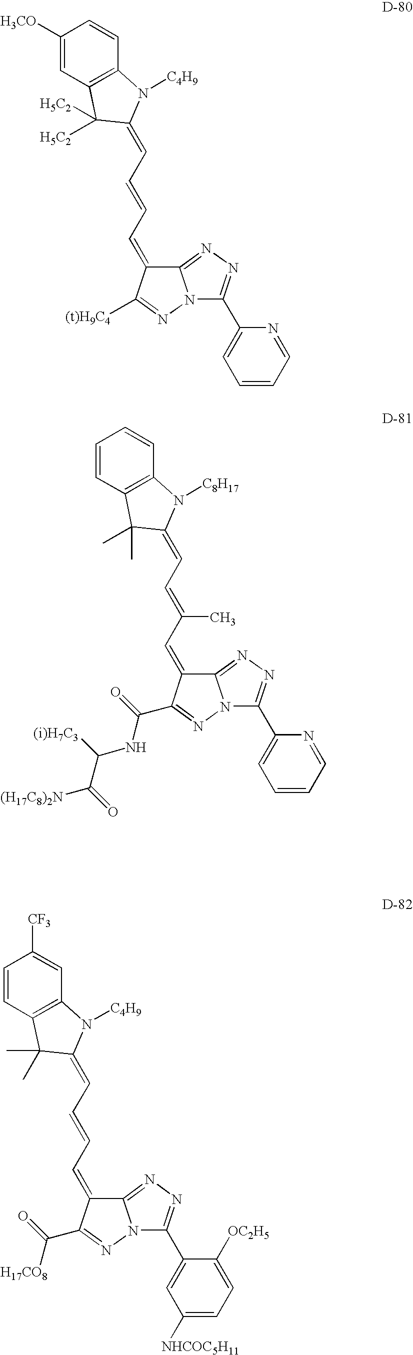

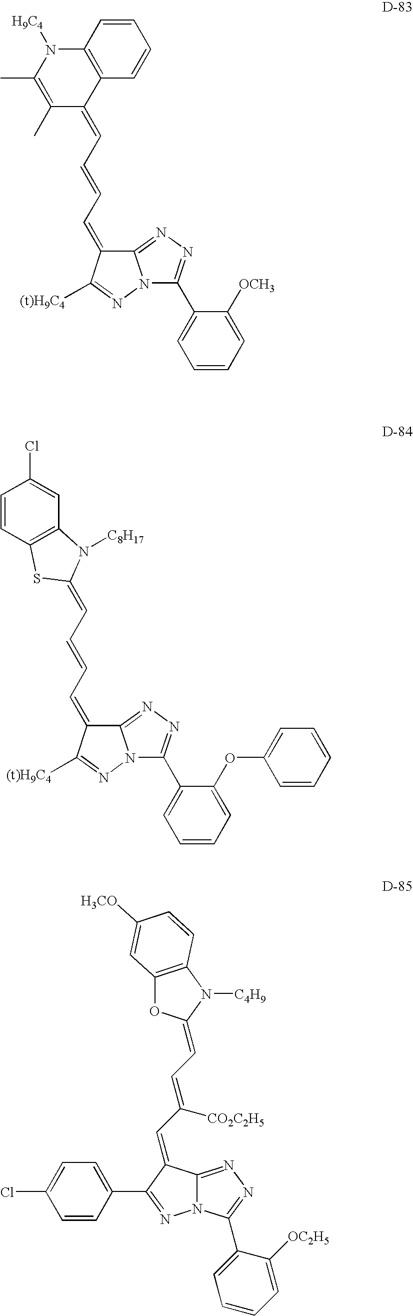

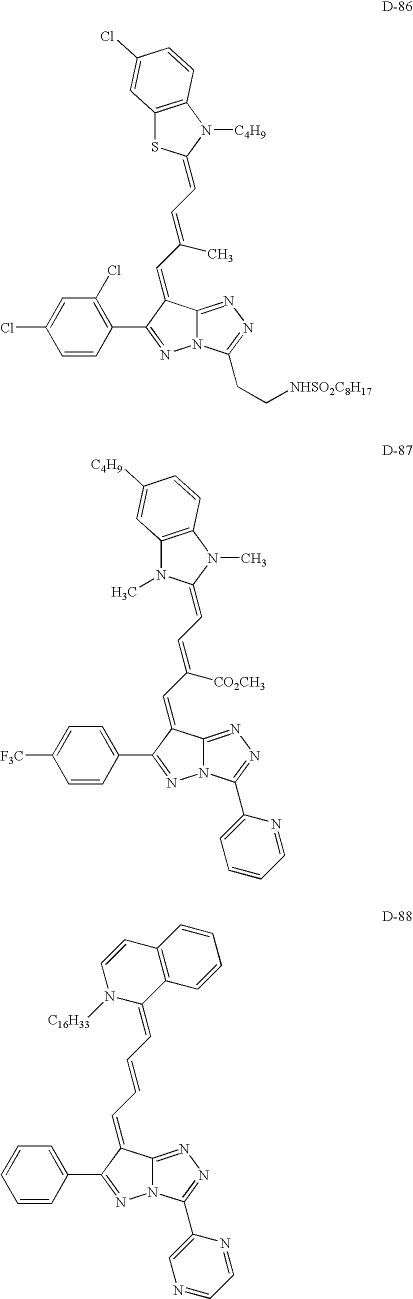

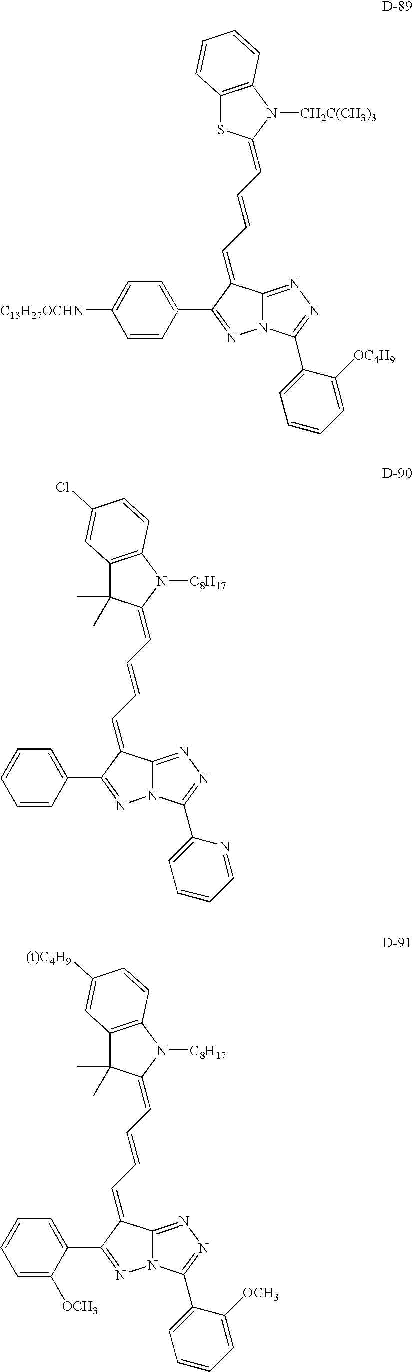

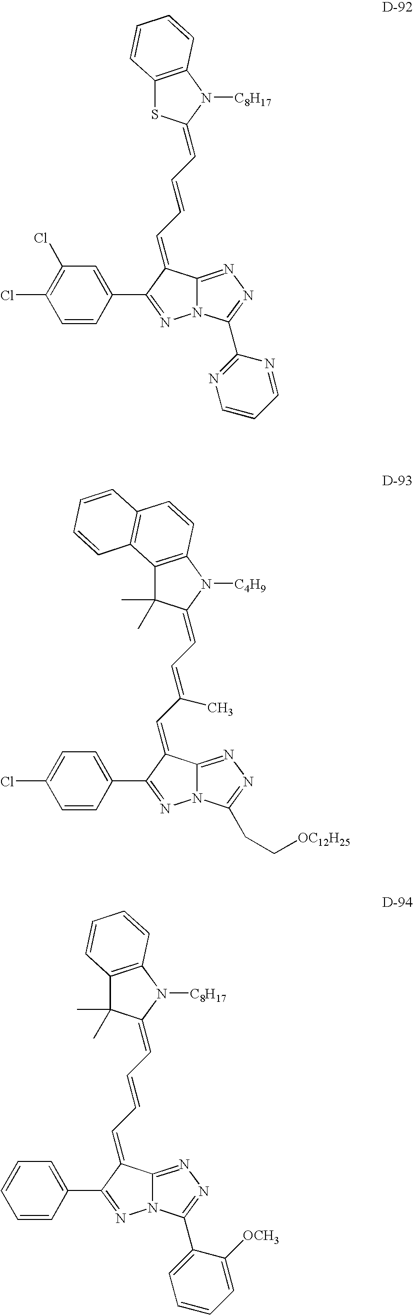

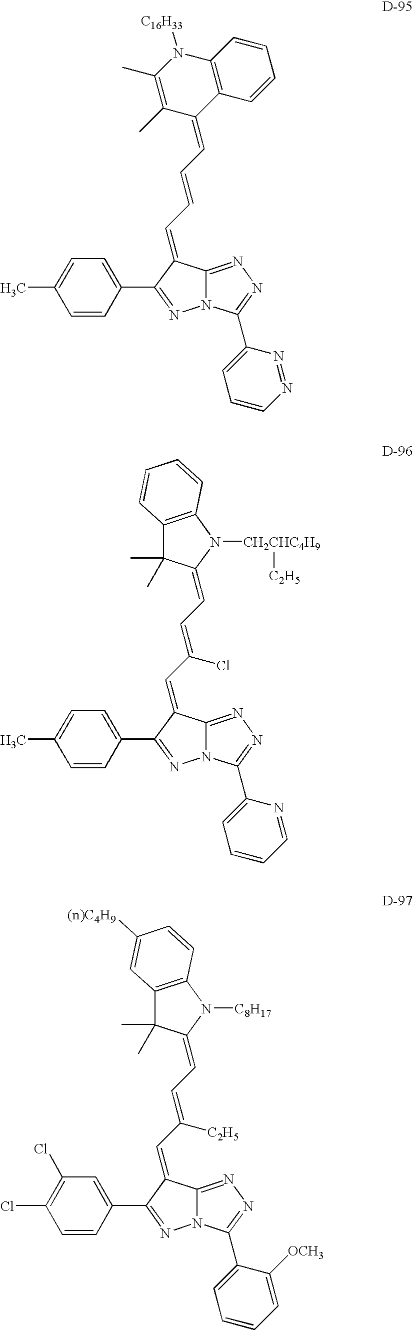

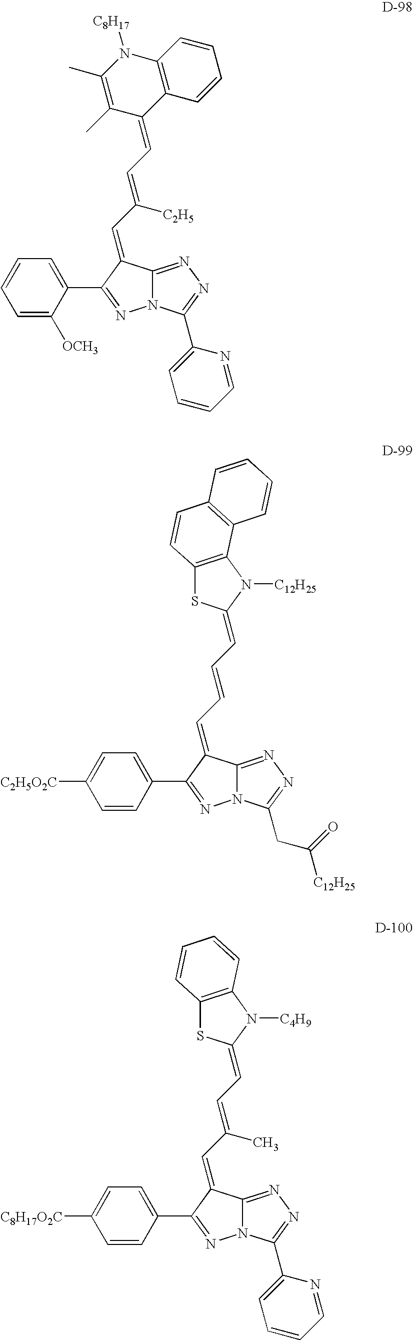

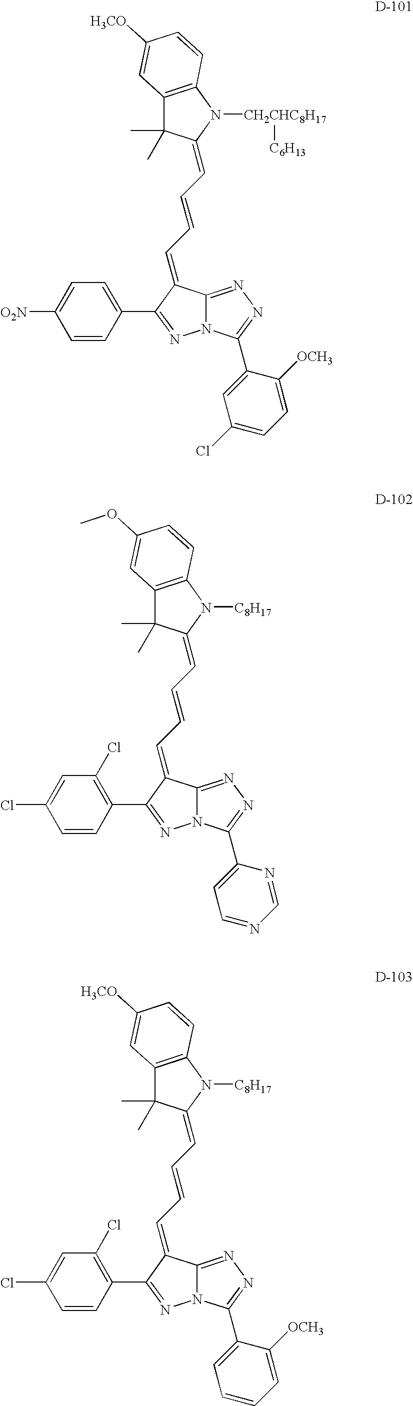

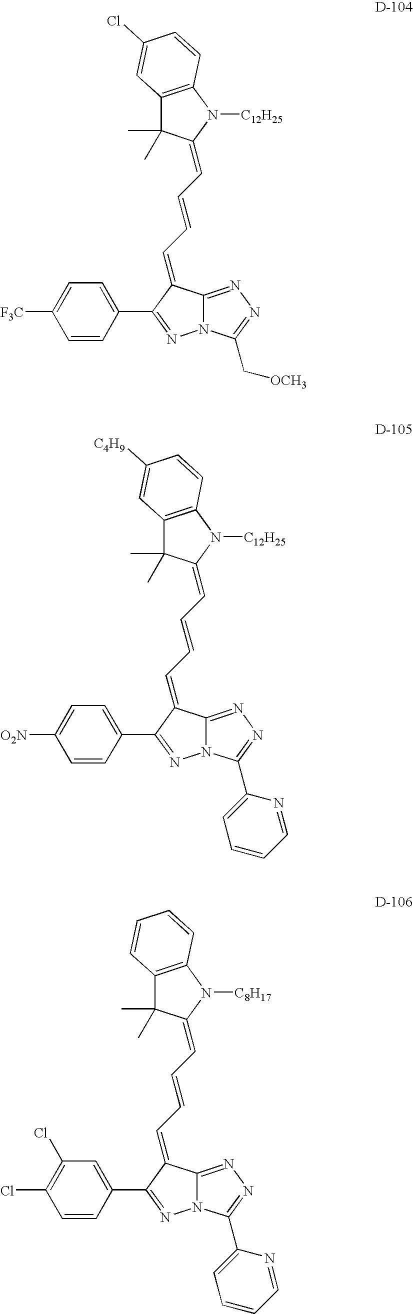

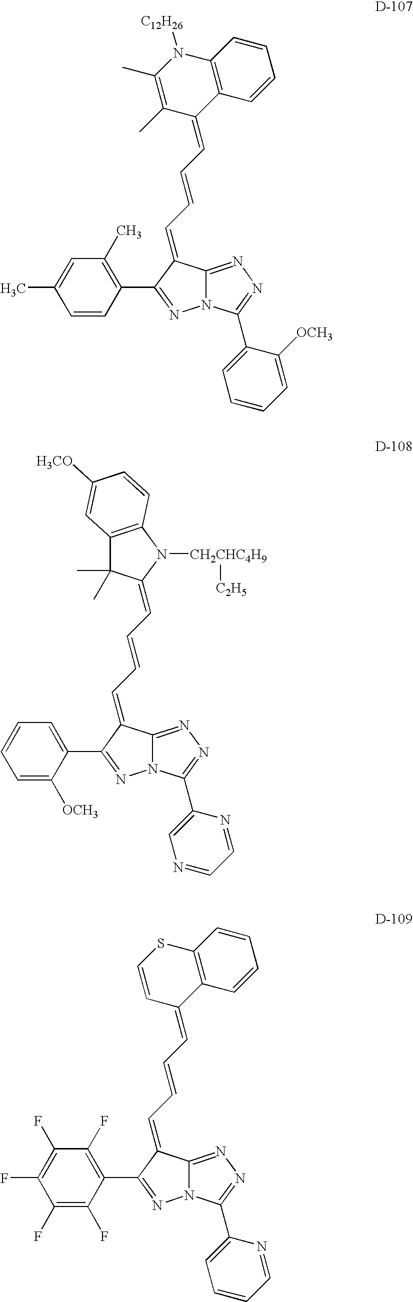

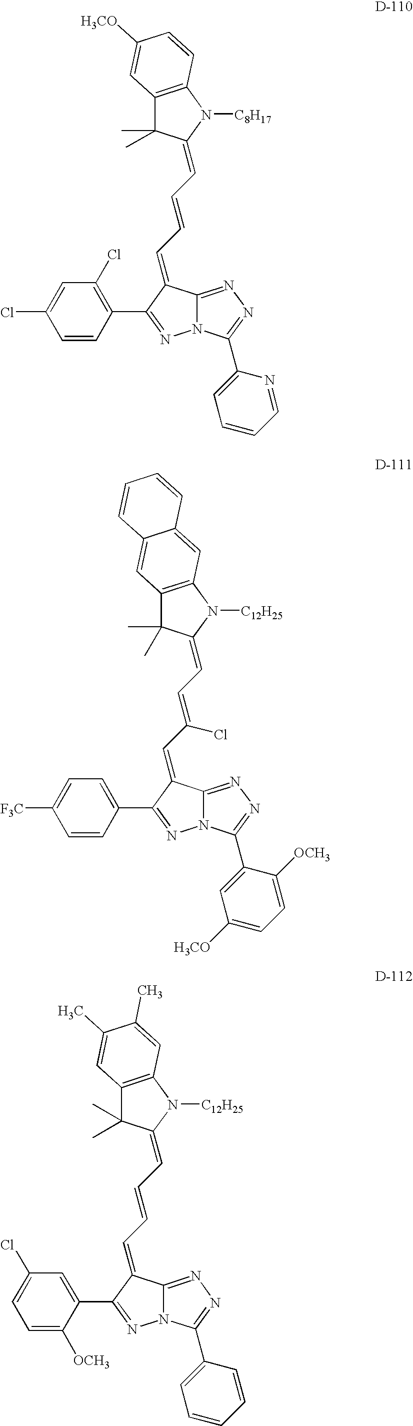

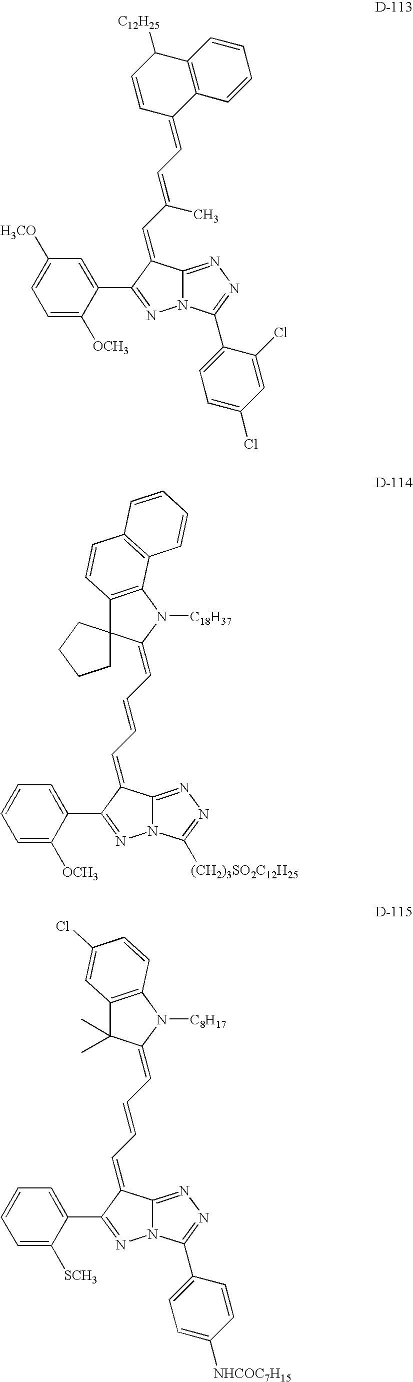

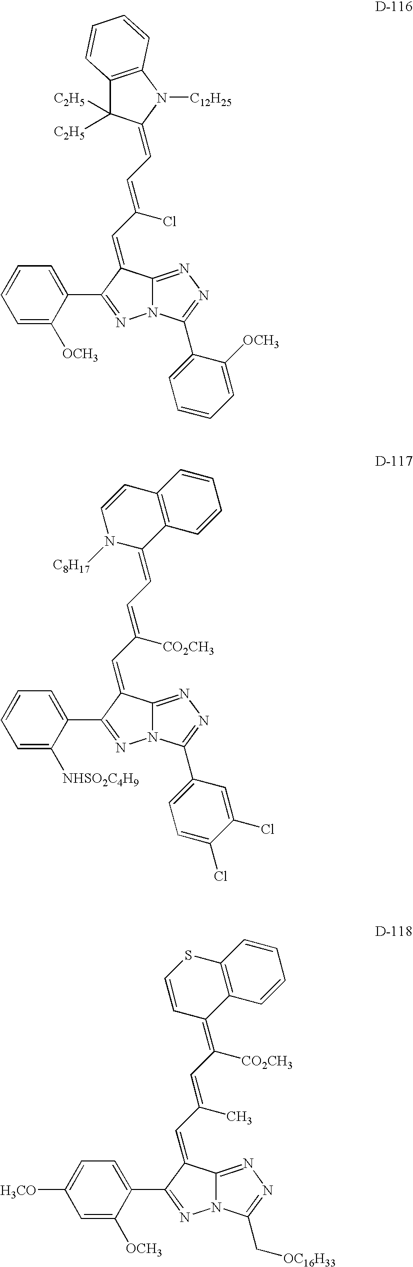

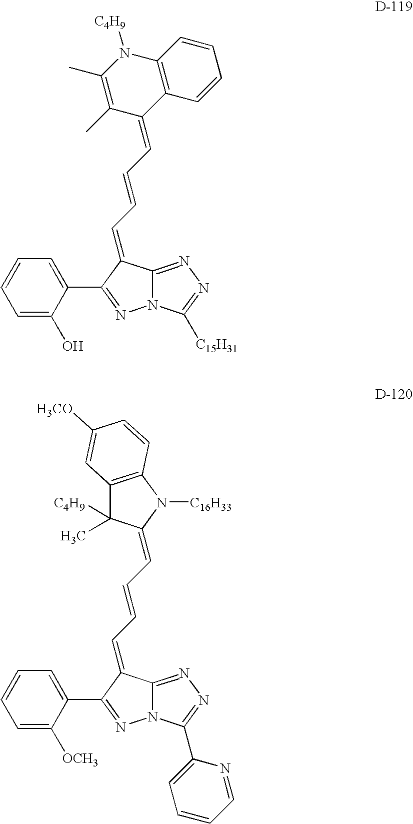

The dyes each capable of forming a metal chelate according to the invention represented by Formula 1 can be easily synthesized by the methods described in Japanese Patent Application No. 2006-144986 and JP-A No. 2001-159832, for example.

The foregoing Formula 2, X₁ and X₂ are each independently a mono- or bi-dentate ligand; they may be the same or different and may be bonded with together. m and n are each an integer of from 0 to 2. W₁ is a counter ion when the counter ion is necessary for neutralizing the charge.

Examples of X₁ and X₂ include those described in JP-A No. 2000-251957, 2000-311723, 2000-323191, 2001-6760, 2001-59062 and 2001-60467. Specific examples of a chelate ligand include a halide ion, a hydroxyl ion, ammonia, pyridine, an amine (e.g., methylamine, diethylamine, tributylamine), a cyanide ion, a cyanate ion, a thiolato ion, a thiocyanate ion, bipyridines, aminopolycarboxylic acids, and 8-hydroxyquiniline. Chelate ligands are exemplified in K. Ueno “Chelate Chemistry”.

A monodentate ligands preferably is a which coordinates via an acyl group, a carbonyl group, a thiocyanate group, an isothiocyanate group, a cyanate group, an isothiocyanate group, a halogen atom, a cyano group, an alkylthio group, an arylthio group, an alkoxy group or an aryloxy group, or a ligand comprised of a dialkyl ketone or a carbonamide.

A didentate ligand preferably is a ligand which coordinate via an acyloxy group, an oxalylene group, an acylthio group, a thioacyloxy group, a thioacylthio group, an acylaminooxy group, a thiocarbamate group, dithiocarbamate group, a thiocarbonate group, a dithiocarbonate group, a trithiocarbonate group, an alkylthio group or an arylthio group, or a ligand comprised of a dialkyl ketone or a carbonamide.

Specific examples of X1 and X2 are shown below but are not specifically limited to these. The structural formula shown below is simply one canonical structure of possible resonance structures. The distinction between a covalent bond (designated “—”) and coordination bond (designated “ . . . ”) is simply formal, not representing an absolute distinction.

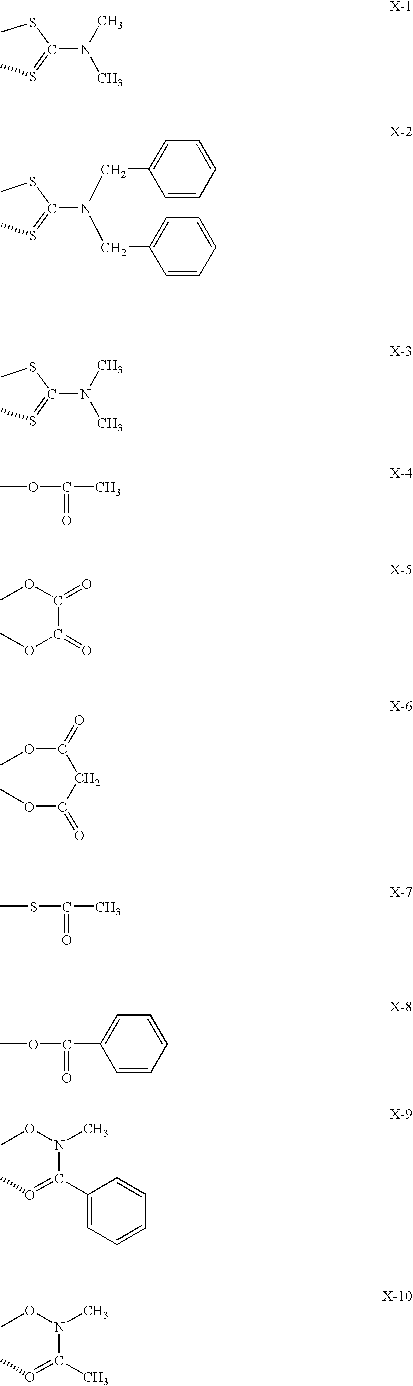

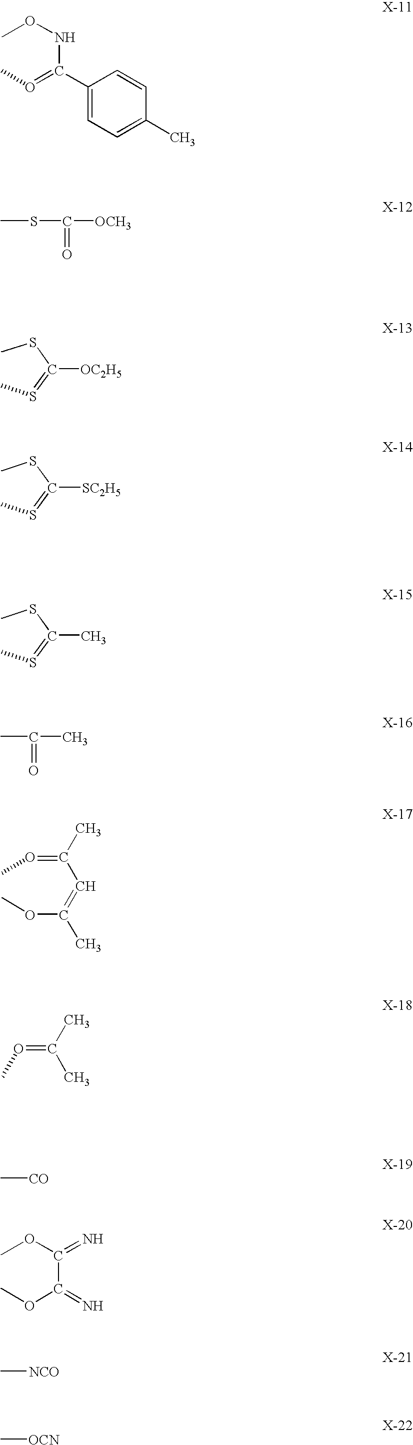

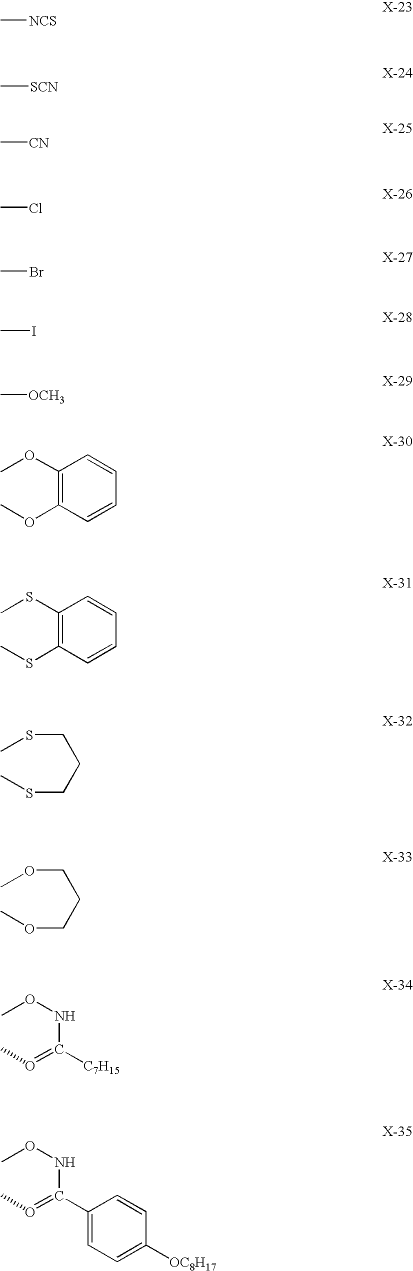

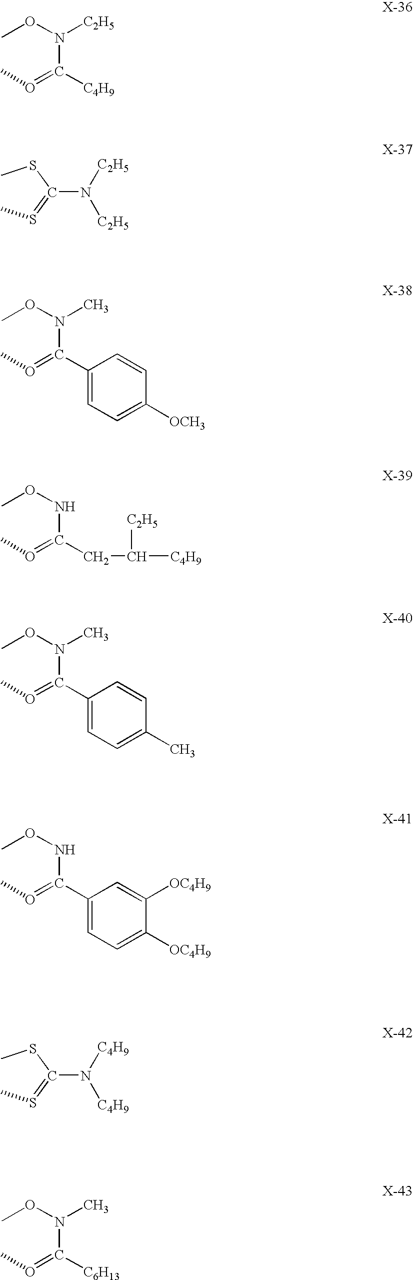

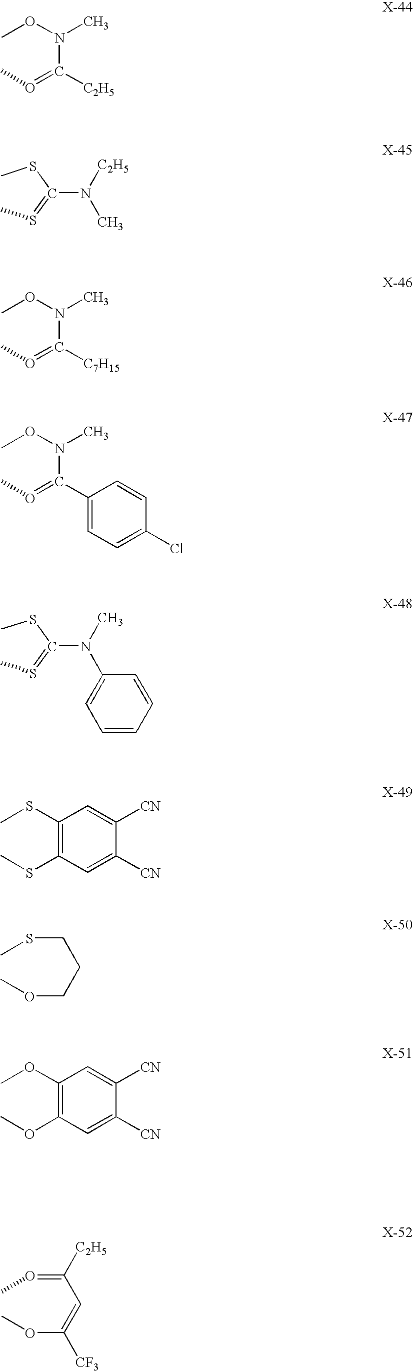

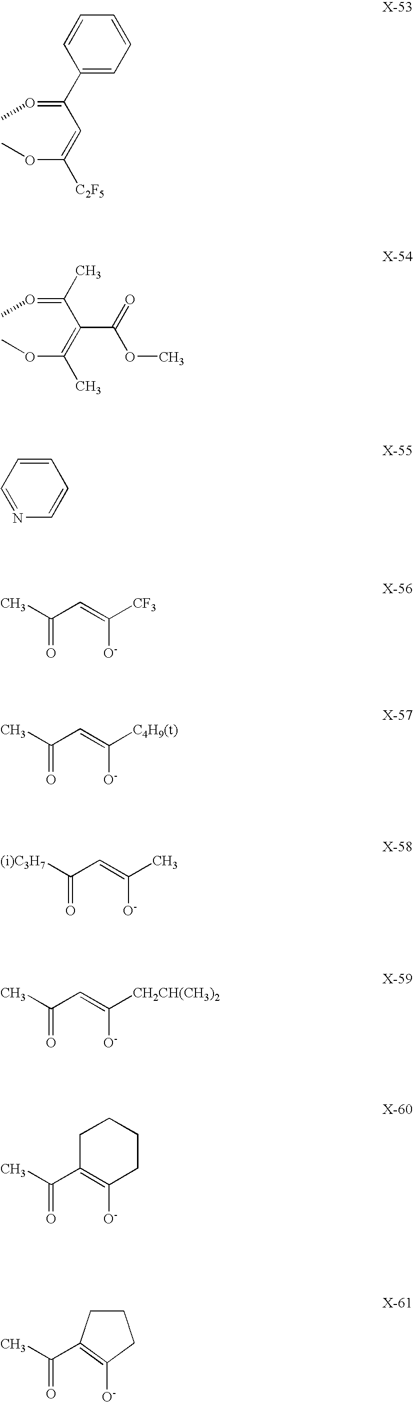

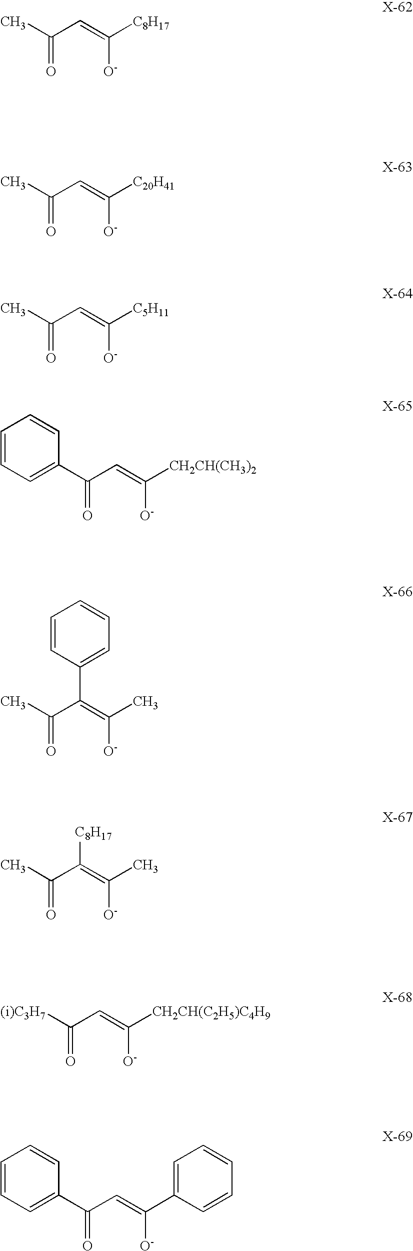

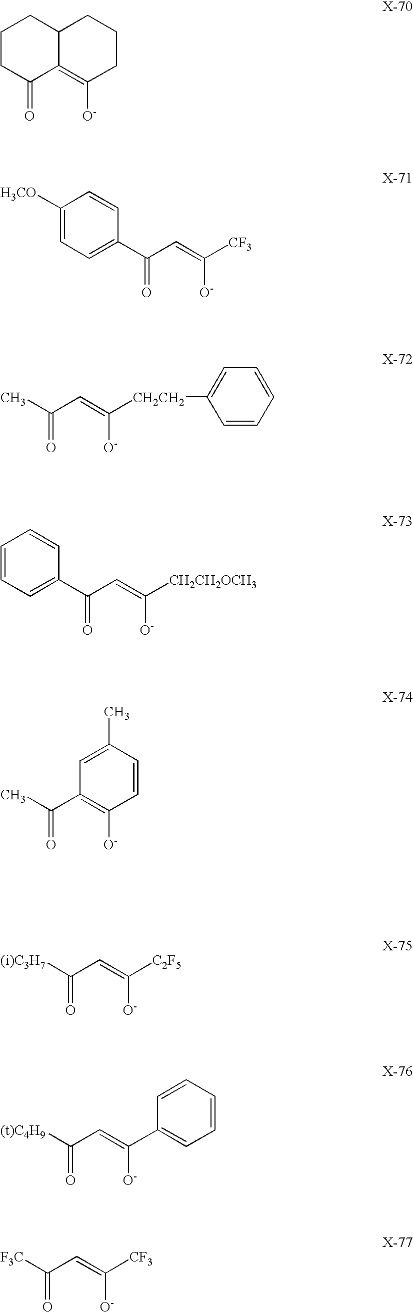

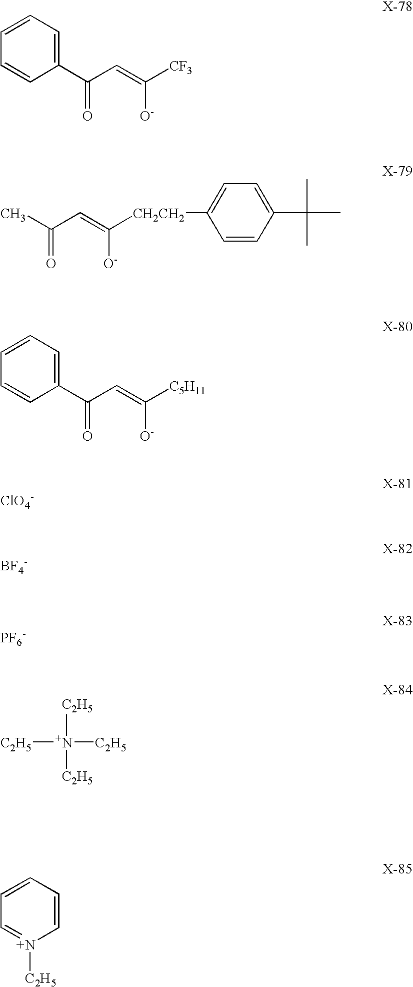

The structure represented by the following formula (17) is also preferred as a ligand:

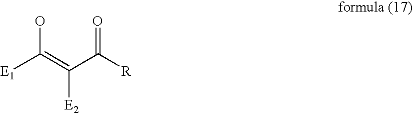

In the formula, E₁ and E₂ are each an electron-withdrawing group exhibiting a Hammett substituent constant (σp) of 0.10 to 0.90; and R is an alkyl group, an aryl group, a heterocyclic group, an alkoxy group or an amino group, which may be substituted with substituents.

There will be described the group of E₁ and E₂, having a σp value of 0.10 to 0.90.

As a Hammett substituent constant (σp) value are preferably used values described in, for example, Hansch, C. Leo et al., J. Med. Chem. 16, 1207 (1973); ibid. 20, 304 (1977).

Examples of a substituent or atom having a σp value of 0.10 or more include a chlorine atom, bromine atom, iodine atom, carboxyl group, cyano group, nitro group, halogen-substituted alkyl group, (e.g., trichloromethyl, trifluoromethyl, chloromethyl, trifluoromethylthiomethyl, trifluoromethanesulfonylmethyl, perfluorobutyl), an aliphatic, aromatic or heterocyclic acyl group (e.g., formyl, acetyl, benzoyl), an aliphatic, aromatic or heterocyclic sulfonyl group (e.g., trifluoromethanesulfonyl, methanesulfonyl, benzenesulfonyl), a carbamoyl group (e.g., carbamoyl, methylcarbamoyl, phenylcarbamoyl, 2-chlorophenylcarbamoyl), an alkoxycarbonyl group (e.g., methoxycarbonyl, ethoxycarbonyl, diphenylmethylcarbonyl), a substituted aromatic group (e.g., pentachlorophenyl, pentafluorophenyl, 2,4-dimethanesulfonylphenyl, 2-trifluoromethylphenyl), a heterocyclic residue (e.g., 2-benzoxazolyl, 2-benzothiazolyl, 1-phenyl-2-benzimidazolyl, 1-tetrazolyl), an azo group (e.g., phenylazo), a ditrifluoromethylamino group, a trifluoromethoxy group, an alkylsulfonyloxy group (e.g., methanesulfonyloxy), an acyloxyl group (e.g., acetyloxy, benzoyloxy), an arylsulfonyloxy group (e.g., benzenesulfonyloxy), a phosphoryl group (e.g., dimethoxyphosphoryl, diphenylphosphoryl), and a sulfamoyl group (e.g., N-ethylsulfamoyl, N,N-dipropylsulfamoyl, N-(2-dodecyloxyethyl)sulfamoyl, N-ethyl-N-dodecylsulfamoyl, N,N-diethylsulfamoyl).

Examples of a substituent having a σp value of 0.35 or more, include cyano group, nitro group, carboxyl group, fluorinated alkyl group (e.g., trifluoromethyl, perfluoromethyl), an aliphatic, aromatic or heterocyclic acyl group (e.g., acetyl, benzoyl, formyl), an aliphatic, aromatic or heterocyclic sulfonyl group (e.g., trifluoromethane-sulfonyl, methanesulfonyl, benzenesulfonyl), a carbamoyl group (e.g., carbamoyl, methylcarbamoyl, phenylcarbamoyl, 2-chlorophenylcarbamoyl), an alkoxycarbonyl group (e.g., methoxycarbonyl, ethoxycarbonyl, diphenylmethylcarbonyl), a fluorine- or sulfonyl-substituted aromatic group (e.g., pentafluorophenyl, 2,4-dimethanesulfonylphenyl), a heterocyclic residue (e.g., 1-tetrazolyl), an azo group (e.g., phenylazo), an alkylsulfonyloxy group (e.g., methanesulfonyloxy), a phosphoryl (e.g., dimethoxyphosphoryl, diphenylphosphoryl) and a sulfamoyl group.

Examples of a substituent having a σp value of 0.60 or more, include cyano group, nitro group, and an aliphatic, aromatic or heterocyclic sulfonyl group (e.g., trifluoromethane-sulfonyl, methanesulfonyl, benzenesulfonyl).

Preferred examples of E¹ and E² include a halogenated alkyl group (specifically, fluorinated alkyl), carbonyl group, cyano group, alkoxycarbonyl group, alkylsulfonyl group, and alkylsulfonyloxy group. A substituent of R is preferably an alkyl group, alkoxy group, and amino group, and more preferably an alkyl group or alkoxy group.

Specific examples of a ligand represented by formula (17) are shown below but are by no means limited to these.

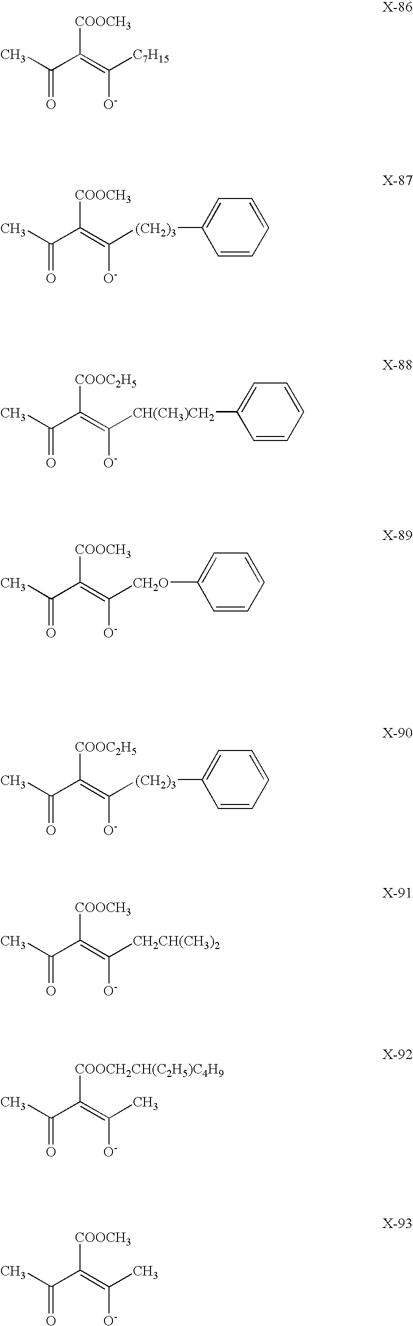

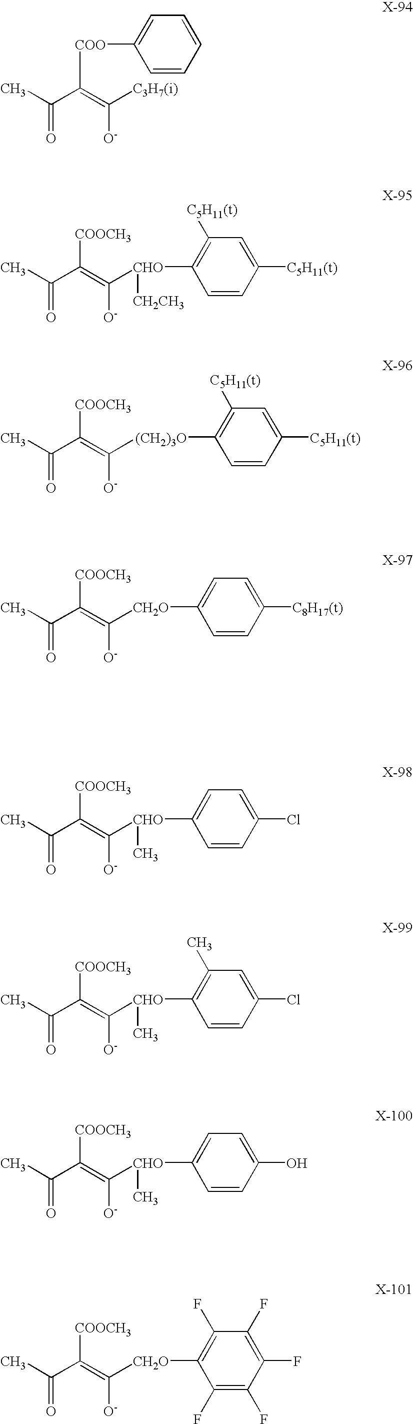

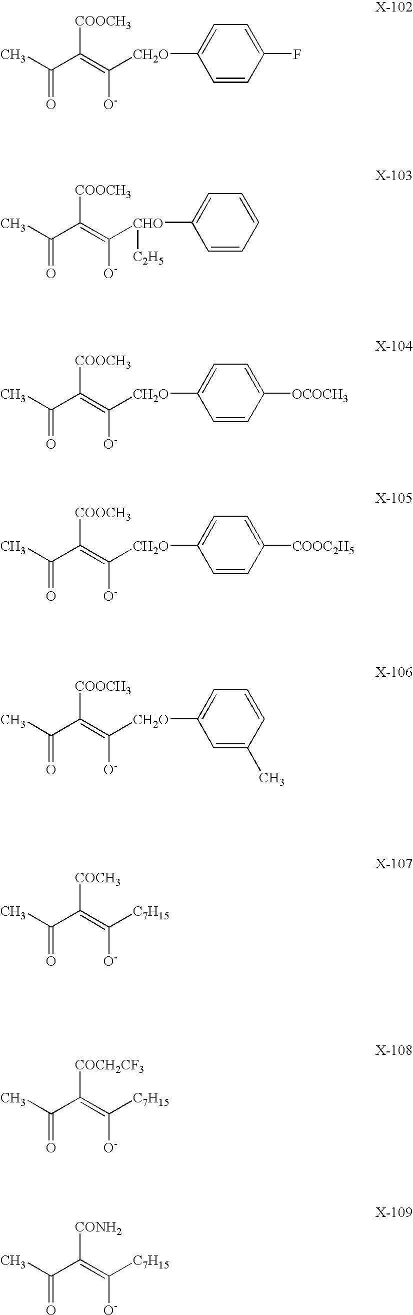

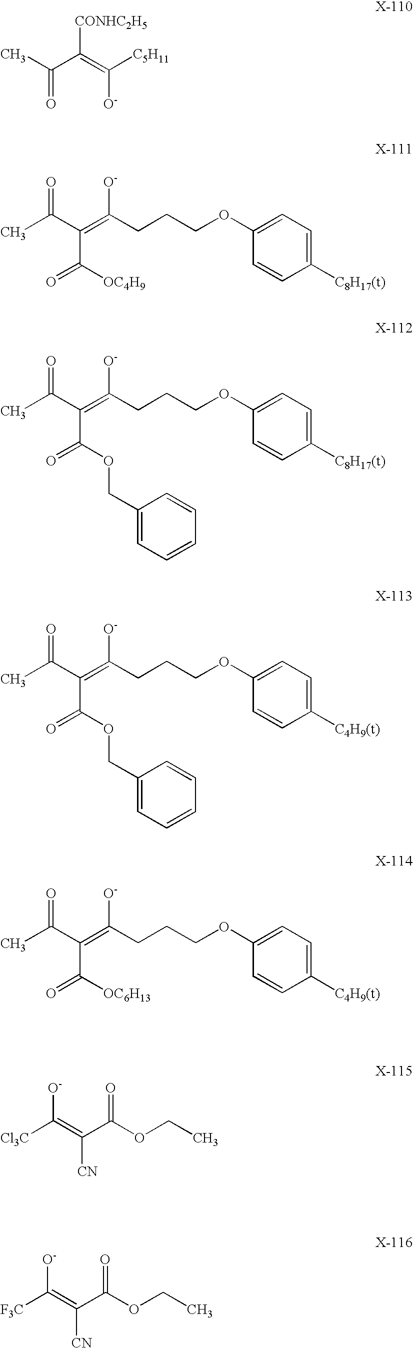

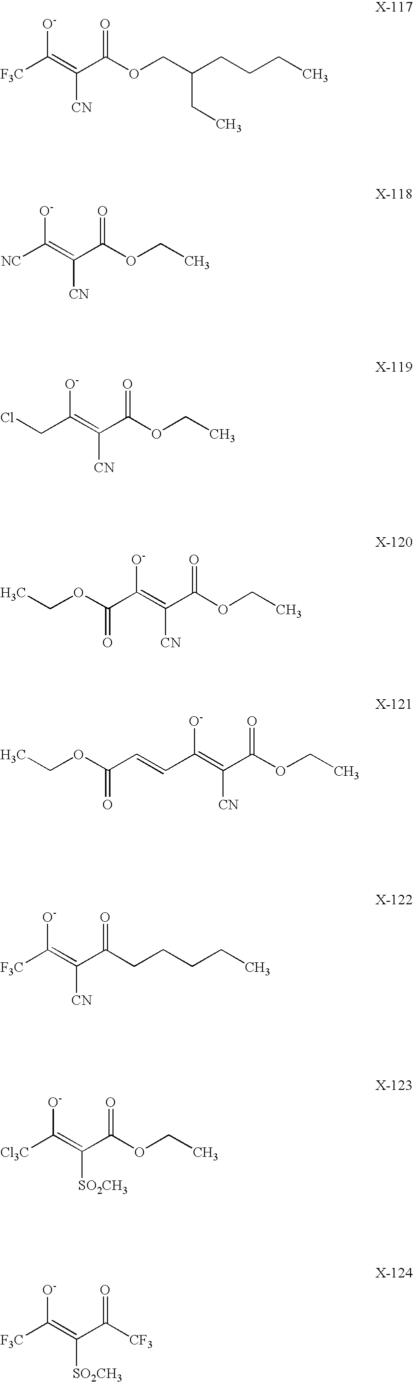

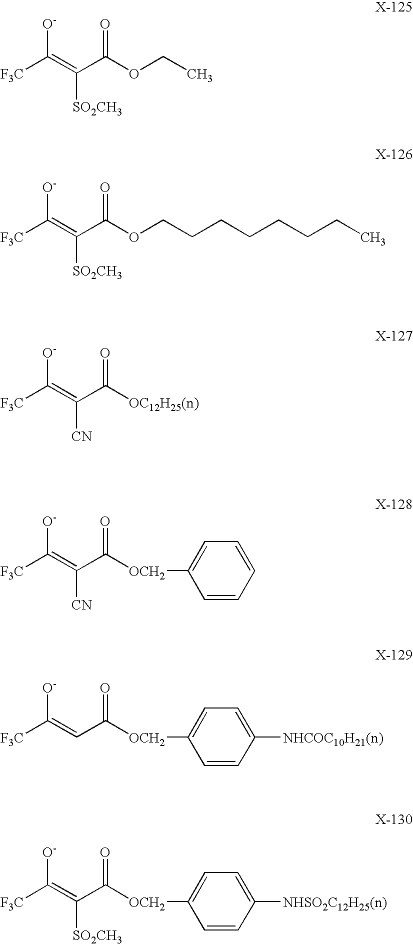

W₁ represents a counter ion when a counter ion is required for neutralization of charge. For instance, ionicity of a dye or its net ionic charge, i.e., whether a dye is cationic or anionic or has a net ionic charge or not, depends on its metal, ligand or substituent. A substituent having a dissociative group may dissociate to have a negative charge, in which overall charge of the molecule is neutralized with W₁. Typical cations include an inorganic or organic ammonium ion (e.g., tetraalkylammonium ion, pyridinium ion), an alkali metal ion and proton. Anions may be any ones of inorganic and organic anions, and specific examples thereof include a halide anion (e.g., fluoride ion, chloride ion, bromide ion, iodide ion), a substituted arylsulfonic acid ion (e.g., p-toluenesulfonic acid ion, p-chlorobenzenesulfonic acid ion), an aryldisulfonic acid ion (e.g., 1,3-benzenedisulfonic acid ion, 1,5-naphthalenedisulfonic acid ion, 2,6-naphthalenedisulfonic acid ion), an alkylsulfate ion (e.g., methylsulfate ion), sulfate ion, thiocyanate ion, perchlorate ion, tetrafluoroborate ion, hexafluorophosphate ion, picrate ion, acetate ion and trifluoromethanesulfonic acid ion.

Examples of such the copper compound include copper acetate, copper stearate, copper 2-ethylhexanate, copper sulfate and cupric chloride.

Concrete compounds represented by Formula 2 are shown below, but the invention is not limited to them.

TABLE 1

| | X₁ | m | X₂ | n | W₁ |
|---|---|---|---|---|---|
| C-1 | X-4 | 1 | X-4 | 1 | — |
| C-2 | X-6 | 1 | X-6 | 1 | X-114 |
| C-3 | X-17 | 1 | X-17 | 1 | — |
| C-4 | X-26 | 1 | X-26 | 1 | — |
| C-5 | X-27 | 1 | X-27 | 1 | — |
| C-6 | X-51 | 1 | X-51 | 1 | X-114 |
| C-7 | X-52 | 1 | X-52 | 1 | — |
| C-8 | X-53 | 1 | X-53 | 1 | — |
| C-9 | X-54 | 1 | X-54 | 1 | — |
| C-10 | X-78 | 1 | X-78 | 1 | — |
| C-11 | X-102 | 1 | X-102 | 1 | — |
| C-12 | X-106 | 1 | X-106 | 1 | — |
| C-13 | X-110 | 1 | X-110 | 1 | — |
| C-14 | X-111 | 1 | X-111 | 1 | — |
| C-15 | X-112 | 1 | X-112 | 1 | — |
| C-16 | X-115 | 1 | X-115 | 1 | — |
| C-17 | X-116 | 1 | X-116 | 1 | — |
| C-18 | X-117 | 1 | X-117 | 1 | — |
| C-19 | X-118 | 1 | X-118 | 1 | — |
| C-20 | X-119 | 1 | X-119 | 1 | — |
| C-21 | X-120 | 1 | X-120 | 1 | — |
| C-22 | X-121 | 1 | X-121 | 1 | — |
| C-23 | X-122 | 1 | X-122 | 1 | — |
| C-24 | X-123 | 1 | X-123 | 1 | — |
| C-25 | X-124 | 1 | X-124 | 1 | — |
| C-26 | X-125 | 1 | X-125 | 1 | — |
| C-27 | X-126 | 1 | X-126 | 1 | — |
| C-28 | X-127 | 1 | X-127 | 1 | — |
| C-29 | X-128 | 1 | X-128 | 1 | — |
| C-30 | X-129 | 1 | X-129 | 1 | — |
| C-31 | X-130 | 1 | X-130 | 1 | — |
| C-32 | SO₄⁽²⁻⁾ | 1 | — | 0 | — |
| C-33 | X-15 | 1 | X-15 | 1 | — |
| C-34 | X-4 | 1 | X-111 | 1 | — |
| C-35 | X-127 | 1 | X-111 | 1 | — |

The ligand of the copper compound represented by Formula 17 can be synthesized referring JP-A No. 2002-332259 and 2003-237246.

(Adding Amount of Copper Compound)

The content of the copper compound represented by Formula 2 in the solid dispersion of the dye and the colored particle is preferably from 0.5 to 3 times, more preferably 1 to 2 times, in mole of the metal chelate formable dye represented by Formula 1. Sufficient density, improving in the light fastness and superior storage stability of the fine particle dispersion so that increasing of the particle size caused by coagulation can be prevented are obtained by containing 1 to 3 times in mole of the copper compound.

(Metal Chelate Dye)

The metal chelate dye having at least one compound as the ligand, in which Z¹ of Formula 1 is represented by Formula 9, is preferably represented by the following Formula 20.

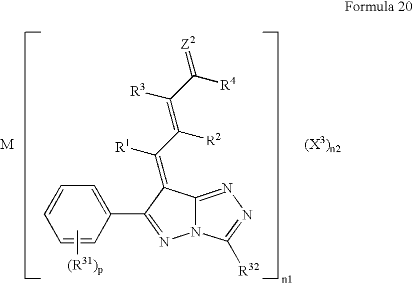

In Formula 20, M is a metal ion, X³ is an anion, n1 is an integer of from 1 to 3 and n2 is an integer of from 0 to 3. R¹ to R⁴ and Z² are each synonym for R¹ to R⁴ and Z² in Formula 1, and R³¹, R³² and p are each synonym for R³¹, R³² and p in Formula 9, respectively.

In Formula 20, the metal ion represented by M is selected from metal atoms of Groups VIII, Ib, IIb, IIIa, IVa Va VIa and VIIa, and di-valent transition metal ions are preferable. In concrete, di-valent metal ions of Ni, Cu, Co, Cr, Zn, Fe, Pd and Pt are preferable, di-valent ions of Cu, Co and Zn are more preferable and di-valent metal ion of Cu is particularly preferable.

In the invention, the metal chelate dye represented by Formula 20 can be obtained by mixing a metal-containing compound represented by M(X³)ₙ₂ and a compound represented by Formula 18 in a solution.

Examples of an anion represented by X³ in Formula 20 include an enolate such as acetyl acetonate and hexafluoroacetylacetonate, a halogen ion such as fluoride, chloride, bromide and iodide, a hydroxyl ion, a sulfite ion, a sulfate ion, an alkylsulfonate ion, an arylsulfonate ion, a nitrate ion, a nitrite ion, a carbonate ion, a perchlorate ion, an alkylcarboxylate ion, an arylcarboxylate ion, tetraalkylborate, salicylate, benzoate, PF₆, BF₄ and SbF₆. In concrete, the anions cited as X1 and X2 in Formula 2 are applicable. It is preferably the enolate ions and more preferably the compounds represented by Formula 17.

When n2 is 2 or 3, plural X³s may be the same or different.

Typical concrete examples of the metal chelate dye of the invention are shown in Table 2 but the invention is not limited to them. When the compound has position isomers, one of them is described below as a typical form, and the position isomers other than the described one are included in the compounds of the invention.

TABLE 2

| Metal chelate dye | M | Formula 1 | n1 | X³ | n2 |
|---|---|---|---|---|---|
| MD-1 | Cu | D-86 | 1 | X-116 | 2 |
| MD-2 | Cu | D-86 | 1 | X-127 | 2 |
| MD-3 | Cu | D-88 | 1 | X-4 | 2 |
| MD-4 | Cu | D-91 | 1 | X-54 | 2 |
| MD-5 | Cu | D-91 | 1 | X-117 | 2 |
| MD-6 | Cu | D-94 | 1 | X-8 | 2 |
| MD-7 | Cu | D-94 | 1 | X-116 | 2 |
| MD-8 | Cu | D-99 | 1 | X-12 | 2 |
| MD-9 | Cu | D-101 | 1 | X-125 | 2 |
| MD-10 | Cu | D-103 | 1 | X-23 | 2 |
| MD-11 | Cu | D-103 | 1 | X-126 | 2 |
| MD-12 | Cu | D-106 | 1 | X-112 | 2 |
| MD-13 | Cu | D-106 | 1 | X-127 | 2 |
| MD-14 | Cu | D-109 | 1 | X-104 | 2 |
| MD-15 | Cu | D-110 | 1 | X-52 | 2 |
| MD-16 | Cu | D-110 | 1 | X-110 | 2 |
| MD-17 | Cu | D-113 | 1 | X-110 | 2 |
| MD-18 | Cu | D-114 | 1 | X-128 | 2 |
| MD-19 | Cu | D-116 | 1 | X-129 | 2 |
| MD-20 | Cu | D-119 | 1 | X-121 | 2 |
| MD-21 | Cu | D-120 | 1 | X-18 | 2 |
| MD-22 | Ni | D-88 | 1 | X-115 | 2 |
| MD-23 | Ni | D-94 | 1 | X-22 | 2 |
| MD-24 | Ni | D-103 | 1 | X-127 | 2 |
| MD-26 | Ni | D-106 | 1 | X-125 | 2 |
| MD-27 | Ni | D-110 | 1 | X-128 | 2 |
| MD-28 | Zn | D-94 | 1 | X-122 | 2 |
| MD-29 | Zn | D-105 | 1 | X-12 | 2 |
| MD-30 | Zn | D-110 | 1 | X-124 | 2 |
| MD-31 | Zn | D-113 | 1 | X-26 | 2 |
| MD-32 | Zn | D-118 | 1 | X-120 | 2 |
| MD-33 | Co | D-94 | 1 | X-127 | 2 |
| MD-34 | Co | D-110 | 1 | X-128 | 2 |
| MD-35 | Cr | D-103 | 1 | X-117 | 2 |
| MD-36 | Cr | D-112 | 1 | X-51 | 2 |
| MD-37 | Fe | D-97 | 1 | X-118 | 2 |
| MD-38 | Fe | D-102 | 1 | X-127 | 2 |
| MD-39 | Pd | D-98 | 1 | X-5 | 2 |
| MD-40 | Pt | D-108 | 1 | X-122 | 2 |
| MD-41 | Ru | D-110 | 1 | X-126 | 2 |

The metal chelate dye having the compound in which Z¹ of Formula 1 is represented by Formula 8 as the ligand can be easily synthesized by know methods described in JP-A No. 10-86517 and JP-A No. 2001-159832.

(Method for Dispersing a Dye)

An electrophotographic toner of the invention can be manufactured by directly dispersing a dye dispersion in a binding resin, or by mixing a dispersion of colored microparticles in a binding resin and using a desired additives mentioned later, employing commonly known methods such as a kneading/pulverizing method, suspension polymerization method, emulsion polymerization method, emulsifying granulation method and encapsulation method. Of these manufacturing methods, when taking into account miniaturization of toner particle along with high image quality, emulsion polymerization is preferable in terms of manufacture cost and manufacture stability.

Thus, toner particles are manufactured in such a manner that a thermoplastic resin emulsion manufactured by emulsion polymerization is mixed with a dispersion of toner constituents such as a solid dispersion of a dye and allowed to cause gradual flocculation, while balancing repulsion of the particle surface caused by pH-adjustment and coagulation due to addition of an electrolyte to perform coalescence.

A dye dispersion can be made by directly dispersing a dye using commonly known dispersing machines such as a roll ink mill, a bead dispersing machine, a high-speed stirring disperser and a medium type dispersing machine, but can also be prepared in a manner similar to the case of a colored microparticle dispersion described below. Thus, a dye is dissolved (or dispersed) in an organic solvent and dispersed (or emulsified) in water, followed by removal of the organic solvent to obtain a dye dispersion.

(Colored Microparticles)

In one of the embodiments of the electrophotographic toner, at least colored microparticles can be dispersed in a thermoplastic resin. The colored microparticles contain a dye represented by the formula (1) and a copper compound represented by the formula (2). Dispersion particle diameter of the colored microparticles can be controlled by employing a drying in liquid method described later. Further it is preferable to contain a resin different in composition from the thermoplastic resin (the similar resin for the core described later) or a known high boiling point solvent such as dibutyl phthalate tricresyl phosphate. Thus, instead of allowing a dye to be directly dispersed or dissolved in a binding resin to form a toner, the colored microparticles can be dispersed in the thermoplastic resin.

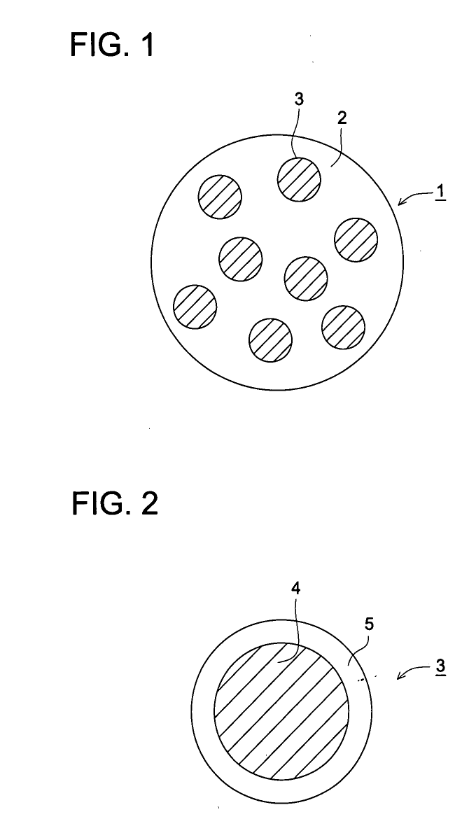

In the colored microparticles, the dye is dissolved in a resin at the molecular level, which enables to be free of any light-shielding particles in a toner, thereby resulting an enhanced transparency in a single toner color and even in overlapped colors. FIG. 1 illustrates the section of an electrophotographic toner particle (1) in which colored microparticles (3) are dispersed in a thermoplastic resin (2). The colored microparticles are each comprised of a dye and a resin differing in composition from the thermoplastic resin (2). In the electrophotographic toner of the invention, as shown in FIG. 2, the colored microparticle (3) may have a shelling resin (or a shell, designated as (5) covering a core comprising a resin and a dye. In that regard, a combination of a resin forming the interior (core, designated 4) of the colored microparticle (3) and a thermoplastic resin 2 (binding resin) is not specifically limited, resulting in greater freedom of material. Further, a shelling resin which is the same with respect to each of the four colors of a toner (namely, yellow, magenta, cyan and black), enables manufacturing under similar manufacturing conditions, leading to an enhanced advantage in cost. Transfer of a dye as a colorant to the outside of the colored microparticles (bleeding-out) is prevented, causing no concern of sublimation of a dye or oil staining caused in the fixing stage which often occurs in toners using dyes.

(Manufacturing Method of Colored Microparticles)

Next, there will be described manufacture of colored microparticles, which is one of preferable embodiment of the invention, as below.

Colored microparticles relating to the invention can be obtained in the following manner, for example. A resin and a dye (or further a resin, high boiling point solvent, additive etc.) are dissolved (or dispersed) in an organic solvent and emulsified in water, followed by removal of the organic solvent (referred to a drying in liquid method) to obtain colored microparticles. When covering the colored microparticles with a shelling resin (shell), an ethylenically unsaturated polymerizable monomer is added to the colored microparticles and emulsion polymerization is performed in the presence of an activator to allow a resin to deposit onto the core surface to obtain colored microparticles having a core/shell structure. Alternatively, an aqueous dispersion of resin microparticles is formed through emulsion polymerization. Subsequently, the aqueous dispersion is mixed with a dye dissolved in an organic solvent to allow the dye to be impregnated within the resin microparticles to obtain colored microparticles. Further, the thus obtained colored microparticles may be shelled by various methods.

The shell is preferably comprised of organic resin. Shelling is performed, for example, in such a manner that a resin dissolved in organic solvent is dropwise added to allow the resin to adsorb onto the surface of colored microparticles, concurrently with deposition. In the invention, shelling is performed preferably in such a manner that colored microparticles containing a colorant and a resin are formed as a core, and then, an ethylenically unsaturated polymerizable monomer is added thereto and emulsion polymerization is performed in the presence of an activator to achieve deposition on the core surface simultaneously with polymerization to form a shell.

(Core Shell/Structure)

In the invention, the core/shell structure refers to a form in which at least two kinds of resin exist with being phase-separated, together with a dye. Accordingly, the core may be covered completely or only partially with a shell. A part of resin forming the shell may be allowed to enter the interior of the core. Further, at least one layer differing in composition may be located between the core and the shell to form a multilayer structure.

In one preferred embodiment of the invention, colored microparticles each form a core/shell structure, comprising a core of a colored portion formed of a resin and a dye within the colored microparticles and a shell covering the core with a shelling resin.

(Resin for Core)

There will be described resin forming the interior (core) of colored microparticles relating to the invention.

Resins usable for the interior (core) of the colored microparticles may be any one which is different in composition from the foregoing thermoplastic resin and examples thereof include a (meth)acrylate resin, polyester resin, polyamide resin, polyimide resin, polystyrene resin, polyepoxy resin, amino resin, fluorinated resin, phenol resin, polyurethane resin, polyethylene resin, polyvinyl chloride resin polyvinyl alcohol resin, polyether resin, polyether ketone resin, polyphenylene sulfide resin, polycarbonate resin and aramid resin. Preferred of these resins is a resin obtained by polymerization of ethylenically unsaturated monomers, such as (meth(acrylate resin, polystyrene resin, polyethylene resin, polyvinyl chloride resin and polyvinyl alcohol. Specifically, (meth)acrylate resin and polystyrene resin are preferred.

A (meth)acrylate resin is synthesized by homo-polymerization or copolymerization of various methacrylate type monomers or acrylate monomers and a desired (meth)acrylate resin can be obtained by varying monomer species or a monomer composition. There are also usable resins obtained by copolymerization of a (meth)acrylate monomer with an ethylenically unsaturated copolymerizable monomer except for (meth)acrylate monomers. A blend of a (meth)acrylate resin and other resins is also usable.

Examples of a monomer constituent forming a (meth)acrylate resin include (meth)acrylic acid, methyl(meth)acrylate, ethyl(meth)acrylate, propyl(meth)acrylate, butyl(meth)acrylate, isopropyl(meth)acrylate, stearyl(meth)acrylate, 2-hydroxyethyl(meth)acrylate, acetoacetoxyethyl(meth)acrylate, dimethylaminoethyl(meth)acrylate, 2-hydroxypropyl(meth)acrylate, di(ethylene glycol)ethyl ether(meth)acrylate, ethylene glycol methyl ether(meth)acrylate, isobornyl(meth)acrylate, chloroethyltrimethylammonium(meth)acrylate, trifluoroethyl(meth)acrylate, octafluoropentyl(meth)acrylate, 2-acetoamidomethyl(meth)acrylate, 2-methoxyethyl(meth)acrylate, 2-dimethylaminoethyl(meth)acrylate, 3-trimethoxysilanepropyl(meth)acrylate, benzyl(meth)acrylate, tridecyl(meth)acrylate, 4-hydroxybutyl(meth)acrylate, tetrahydrofurfuryl(meth)acrylate, dodecyl(meth)acrylate, octadecyl(meth)acrylate, 2-ethylaminoethyl(meth)acrylate, 2-ethylhexyl(meth)acrylate, cyclohexyl(meth)acrylate, phenyl(meth)acrylate, and glycidyl(meth)acrylate. Preferred of these are (meth)acrylic acid, methyl(meth)acrylate, ethyl(meth)acrylate, propyl(meth)acrylate, butyl(meth)acrylate, stearyl(meth)acrylate, 2-hydroxyethyl(meth)acrylate, acetoacetoxyethyl(meth)acrylate, benzyl(meth)acrylate, tridecyl(meth)acrylate, dodecyl(meth)acrylate, and 2-ethylhexyl(meth)acrylate.

Styrene resin include, for example, a homopolymer of a styrene monomer, a random copolymer, block copolymer or graft copolymer obtained by copolymerization of a styrene monomer and an ethylenically unsaturated copolymerizable monomer. In addition to the foregoing polymers, a polymer blend or a polymer alloy is also included. Examples of a styrene monomer include styrene; a nuclear-alkylated styrene such as α-methylstyrene, α-ethylstyrene, α-methylstyrene-p-methylstyrene, o-methylstyrene, m-methylstyrene and p-methylstyrene; and a nuclear-chlorinated styrene such as o-chlorostyrene, m-chlorostyrene, p-chlorostyrene, p-bromostyrene, dichlorostyrene, dibromostyrene, trichlorostyrene, and tribromostyrene. Of these is preferred styrene and α-methylstyrene.

Resin usable in the invention can be synthesized by homopolymerization or copolymerization of the foregoing monomers. Examples thereof include copolymeric resin of benzyl methacrylate/ethyl methacrylate or butyl acrylate, copolymeric resin of methyl methacrylate/2-ethyhexyl methacrylate, copolymeric resin of methyl methacrylate/methacrylic acid/stearyl methacrylate/acetoacetoxyethyl methacrylate, copolymeric resin of styrene/acetoacetoxyethyl methacrylate/stearyl methacrylate, copolymeric resin of styrene/2-hydroxyethyl methacrylate/stearyl methacrylate, and copolymeric resin of 2-ethylhexyl methacrylate/2-hydroxyethyl methacrylate.

The number-average molecular weight of a resin usable in the invention is preferably from 500 to 100,000, and more preferably 1,000 to 30,000 in terms of durability and formability of fine particles.

(Shelling Resin)

A shelling resin which covers the core of colored particles to form a shell is not specifically limited and examples thereof include a poly(meth)acrylate resin, polyester resin, polyamide resin, polyimide resin, polystyrene resin, polyepoxy resin, amino resin, fluorinated resin, phenol resin, polyurethane resin, polyethylene resin, polyvinyl chloride resin polyvinyl alcohol resin, polyether resin, polyether ketone resin, polyphenylene sulfide resin, polycarbonate resin and aramid resin. Of these resins, poly(meth)acrylate resin is preferred in terms of combination with a toner-binding resin.

A poly(meth)acrylate resin is synthesized by homo-polymerization or copolymerization of various methacrylate type monomers or acrylate monomers and a desired (meth)acrylate resin can be obtained by varying monomer species or a monomer composition. A poly(meth)acrylate resin may be blended with other resins.

Examples of a monomer constituent forming a (meth)acrylate resin include (meth)acrylic acid, methyl(meth)acrylate, ethyl(meth)acrylate, propyl(meth)acrylate, butyl(meth)acrylate, isopropyl(meth)acrylate, isobutyl(meth)acrylate, t-butyl(meth)acrylate, stearyl(meth)acrylate, 2-hydroxyethyl(meth)acrylate, acetoacetoxyethyl(meth)acrylate, dimethylaminoethyl(meth)acrylate, 2-hydroxypropyl(meth)acrylate, di(ethylene glycol)ethyl ether(meth)acrylate, ethylene glycol methyl ether(meth)acrylate, isobornyl(meth)acrylate, chloroethyltrimethylammonium(meth)acrylate, trifluoroethyl(meth)acrylate, octafluoropentyl(meth)acrylate, 2-acetoamidomethyl(meth)acrylate, 2-methoxyethyl(meth)acrylate, 2-dimethylaminoethyl(meth)acrylate, 3-trimethoxysilanepropyl(meth)acrylate, benzyl(meth)acrylate, tridecyl(meth)acrylate, 4-hydroxybutyl(meth)acrylate, tetrahydrofurfuryl(meth)acrylate, dodecyl(meth)acrylate, octadecyl(meth)acrylate, 2-diethylaminoethyl(meth)acrylate, 2-ethylhexyl(meth)acrylate, cyclohexyl(meth)acrylate, phenyl(meth)acrylate, and glycidyl(meth)acrylate. Preferred of these are (meth)acrylic acid, methyl(meth)acrylate, ethyl(meth)acrylate, propyl(meth)acrylate, butyl(meth)acrylate, stearyl(meth)acrylate, 2-hydroxyethyl(meth)acrylate, acetoacetoxyethyl(meth)acrylate, benzyl(meth)acrylate, tridecyl(meth)acrylate, dodecyl(meth)acrylate, and 2-ethylhexyl(meth)acrylate. Of these are preferred methyl(meth)acrylate, ethyl(meth)acrylate, propyl(meth)acrylate and butyl(meth)acrylate.

The shelling resin usable in the invention may be a copolymer with a reactive emulsifying agent.

(Reactive Emulsifying Agent)

Reactive emulsifying agents usable in the invention may be anionic or nonionic ones but compounds containing any one of the following substituents A, B and C:

A: a straight chain alkyl, branched alkyl, substituted or unsubstituted aromatic substituent group having at least 6 carbon atoms,

B: a nonionic or anionic substituent group displaying surface active capability, and

C: a polymerizable group capable of performing radical polymerization.

Examples of a straight chain alkyl group of “A” include heptyl, octyl, nonyl, decyl and dodecyl. Examples of a branched alkyl group include 2-ethylhexyl. Examples of an aromatic group include phenyl, nonylphenyl and naphthyl.

Examples of a nonionic or anionic substituent group displaying emulsifying capability (surface active capability) of “B” include polyethylene oxide, polypropylene oxide and a copolymer of alkylene oxides. Examples of an anionic substituent group include a carboxylic acid, phosphoric acid, sulfonic acid and their salts. A polyalkylene oxide having the foregoing anionic substituent group at the end-position is one of anionic substituent groups. The substituent group of “B” is preferably an anionic group and more preferably one forming a salt at the end position.

The polymerizable group capable of performing radical polymerization of “C” is a group capable of causing polymerization or cross-linking reaction by a radical-active species, and examples thereof include a group having an ethylenically unsaturated bond, such as vinyl group, allyl group, 1-propenyl group, isopropenyl group, acryl group, methacryl group, maleimide group, acrylamide group, and styryl group.

A reactive emulsifying agent usable in the invention is a compound represented by the following formula (A), (B) or (C):

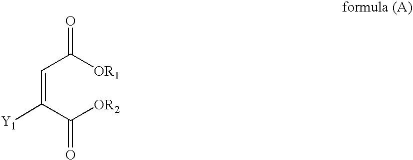

wherein R₁ is a straight chain alkyl, branched alkyl, or substituted or unsubstituted aromatic group having 6 to 20 carbon atoms, for example, a straight chain alkyl group such as heptyl, octyl, nonyl, decyl and dodecyl; a branched alkyl group such as 2-ethylhexyl; an aromatic group such as phenyl, nonylphenyl and naphthyl; R₂ is a group containing a polymerizable group capable of performing radical polymerization, as described in the foregoing “C”, such as acryl, methacryl or maleimide group; Y is sulfonic acid, carboxylic acid or their salts.

Compounds of formula (A) can be readily synthesized by methods known in the art and are also commercially available, including, for example, LATEMUL S-120, LATEMUL S-120A, LATEMUL S-180 and LATEMUL S-180A, produced by Kao Corporation; Eleminol JS-2, produced by Sanyo Chemical Industries, Ltd.

Formula (B) is represented as below:

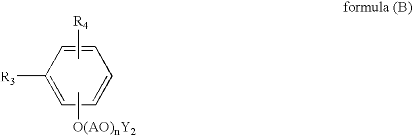

wherein R₃ is the same as defined in R₁ of formula (A), R₄ is the same as defined in R₂ of formula (A), Y is a hydrogen atom, sulfonic acid, carboxylic acid or their salts, and AO represents an alkylene oxide.

Compounds of formula (B) can be readily synthesized by methods known in the art and are also commercially available, including, for example, NE-series of ADEKA REASOAP NE-10, ADEKA REASOAP NE-20 and ADEKA REASOAP NE-30, SE-series of ADEKA REASOAP SE-10N, ADEKA REASOAP SE-20N and ADEKA REASOAP SE-30N, which as all available from ASAHI DENKA KOGYO K. K.; RN-series of AQUALON RN-10, AQUALON RN-20, AQUALON RN-30, AQUALON RN-50, HS-series of AQUALON HS-05, AQUALON HS-10 and AQUALON HS-20, AQUALON HS-30, and AQUALON BC-series, which are all available from DAIICHI KOGYO SEIYAKU CO., LTD.

Formula (C) is represented as below:

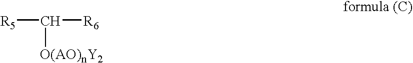

wherein R₅ is the same as defined in R₁ of formula (A), R₆ is the same as defined in R₂ of formula (A), Y₃ is the same as defined in Y₁ of formula (A) and AO is the same as defined in AO of formula (B).

Compounds of formula (C) can be readily synthesized by methods known in the art and are also commercially available, including, for example, AQUALON KH-05, AQUALON KH-10 and AQUALON KH-20, which are available from DAIICHI KOGYO SEIYAKU CO., LTD.

In the foregoing formulas (B) and (C), the average polymerization degree of an alkylene oxide chain (AO) is preferably from 1 to 10, and examples thereof include AQUALON KH-05, AQUALON KH-10, AQUALON HS-05 and AQUALON HS-10, which are available from DAIICHI KOGYO SEIYAKU CO., LTD.

In the invention, the reactive emulsifying agent is preferably an anionic one and examples thereof include ADEKA REASOAP SE-series (available from ASAHI DENKA KOGYO K. K., AQUALON HS-series, available from DAIICHI KOGYO SEIYAKU CO., LTD., LATEMUL S-series, available from Kao Corp. and ELEMINOL JS-series, available from SANYO CHEMICAL INDUSTRIES, LTD.

In the invention, the foregoing reactive emulsifying agent is used usually at 0.1 to 80 parts by weight, preferably 1 to 70 parts by weight, and more preferably 10 to 60 parts by weight per 100 parts by weight of whole resin forming colored microparticles.

(Surfactant)

Conventional anionic surfactants and/or nonionic emulsifying agent (surfactant) may be employed, if necessary, for emulsification in the course of manufacturing dye solid dispersion or colored microparticles relating to the invention.

Examples of conventional nonionic emulsifying agents include polyoxyethylene alkyl ethers such as polyoxyethylene lauryl ether and polyoxyethylene stearyl ether; polyoxyethylene alkylphenyl ethers such as polyoxyethylene nonylphenyl ether; sorbitan higher fatty acid esters such as sorbitan monolaurate, sorbitan monostearate, and sorbitan trioleate; polyoxyethylene sorbitan higher fatty acid esters, such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymer.

Examples of conventional anionic emulsifying agents include higher fatty acid salts such as sodium oleate, alkylarylsulfonates such as sodium dodecylbenzenesulfonate, alkyl sulfuric acid esters such as sodium laurylsulfate, polyoxyethylene alkyl ether sulfuric acid ester salts such as polyethoxyethylene lauryl ether sulfuric acid sodium salt, polyoxyethylene alkylaryl ether sulfuric acid esters such as polyoxyethylene nonylphenyl ether sulfuric acid sodium salt, alkyl sulfosuccinic acid ester salts such as monooctyl sulfosuccinic acid sodium salt, dioctyl sulfosuccininc acid sodium salt, and polyoxyethylene laurylsulfosuccininc acid sodium salt, and derivatives of the foregoing.

(Dye)

There will be now described dyes contained in the dye solid dispersion or colored microparticles used in the invention.

Metal chelate dyes represented by formula (1) relating to the invention may be used alone or in combination with other dyes. Generally known dyes are usable in this invention, and coloring materials are preferably oil-soluble dyes. Usually, oil-soluble dyes which do not contain any water-solubilizing group such as a carboxylic acid or sulfonic acid group, are soluble in organic solvents and not soluble in water, but a dye obtained by salt-formation of a water-soluble dye with a long chain base and thereby being soluble in oil, is also included. There are known, for example, an acid dye, a direct dye and a salt formation dye of a reactive dye with a long chain amine.

Specific examples thereof are described below but are not limited to these: Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue 2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, Oil Black 5905, which are all available from Orient Chemical Industries, Ltd.;
Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, Kayaset Blue K-FL, which are all available from NIPPON KAYAKU CO., LTD.;
FS Yellow 1015, FS Magenta 1404, FS cyan 1522, FS Blue 1504, C.I. Solvent Yellow 88, 83, 82, 79, 56, 29, 19, 16, 14, 04, 03, 02, and 01; C.I. Solvent Red 84:1, C.I. Solvent Red 84, 218, 132, 73, 72, 51, 43, 27, 24, 18, and 01; Solvent Blue 70, 67, 44, 40, 35, 11, 02, and 01; C.I. Solvent Black 43, 70, 34, 29, 27, 22, 7, 3, and 3; C.I. Solvent Violet 3; C.I. Solvent Green 3 and 7; Plast Yellow DY352, Plast Red 8375, which are available from Arimoto Chemical Co., Ltd.;
MS Yellow HD-180, MS Red G, MS Magenta HM-1450H, MS Blue HM-1384, which are available from Mitsui Chemicals, Inc.; ES Red 3001, ES Red 3002, ES Red 3003, TS Red 305, ES Yellow 1001, ES Yellow 1002, Ts Yellow 118, ES Orange 2001, ES Blue 6001, TS Turq Blue 618, which are available from SUMITOMO CHEMICAL CO., LTD.;
MACROLEX Yellow 6G, Ceres Blue, GNNEOPAN Yellow 075, Ceres Blue GN, MACROLEX Red and Violet R, which as available from Bayer Co.

Disperse dyes are also usable as an oil-soluble dye, examples thereof include C.I. Disperse Yellow 5, 42, 54, 64, 79, 82, 83, 93, 99, 100, 119, 122, 124, 126, 160, 184:1, 186, 198, 199, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; C.I. Disperse green 6:1 and 9.

In addition, phenol, naphthols; cyclic methylene compounds such as pyrazolone and pyrazolotriazole, couplers such as ring-opening methylene compounds, p-diaminopyridines, azomethine dyes and indoaniline dyes are also preferably usable as an oil-soluble dye.

(Particle Diameter)

The volume-average particle size of the colored microparticles relating to this invention is preferably 10-100 nm. A volume-average particle size of less than 10 nm markedly increases a surface area per unit volume and decreases inclusion of a dye into resin of the colored microparticle, deteriorating stability of colored microparticles and leading to deteriorated storage stability. A volume-average particle size exceeding 100 nm easily causes sedimentation of particles, leading to deteriorated pot-life.

The volume-average particle size can be determined by the dynamic light scattering method, laser diffraction method, centrifugal sedimentation method, FFF method or electric detector method. In this invention determination in the dynamic light scattering method using “Zeta Sizer” (produced by Malvern Instruments Ltd.) is preferable.

(Thermoplastic Resin)

Thermoplastic resin contained in the electrophotographic toner of the invention is preferably one which is adhesive onto colored microparticles and is also soluble in solvents. There is also usable a thermosetting resin capable of forming a three-dimensional structure, a precursor of which is solvent-soluble. Any thermoplastic resin usable as a binding resin for a toner is usable but is preferably a styrene resin, an acrylate resin such as alkyl acrylate or alkyl methacrylate resin, a styrene-acryl copolymeric resin, a polyester resin, a silicone resin, an olefin resin, an amide resin and an epoxy resin. To enhance transparency and color reproduction of an overlapped image is required a resin having enhanced transparency and exhibiting melt characteristics of a low melt viscosity and also sharp melting characteristic. Suitable resins exhibiting such characteristics include styrene resin, acryl resin and polyester resin.

A binding resin preferably exhibits a number-average molecular weight (Mn) of 3,000 to 6,000 (preferably, 3,500 to 5,500), a ratio of weight-average molecular weight (Mw) to number-average molecular weight (Mn), Mw/Mn of 2 to 6 (preferably, 2.5 to 5.5), a glass transition temperature of 50 to 70° C. (preferably, 55 to 70° C.), and a softening temperature of 90 to 110° C. (preferably, 90 to 105° C.).

A number-average molecular weight of a binding resin of less than 3,000 often causes image defects such as peeling in the imaging area upon bending a solid image (deterioration in bending fixability), while that of more than 6,000 results in lowered heat-fusibility in fixing, leading to deteriorated fixability. A Mw/Mn of less than 2 often causes off-set, while that of more than 6 results in lowered sharp melt characteristics, leading to lowered light-transmittance of a toner and deteriorated color mixture property at the time of full color image formation.

A glass transition temperature of less than 50° C. results in insufficient heat resistance, easily causing coagulation of toner particles during storage, while that of more than 70° C. results in difficulty in melting, leading to lowered fixability and deteriorated color-mixing property in full color image formation a softening temperature of less than 90° C. easily causes high-temperature offset, while that of more than 110° C. results in deterioration in fixing strength, light-transmission, color-mixing property and glossiness of a full-color image.

(Toner)

In addition to the foregoing thermoplastic resin and colored microparticles, a charge control agent or a off-set preventing agent known in the art may be incorporated to the toner of this invention.

Charge control agents usable in this invention are not specifically limited. As a negative charge control agent used for color toners are usable colorless, white or light color charge control agents. Preferred example thereof include zinc or chromium metal complex of salicylic acid derivatives, carixarene compounds, organic borane compounds, and fluorine-containing quaternary ammonium salt compounds. There are usable salicylic acid metal complexes described, for example, in JP-A Nos. 53-127726 and 62-145255; carixarene compounds described, for example, in JP-A No. 2-201378; organic borane compounds described, for example, in JP-A Nos. 2-221967 and 3-1162.

Such a charge control agent is used preferably in an amount of 0.1 to 10 parts by weight per 100 parts by weight of thermoplastic resin (binding resin), and more preferably 0.5 to 5.0 parts by weight.

Off-set preventing agents usable in this invention are not specifically limited and specific examples thereof include polyethylene wax, oxidation type polyethylene wax, polypropylene wax, oxidation type polypropylene wax, carnauba wax, sazole wax, rice wax, candelilla wax, jojoba wax, and bees wax. Such a wax is used preferably in an amount of 0.5 to 5.0 parts by weight per 100 parts by weight of thermoplastic resin, and more preferably 1.0 to 3.0 parts by weight. An amount of less than 0.5 part by weight results in insufficient effects and an amount of more than 5 parts by weight results in lowered light-transmittance and color reproduction.

Using a thermoplastic resin (binder resin), colored microparticles and other desired additives, the toner of this invention can be manufactured by commonly known methods such as a kneading and grinding method, suspension polymerization method, emulsion polymerization method, emulsion granulation method, or capsulation method. Of the foregoing methods, taking into account the decrease of the toner particle size along with enhancement of image quality, the emulsion polymerization method is preferable in terms of manufacturing cost and manufacturing stability.

A thermoplastic resin emulsion prepared by emulsion polymerization is mixed with a dispersion of toner particle components such as colored microparticles. While maintaining balance between repulsion force of the particle surface, formed by pH adjustment and aggregation force due to addition of an electrolyte, aggregation is gradually performed. Association is performed with controlling the particle size and the particle size distribution, while stirring with heating. Thereby, fusion of microparticles and particle shape control are conducted to manufacture the toner particles. The volume-average particle size of the toner relating to this invention is preferably 4-10 μm in terms of high precise image reproduction, and more preferably 6 to 9 μm.

In this invention, the thus prepared toner particles may be used as it is, but preferably, Post-treatment agents may be incorporated to the toner particles to control electrostatic charge or enhance fluidity or cleaning ability. Examples of such post-treatment agents include inorganic oxide particles such as particulate silica, particulate alumina, and particulate titania, inorganic stearate compound particles such particulate aluminum stearate or particulate zinc stearate, and inorganic titanate compound particles such as strontium titanate or zinc titanate. These additives may be used singly or in combination. These particles are desirably used together with a surface treatment of a silane coupling agent, titan coupling agent, higher fatty acid or silicone oil in terms of environmental resistance stability and heat resistance maintenance. The post-treatment agent is incorporated preferably in an amount of 0.05 to 5 parts by weight per 100 parts by weight of toner particles, and more preferably from 0.1 to 3 parts by weight.

The electrophotographic toner of the invention may be mixed with a carrier and used as a toner used for a two-component developer, or may be used as a toner used for a single-component developer.

Conventional carriers used for a two-component developer can be used in combination with the electrophotographic toner of this invention. There can be used, for example, a carrier composed of magnetic material particles such as iron or ferrite, a resin-coated carrier formed by covering magnetic material particles with resin and a binder type carrier obtained by dispersing powdery magnetic material in a binder. Of these carriers, the use of a resin-coated carrier using silicone resin, copolymer resin (graft resin) of an organopolysioxane and a vinyl monomer or polyester resin is preferred from the viewpoint of toner spent and the like. Specifically, a carrier coated with a resin which is obtained by reacting isocyanate with a copolymer resin of an organopolysiloxane and a vinyl monomer, is preferred in terms of fastness, ecological concerns and resistance to spent toner. A monomer containing a substituent such as a hydroxyl group having reactivity with an isocyanate needs to be used as the above-described vinyl monomer. The volume-average particle size of a carrier is preferably 20 to 100 μm (more preferably 20 to 60 μm) to maintain high image quality and prevent a carrier from fogging.

(Image Formation Method)

Next, there will be described an image formation method using the electrophotographic toner of the invention.

In the invention, the system of image formation is not specifically limited. Examples thereof include a system in which plural images are formed on a photoreceptor and transferred all together, a system in which an image formed on a photoreceptor is successively transferred using a transfer belt and is not specifically limited to such, of which the system in which plural images are formed on a photoreceptor and transferred all together is preferred.

In this system, the photoreceptor is uniformly charged and exposed according to the first image and the first development is performed to form the first toner image on the photoreceptor. Subsequently, the photoreceptor having formed the first toner image is uniformly charged, exposed according to the second image and the second development is performed to the second toner image. Further, the photoreceptor having formed the first and second toner images is uniformly charged, exposed according to the third image and the third development is performed to form the third toner image on the photoreceptor. Furthermore, the photoreceptor having formed the first, second and third toner images is uniformly charged, exposed according to the fourth image and the fourth development is performed to form the fourth toner image on the photoreceptor.

In the foregoing, the first development is performed with a yellow toner, the second development is performed with a magenta toner, the third development is performed with a cyan toner and the fourth development is performed with a black toner to form a full color image. Thereafter, images formed on the photoreceptor are transferred all together to a transfer material such as paper and fixed on the transfer material to form images.

In this system, images formed on the photoreceptor are transferred all together to paper or the like to form the final image, so that differing from a so-called intermediate system, the transfer, which often perturbs the previous images, is done only one time, resulting in enhanced image quality.

Since a plural number of development processes need to be performed to develop latent images formed on the photoreceptor, a non-contact development system is preferred. A system in which an alternant electric field is applied during development, is also preferable.

In the system in which overlaid color images are formed on a photoreceptor and transferred all together, a non-contact development system is preferred.

The volume-average particle size of a carrier usable as two-component developer is preferably 15 to 100 μm to maintain high image quality and prevent a carrier from fogging. The volume-average particle size of the carrier can be determined using a laser diffraction type particle size distribution measurement apparatus, HELOS (produced by SYMPATEC Corp.).

The carrier usable in the invention is preferably a resin-covered carrier or a so-coated resin dispersion type carrier in which magnetic particles are dispersed in resin. Resin used for coating is not specifically limited with respect to composition but, for example, olefin resin, styrene resin, styrene/acryl resin silicone resin, polyester resin and fluorinated resin are usable. Resin constituting the resin dispersion type carrier includes, for example, styrene/acryl resin, polyester resin, fluorinated resin and phenol resin.

Suitable fixing systems usable in this invention include a so-called contact heating system. Representative examples of the contact heating system include a heat roll fixing system and a pressure heat-fixing system in which fixing is performed using a rolling pressure member including a fixed heating body.

(Image)

In the image formation process to perform development, transfer and fixing by using a toner of this invention, the toner transferred onto a transfer material adheres onto the paper surface without colored microparticles being disintegrated, even after fixing.

In conventional toners obtained by directly dispersing or dissolving a dye in a thermoplastic resin (binding resin), the dye bleeds out onto the toner particle surface, producing the following problems:
1) low charging,
2) marked difference in charging between high temperature and high humidity, and low temperature and low humidity
3) the charging amount varying depending on the kind of dye as a colorant, for example, when using pigments of cyan, magenta, yellow and black in full color recording. However, in this invention, colored microparticles are dispersed within the toner particle so that in spite of the toner particle having the dye at a relatively high content, the dye does not bleed out on the particle surface, overcoming the foregoing problems.

Further, when thermally fixed onto a transfer material, transport of a dye as colorant to the outside of the colored microparticles (bleeding-out onto the surface of the colored microparticle) does not result and does not produce problems sublimation of a dye or oil staining during thermal fixing, as tends to be caused with conventional toners.

### EXAMPLES

The invention is described in detail below referring examples by the invention is not limited to the examples.

An example of synthesizing method of the compound represented by Formula 1 is described below and another compound can be similarly synthesized but the synthesizing method is not limited to that.

### Example 1

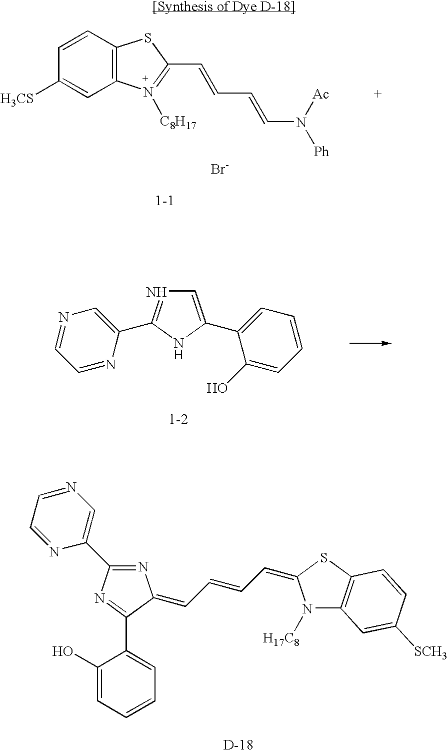

Four point nine two grams of Compound 1-1, 1.91 g of Compound 1-2, 0.85 g of potassium acetate anhydrous and 20 ml of methanol were mixed and stirred at 60° C. for 3.5 hours. After cooling by standing, water was added and extracted by ethyl acetate and the organic layer was washed. After that the organic layer was washed by a saturated aqueous solution of sodium hydrogen carbonate and then by a saturated aqueous solution of sodium chloride. The organic layer was dried by anhydrous magnesium sulfate and then filtered, and the solvent was distillated out under reduced pressure. The resultant residue was purified by silica gel column chromatography using a solvent of a 95:5 mixture of ethyl acetate and methanol. Thus 0.81 g of D-18 was obtained. It was confirmed by MASS, ¹H-NMR and IR spectrum that the resultant substance was the objective substance.

### Example 2

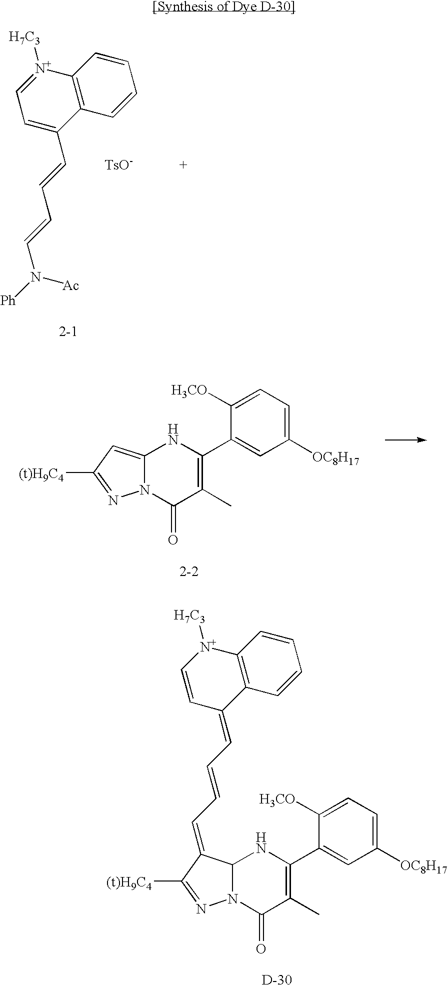

Two point nine one grams of Compound 2-1, 2.20 g of Compound 2-2, 0.54 g of potassium acetate anhydrous and 22 ml of methanol were mixed and refluxed for 3 hours. After cooling by standing, water was added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered and then the solvent was distillated out under reduced pressure. Thus obtained residue was purified by silica gel column chromatography using a solvent of a 95:5 mixture of ethyl acetate and methanol. Thus 1.09 g of D-30 was obtained. It was confirmed by MASS, ¹H-NMR and IR spectrum that the resultant substance was the objective substance.

### Example 3

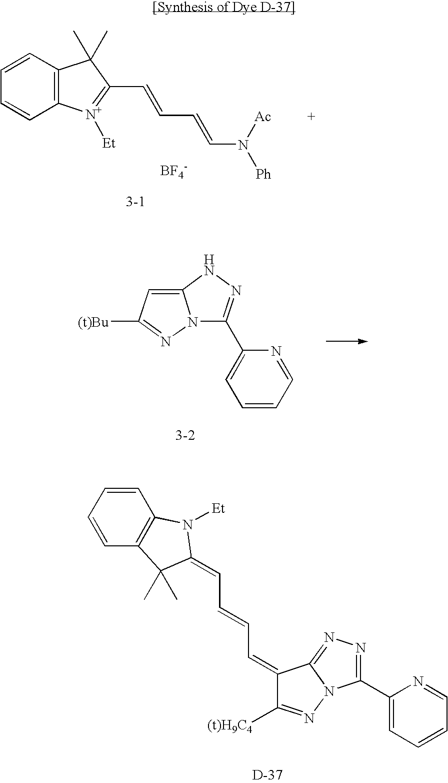

One point nine three grams of Compound 3-1, 1.69 g of Compound 3-2, 0.76 g of potassium acetate anhydrous and 20 ml of ethanol were mixed and stirred at 60° C. for 3.5 hours. After cooling by standing, water was added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered, and then the solvent was distillated out under reduced pressure. Thus obtained residue was purified by silica gel column chromatography using a solvent of a 95:5 mixture of ethyl acetate and methanol. Thus 0.81 g of D-37 was obtained. It was confirmed by MASS, ¹H-NMR and IR spectrum that the resultant substance was the objective substance.

### Example 4

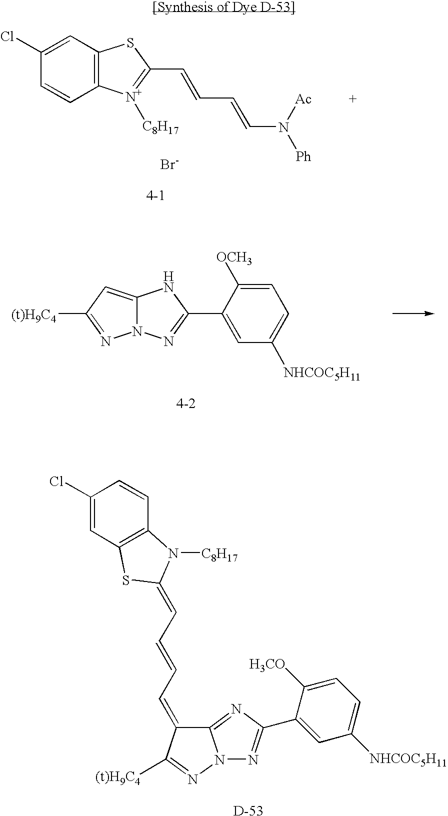

Compound 4-1 in amount of 4.22 g, 2.68 g of Compound 4-2, 0.76 g of potassium acetate anhydrous and 30 ml of ethanol were mixed and stirred at 60° C. for 3.5 hours. After cooling by standing, water added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered, and then the solvent was distillated out under reduced pressure. Thus obtained residue was purified by silica gel column chromatography using a solvent of a 93:7 mixture of ethyl acetate and methanol. Thus 1.15 g of D-53 was obtained. It was confirmed by MASS, ¹H-NMR and IR spectrum that the resultant substance was the objective substance.

### Example 5

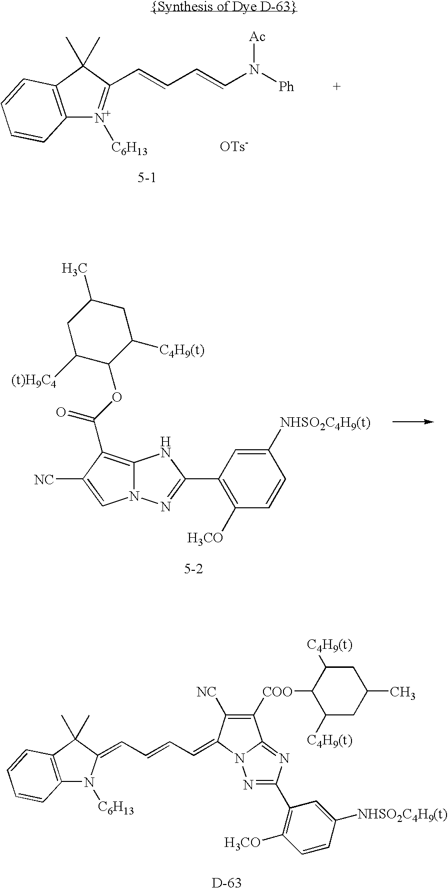

Three point eight seven grams of Compound 5-1, 2.94 g of Compound 5-2, 0.65 g of potassium acetate anhydrous and 30 ml of methanol were mixed and stirred, and heated and refluxed for 2 hours. After cooling by standing, water was added to the mixture and extracted by ethyl acetate, and the organic layer was washed by water, a saturated aqueous solution of sodium hydrogen carbonate and then by a saturated aqueous solution of sodium chloride. After that, the organic layer was dried by magnesium sulfate anhydrous and filtered and then the solvent was distillated out under reduced pressure. Thus obtained residue was purified by silica gel column chromatography using a solvent of a 95:5 mixture of ethyl acetate and methanol. Thus 1.14 g of D-63 was obtained. It was confirmed by MASS, ¹H-NMR and IR spectrum that the resultant substance was the objective substance.

### Example 6

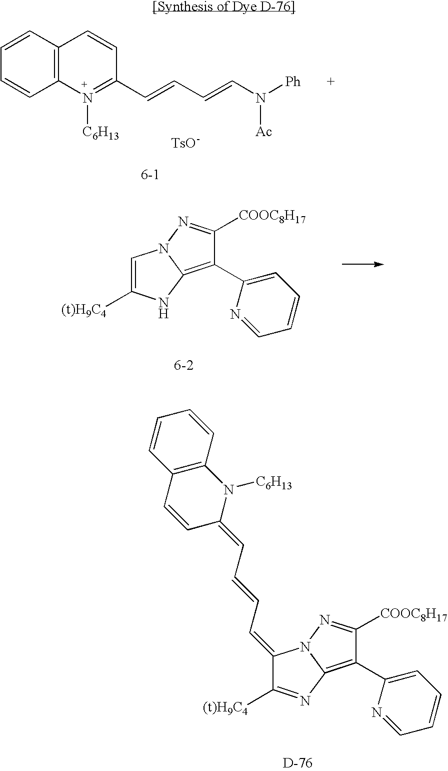

Three point seven seven grams of Compound 6-1, 2.38 g of Compound 6-2, 0.65 g of potassium acetate anhydrous and 25 ml of methanol were mixed and stirred, and fluxed by heating for 3 hours. After cooling by standing, water was added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered, and then the solvent was distillated out under reduced pressure. Thus obtained residue was purified by silica gel column chromatography using a solvent of a 95:5 mixture of ethyl acetate and methanol. Thus 1.23 g of D-76 was obtained. It was confirmed by MASS, ¹H-NMR and IR spectrum that the resultant substance was the objective substance.

### Example 7

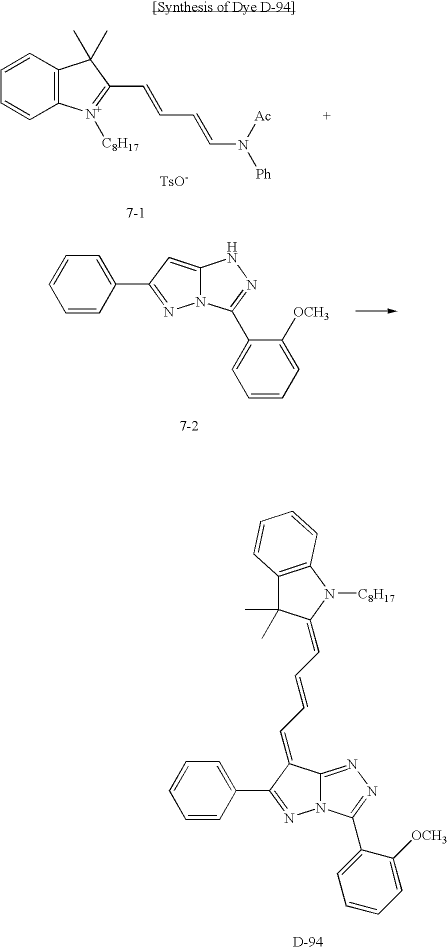

Three point six nine grams of Compound 7-1, 1.74 g of Compound 7-2, 0.59 g of potassium acetate anhydrous and 37 ml of methanol were mixed and stirred, and refluxed by heating for 3 hours. After cooling by standing, water was added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered, and then the solvent was distillated out under reduced pressure. Thus obtained residue was purified by silica gel column chromatography using a solvent of a 95:5 mixture of ethyl acetate and methanol. Thus 1.10 g of D-94 was obtained. It was confirmed by MASS, ¹H-NMR and IR spectrum that the resultant substance was the objective substance.

### Example 8

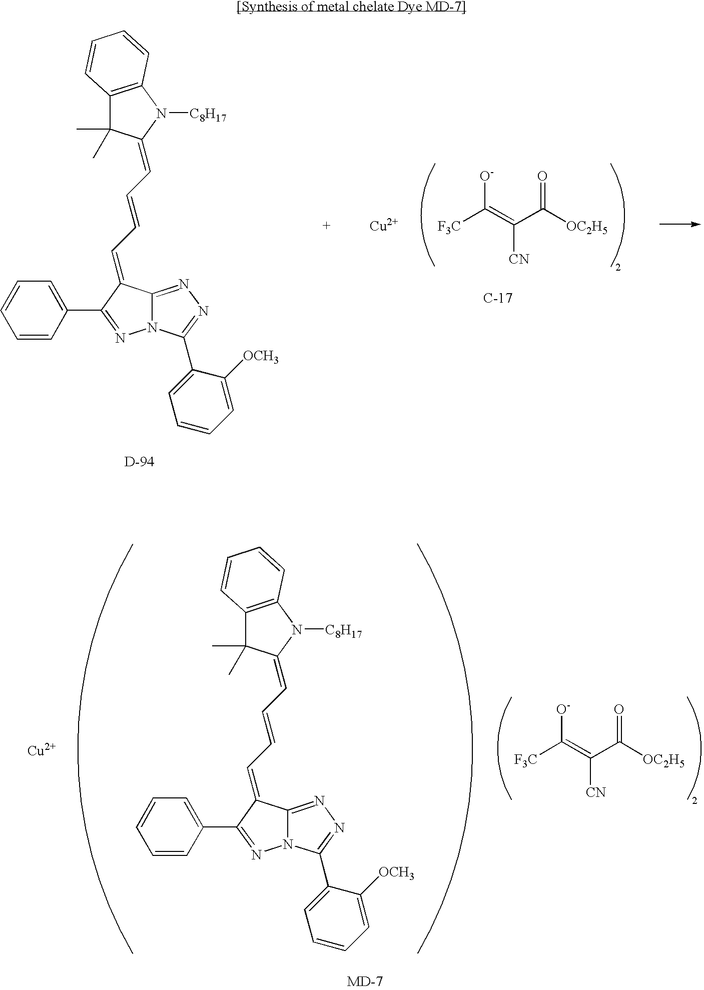

To 0.598 g of Dye D-10, 5 ml of methanol was added, heated and stirred for dissolving the dye and a solution of 0.480 g of Copper Compound C-17 dissolved in 2.5 ml of ethyl acetate was dropped spending 5 minutes and stirred for 1 hour at room temperature. The reaction liquid was concentrated and then dissolved in 20 ml of ethyl acetate, and neutralized, washed and concentrated. Thus 0.97 g of Metal Chelate Dye MD-7 was obtained. It was confirmed by elemental analysis that the obtained compound was the objective substance. The maximum absorption wavelength and molar absorption coefficient of ethyl acetate solution of the compound was 631 nm and 170,000, respectively.

### Example 9

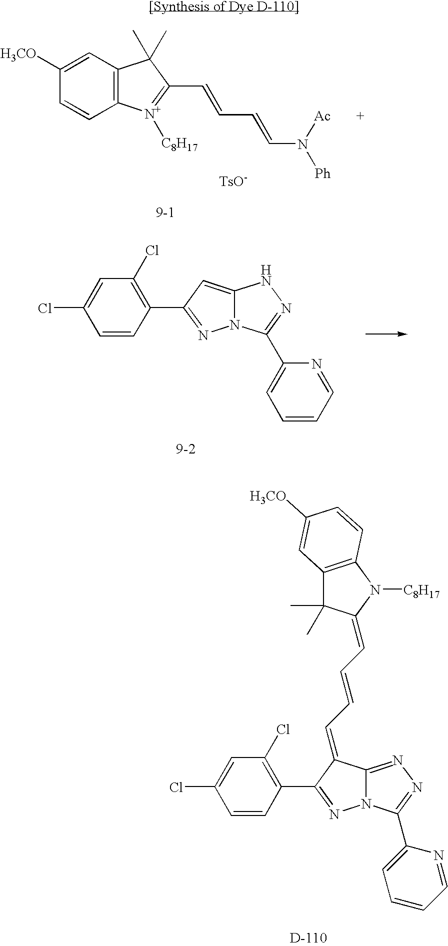

Four point five one grams of Compound 9-1, 2.31 g of Compound 9-2, 0.69 g of potassium acetate anhydrous and 45 ml of methanol were mixed and stirred, and refluxed by heating for 3 hours. After cooling by standing, water was added to the mixture and extracted by ethyl acetate and the organic layer was washed by water, a saturated aqueous solution of sodium hydrogen carbonate and then by a saturated aqueous solution of sodium chloride. After that, the organic layer was dried by magnesium sulfate anhydrous and filtered and then the solvent was distillated out under reduced pressure. Thus obtained residue was purified by silica gel column chromatography using a solvent of a 95:5 mixture of ethyl acetate and methanol. Thus 1.21 g of D-110 was obtained. It was confirmed by MASS, ¹H-NMR and IR spectrum that the resultant substance was the objective substance.

### Example 10

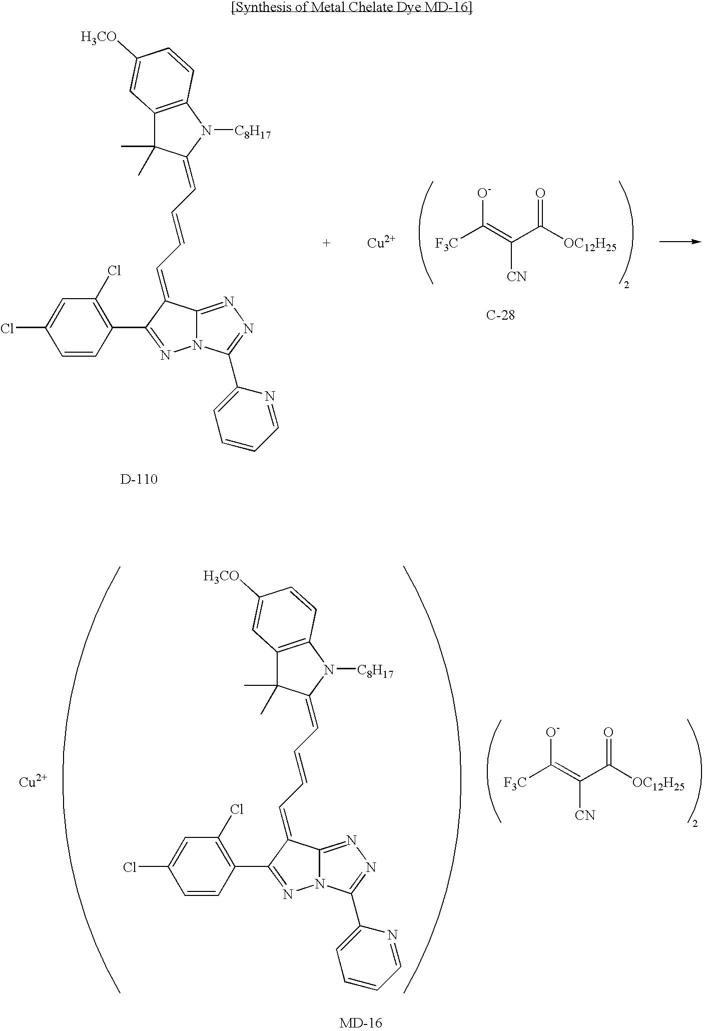

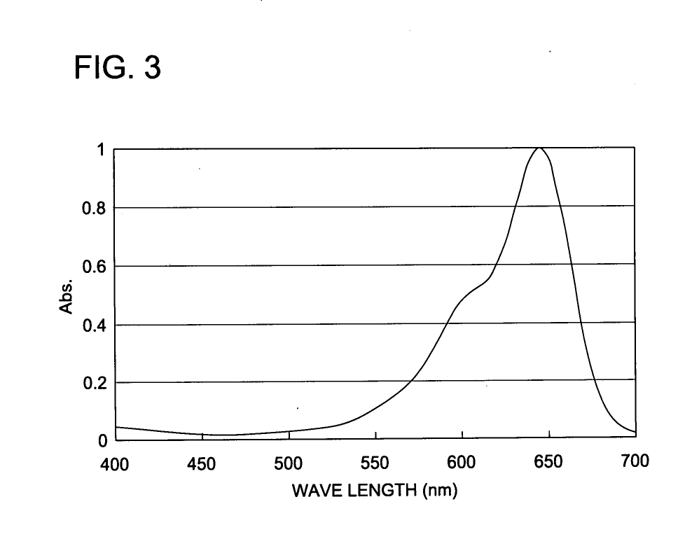

To 1.0 g of Dye D-110, 10 ml of methanol was added, heated and stirred for dissolving the dye and a solution of 1.14 g of Copper Compound C-28 dissolved in 6 ml of ethyl acetate was dropped spending 5 minutes and stirred for 1 hour at room temperature. The reaction liquid was concentrated and then dissolved in 20 ml of ethyl acetate, and neutralized, washed and concentrated. Thus 1.87 g of Metal Chelate Dye MD-16 was obtained. It was confirmed by elemental analysis that the obtained compound was the objective substance. The maximum absorption wavelength and molar absorption coefficient of ethyl acetate solution of the compound was 646 nm and 150,000, respectively. The shape of absorption curve of Metal Chelate Dye MD-16 is shown in FIG. 3.

### Example 11

[Preparation of Toner]

### Preparation Example 1

### Preparation of Colored Fine Particle Dispersion 1

Into a stainless steel beaker, 3.0 g of Dye A-1 and 80 g of an aqueous solution containing 3.0 g of a 27% solution of surfactant EM-27, manufactured by Kao Co., Ltd., were charged and stirred by Ultraturax UTC, manufactured by IKA Co., Ltd., and then dispersed for 3 hours by medium type stirring machine SLC-12, manufactured by Getzman Co., Ltd. of Germany, using zirconia beads having a diameter of 0.5 mm. Thus Colored Fine Particle Dispersion 1 was obtained.

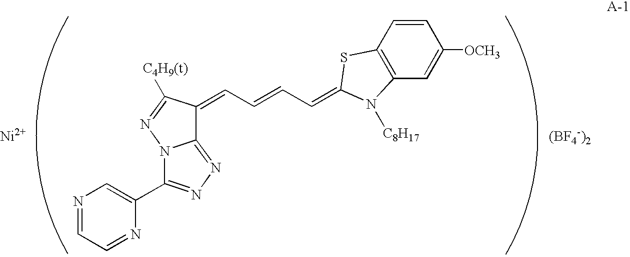

### Preparation Example 2

### Preparation of Colored Fine Particle Dispersion 2

Into a separable flask, 3.0 g of Dye A-1 and 50.0 g of ethyl acetate were charged and air in the flask was replaced by nitrogen and the mixture was stirred for dissolving the dye. After that, 80.0 g of an aqueous solution containing 3.0 g of a 27% solution of surfactant EM-27C, manufactured by Kao Co., Ltd., was dropped and stirred and then emulsified for 5 minutes by a ultrasonic dispersing machine UH-600, manufactured by S.M.T. Co., Ltd. Next, ethyl acetate was removed under reduced pressure to obtain Colored Fine Particle Dispersion 2.

### Preparation Example 3

### Preparation of Colored Fine Particle Dispersion 3

Colored Fine Particle Dispersion 3 was prepared in the same manner as in Preparation Example 1 except that 3.0 g of Dye A-1 was replaced by 1.26 g of D-38 and 1.74 g of Copper Compound C-28 was added.

### Preparation Example 4

### Preparation of Colored Fine Particle Dispersion 4

Colored Fine Particle Dispersion 4 was prepared in the same manner as in Preparation Example 2 except that 3.0 g of Dye A-1 was replaced by 1.26 g of D-38 and 1.74 g of Copper Compound C-28 was added.

### Preparation Example 5

### Preparation of Colored Fine Particle Dispersion 5

Colored Fine Particle Dispersion 5 was prepared in the same manner as in Preparation Example 2 except that 3.0 g of Dye A-1 was replaced by 1.26 g of D-3 and 1.74 g of Copper Compound C-23 was added.

### Preparation Examples 6 to 27

### Preparation of Colored Fine Particle Dispersions 6 to 27

Colored Fine Particle Dispersions 6 to 27 were prepared in the same manner as in Preparation Example 5 except that Dye D-3 and Copper Compound C-23 were changed as listed in Table 3.

The kind of the dye and that of the copper compound and the mole ratio of them are listed in Table 3.

TABLE 3

| Colored fine | Presence | | | |
|---|---|---|---|---|
| particle | of ethyl | | Copper | |
| dispersion No. | acetate | Dye | compound | Remarks |
| 1 | None | A-1 | — | Comparative |
| 2 | Presence | A-1 | — | Comparative |
| 3 | None | D-38 | C-28 | Inventive |
| 4 | Presence | D-38 | C-28 | Inventive |
| 5 | Presence | D-3 | C-23 | Inventive |
| 6 | Presence | D-12 | C-26 | Inventive |
| 7 | Presence | D-17 | C-30 | Inventive |
| 8 | Presence | D-21 | C-11 | Inventive |
| 9 | Presence | D-28 | C-29 | Inventive |
| 10 | Presence | D-35 | C-25 | Inventive |
| 11 | Presence | D-41 | C-3 | Inventive |
| 12 | Presence | D-47 | C-20 | Inventive |
| 13 | Presence | D-49 | C-18 | Inventive |
| 14 | Presence | D-56 | C-19 | Inventive |
| 15 | Presence | D-63 | C-17 | Inventive |
| 16 | Presence | D-66 | C-9 | Inventive |
| 17 | Presence | D-70 | C-16 | Inventive |
| 18 | Presence | D-72 | C-28 | Inventive |
| 19 | Presence | D-77 | C-10 | Inventive |
| 20 | Presence | D-87 | C-21 | Inventive |
| 21 | Presence | D-92 | C-20 | Inventive |
| 22 | Presence | D-93 | C-12 | Inventive |
| 23 | Presence | D-96 | C-25 | Inventive |
| 24 | Presence | D-110 | C-28 | Inventive |
| 25 | Presence | D-112 | C-15 | Inventive |
| 26 | Presence | D-115 | C-27 | Inventive |
| 27 | Presence | D-120 | C-24 | Inventive |

### Preparation Example 28

### Preparation of Colored Fine Particle Dispersion 28

Into a separable flask, 13.5 g of Resin P-1 having the following composition, 16.0 g of Dye A-1 and 123.5 g of ethyl acetate were charged and air in the flask was replaced by nitrogen, and the mixture was stirred for dissolving the dye. After that, 238 g of an aqueous solution containing 0.8 g of Aqualon KH-05, manufactured by Daiichi Kogyo Seiyaku Co., Ltd., was dropped and stirred and then emulsified for 300 seconds by Clearmix W Mortion CLM-0.8W, manufactured by M Tech Co., Ltd. Next, ethyl acetate was removed under reduced pressure to obtain core type dye-impregnated Colored Fine Particle Dispersion 28.

Resin P-1: St/HEMA/SMA=30/40/30

St: Styrene

HEMA: 2-hydroxyethyl methacrylate

SMA: Stearyl methacrylate

### Preparation Example 29

### Preparation of Colored Fine Particle Dispersion 29

To the core type dye-impregnated colored fine particle dispersion prepared in Preparation Example 28, 0.5 g of potassium persulfate was further added and heated by 70° C. by a heater and reacted for 5 hours while dropping 10 g of methyl methacrylate to obtain core/shell type Colored Fine Particle Dispersion 29.

### Preparation Example 30

### Preparation of Colored Fine Particle Dispersion 30

Core type Colored Fine Particle Dispersion 30 was obtained in the same manner as in Preparation Example 28 except that 16.0 g of Dye A-1 was replaced by 9.46 g of D-44 and 9.62 g of Copper Compound C-18 was added.

### Preparation Example 31

### Preparation of Colored Fine Particle Dispersion 31

Core/shell type Colored Fine Particle Dispersion 31 was obtained in the same manner as in Preparation Example 29 except that 16.0 g of Dye A-1 was replaced by 9.46 g of D-44 and 9.62 g of Copper Compound C-18 was added.

### Preparation Examples 32 to 50

### Preparation of Colored Fine Particle Dispersions 32 to 50

Core/shell type Colored Fine Particle Dispersions 32 to 50 were obtained in the same manner as in Preparation Example 31 except that D-44 and Copper Compound C-18 were changed as shown in Table 4.

Kind of dye and copper compound and the molar ratio of them in Colored Fine Particle Dispersions 28 to 50 are listed in Table 4.

TABLE 4

| Colored fine | | | | | |
|---|---|---|---|---|---|
| particle | Resin | Resin | | Copper | |
| dispersion No. | (Core) | (Shell) | Dye | compound | Remarks |
| 28 | P-1 | — | A-1 | — | Comparative |
| 29 | P-1 | MMA | A-1 | — | Comparative |
| 30 | P-1 | — | D-44 | C-18 | Inventive |
| 31 | P-1 | MMA | D-44 | C-18 | Inventive |
| 32 | P-1 | MMA | D-19 | C-29 | Inventive |
| 33 | P-1 | MMA | D-22 | C-17 | Inventive |
| 34 | P-1 | MMA | D-26 | C-20 | Inventive |
| 35 | P-1 | MMA | D-27 | C-10 | Inventive |
| 36 | P-1 | MMA | D-40 | C-22 | Inventive |
| 37 | P-1 | MMA | D-43 | C-2 | Inventive |
| 38 | P-1 | MMA | D-48 | C-28 | Inventive |
| 39 | P-1 | MMA | D-54 | C-18 | Inventive |
| 40 | P-1 | MMA | D-55 | C-24 | Inventive |
| 41 | P-1 | MMA | D-62 | C-17 | Inventive |
| 42 | P-1 | MMA | D-65 | C-25 | Inventive |
| 43 | P-1 | MMA | D-69 | C-34 | Inventive |
| 44 | P-1 | MMA | D-88 | C-5 | Inventive |
| 45 | P-1 | MMA | D-91 | C-28 | Inventive |
| 46 | P-1 | MMA | D-111 | C-30 | Inventive |
| 47 | P-1 | MMA | D-114 | C-27 | Inventive |
| 48 | P-1 | MMA | D-103 | C-28 | Inventive |
| 49 | P-1 | MMA | D-106 | C-7 | Inventive |
| 50 | P-1 | MMA | D-108 | C-29 | Inventive |

### Preparation of Thermoplastic Resin (Latex)

Into a separable flask on which a stirrer, thermal sensor, cooling pipe and nitrogen introducing device were attached, a surfactant solution (aqueous medium) composed of 2760 g of deionized water and 7.08 g of an anionic surfactant (sodium benzenesulfonate SDS) dissolved therein was previously charged and the interior temperature was raised by 80° C. while stirring at 230 rpm under nitrogen atmosphere.

Besides, 72.0 g of the compound represented by the following Formula 1 was added to a monomer mixture liquid composed of 115.1 g of styrene, 42.0 g of n-butyl acrylate and 10.9 g of methacrylic acid and dissolved by heating by 80° C. to prepare a monomer solution. The monomer solution (80° C.) was dispersed in the surfactant solution (80° C.) by a mechanical dispersing machine having a circulation pass to prepare a dispersion of emulsified particles (oil particles) having uniform particle diameter. To the resultant dispersion, a polymerization initiator solution (potassium persulfate KPS) composed of 0.84 g of the polymerization initiator and 200 g of deionized water was added, and heated and stirred for 3 at 80° C. for carrying out polymerization (1^{st} step polymerization) to prepare a latex. After that, an initiator solution composed of 7.73 g of the polymerization initiator (KPS) and 240 ml of deionized water was added to the latex. After standing for 15 minutes, a monomer mixture liquid composed of 383.6 g of styrene, 140.0 g of n-butyl acrylate, 36.4 g of methacrylic acid and 13.7 g of t-dodecylmercaptane was dropped into the latex spending 126 minutes. After completion of dropping, the system was heated and stirred for 60 minutes for carrying out polymerization (2^{nd} step polymerization) and then cooled by 40° C. Thus a latex was prepared. The latex was referred to as Latex 1.

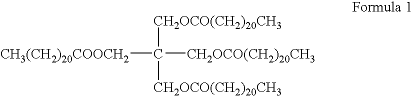

[Preparation of Toner Particle 1]

Into a 5 L four-mouthed flask on which a thermal sensor, cooling pipe, nitrogen introducing device and stirrer, 1,250 g of Latex 1 prepared in the above preparation example of thermoplastic resin (latex), 2,000 g of deionized water and the above Colored Fine Particle Dispersion 1 were charged and stirred. After adjusting interior temperature to 30° C., pH of the mixture was adjusted to 10.0 by adding a 5M sodium hydroxide aqueous solution, and a solution composed of 52.6 g of magnesium chloride hexahydrate and 72 ml of deionized water was added spending 10 minutes at 30° C. while stirring. After standing for 3 minutes, the system was heated by 90° C. spending 6 minutes at a rate of 10° C./minute. The diameter of the associated particle was measured in such the situation by Coulter Counter TA-11 and the growing of particle was stopped by adding a solution composed of 115 g of sodium chloride and 700 g of deionized water when the volume average particle diameter became 6.5 μm. After that, the fusion of particle was continued by heating and stirring for 6 hours at a liquid temperature of 90±2° C., and cooled by 30° C. at a rate of 6° C./minute.

The associated particles were separated by filtration from the above dispersion and the particles were washed by re-dispersing in deionized water (pH=3) in an amount of 10 times of the whole amount of the associated particles and separated by filtration from the washing water. Such the treatment was repeated two times. After that, the particles were finally washed by only deionized water and dried by air warmed at 40° C. to prepare toner particles. Thus obtained toner particles were referred to as Toner Particle 1.

[Preparation of Toner Particles 2 to 27]

Toner Particles 2 to 27 were prepared in the same manner as in Toner Particle 1 except that the Colored Fine Particle Dispersion 1 was replaced by each of Colored Fine Particle Dispersions 2 to 27, respectively.

[Preparation of Toner Particles 28 to 50]

Toner Particles 28 to 50 were prepared in the same manner as in Toner Particle 1 except that the Colored Fine Particle Dispersion 1 was replaced by each of Colored Fine Particle Dispersions 28 to 50, respectively.

[Preparation of Toner Particle 51]

A low molecular weight polypropylene dispersion was prepared by emulsifying low molecular weight polypropylene having a number average molecular weight of 3,200 in water using a surfactant while heating so that the solid content in the dispersion became 30% by weight. Sixty grams of the above low molecular weight polypropylene dispersion, 3.338 g of the colored fine particle dispersion were mixed and 220 g of styrene monomer, 40 g of n-butyl acrylate monomer, 12 g of methacrylic acid monomer, 5.4 g of t-dodecylmercaptane as chain transferring agent and 2,000 ml of deaerated pure water were added. The resultant mixture was held at 70° C. for 3 hours while stirring for carrying out emulsion polymerization.

The pH value of the resultant resin fine particle dispersion was adjusted to 7.0 by adding sodium oxide and then 700 g of a 2.7 mole-% aqueous solution of potassium chloride was added to the dispersion, and 420 ml of isopropyl alcohol and 23.4 g of polyoxyethylene octylphenyl ether (average polymerization degree of ethylene oxide=10) dissolved in 175 g of purified water were further added. The dispersion was held at 75° C. for 6 hours while stirring for progressing reaction, and then cooled by 30° C. at a rate of 6° C./minute. The particles were separated by filtration from the above dispersion and the particles were washed by re-dispersing in deionized water (pH=3) in an amount of 10 times of the whole amount of the associated particles and separated by filtration from the washing water. Such the treatment was repeated two times. After that, the particles were finally washed by only deionized water and dried by warmed air at 40° C. to prepare toner particles. Thus obtained toner particles were referred to as Toner Particle 51.

{Preparation of Comparative Toner Particle 52}

Colored Fine Particle Dispersion 52 was prepared in the same manner as in Preparation Example 1 except that Dye A-1 was replaced by C.I. Pigment Red 48:3, manufactured by Clariant in Japan Co., Ltd.

Toner Particle 52 was prepared in the same manner as in Toner Particle 51 except that Colored Fine Particle Dispersion 3 was replaced by Colored Fine Particle Dispersion 52.

[Preparation of Comparative Toner Particle 53]

A toner particle was prepared in the same manner as in Toner Particle 51 except that the dye was replaced by C.I. Pigment Blue 15:3, manufactured by Dainippon Ink & Chemicals Incorporated. Thus obtained toner particle was referred to as Toner Particle 53.

[Preparation of Developer]

To each of Toner Particles 1 to 53, 1% by weight of hydrophobic silica (number average primary particle diameter=12 nm, hydrophobicity=68) and 1.2% by weight of hydrophobic titanium oxide (number average primary particle diameter=12 nm, hydrophobicity=68) were added and mixed by a Henschel mixer to prepare toners. These toners were referred to Toners 1 to 53 corresponding to the toner particles, respectively.

Each of the above obtained toners was mixed with a ferrite carrier having a volume average particle diameter of 60 μm to prepare developers having a toner concentration of 6%. These toners were referred to Developers 1 to 53 corresponding to the toners, respectively.

[Apparatus and Conditions for Evaluation]

Toners 1 to 53 were each subjected to practical printing test using a digital copying machine Konica 7075, manufactured by Konica Minolta Business Technologies Co., Ltd., which was modified as follows, and high grade paper (64 g/m²) or transparent sheet for OHP as the image transfer medium.

<Electrical Charging of Photoreceptor>

Surface potential of photoreceptor: −700 V

<Developing Conditions>

DC bias: −500 V

Dsd (Distance between photoreceptor and developing sleeve): 600 μm

Developer layer regulation: Magnetic H-Cut system

Thickness of developer layer: 700 μm

Diameter of developing sleeve: 40 mm

<Fixing Device>

A heating roller fixing system was utilized as the fixing device. In concrete, a heating roller was constituted by an aluminum cylindrical core (internal diameter=40 mm, thickness=1.0 mm and whole width=310 mm) having a heater at the central portion and a tube of tetrafluoroethylene perfluoroalkylvinyl ether with a thickness of 120 μm covering the surface of the core, and a pressing roller was constituted by a iron cylindrical core (internal diameter=40 mm, thickness=2.0 mm) and silicon rubber sponge covering the core surface. The heating roller and the pressing roller were contacted with a load of 150 N to form a nip of 8 mm width.

In the fixing device, the line speed was set at 480 mm/sec. As the cleaning mechanism of the fixing device, a system supplying polydiphenyl silicone having a viscosity of 10 Pa·s at 20° C. by a web impregnated with the silicone was used. The fixing temperature was controlled at 175° C. according to the roller surface temperature. The coating amount of the silicone oil was 0.1 mg per A4 size of the medium.

[Evaluation of Properties]

Thus obtained print was evaluated about (1) color reproducibility, (2) transparency, (3) electric chargeability, (4) anti-offset ability and (5) light fastness. In the norms of evaluation, ranks A, B and C were acceptable and D was unacceptable.

(1) Color Reproducibility

The color reproducibility was evaluated about a monocolor image printed on high grade paper by visual observation by 10 monitors according to the following norms. The evaluation was carried out about the image having an adhering amount of the toner within the range of 0.7±0.05 mg/cm². Results of the evaluation are listed in the following Tables 5 and 6.

A: The color reproducibility was excellent.

B: The color reproducibility was good.

C: Color contamination was observed a little but any problem was not caused for practical use at such the level.

D: The color contamination was large and a problem was caused on the image quality.

(2) Transparency

A fixed transparent image was prepared on the OHP sheet as a transparent image transfer medium. The spectral transmittance of visual light of the image was measured by an automatic spectrophotometer, manufactured by Hitachi Seisakusho Co., Ltd., using the OHP sheet without any toner image as the reference. Difference between the spectral transmittance at 650 nm and that at 450 nm as to the yellow toner, that between 650 nm and 550 nm as to the magenta toner and that between 500 nm and 600 nm were each determined and the transparency of OPH image was ranked as follows. The evaluation was carried out about the image having a adhering amount of toner within the range of 0.7±0.05 mg/cm².

A: Not less than 90%

B: Not less than 80% and less than 90%

C: Not less than 70% and less than 80%

D: Less than 70%

(3) Electric Chargeability

Electric charging amount at the first print after setting the developer Qa and that after 1,000,000th print Qb were measured and the variation of charging amount during the passing time was evaluated by the ratio of Qb/Qa according to the following norms.

A: Not less than 0.9 and less than 1.1

B: Not less than 0.8 and less than 0.9 or not less than 1.1 and less than 1.2

C: Not less than 0.7 and less than 0.8 or not less than 1.2 and less than 1.3

D: Less than 0.7 or not less than 1.3

(4) Anti-Offset Ability

The anti-offset ability was evaluated as follows. High quality paper was used as the image transfer medium. Ten thousands sheets of A4 size high grade paper carrying a 5 mm width band-shaped solid image formed in the vertical direction to the conveying direction were conveyed in the length direction for fixing the image. After that, ten thousand sheets of A4 size sheets having a 20 mm width halftone image formed in the vertical direction were continuously conveyed and fixed in the width direction and then the machine was rest at once. The machine was restarted and contamination on the firstly passed paper by the offset was visually evaluated according to the following norms.

A: No contamination was observed on the image.

B: Contamination was slightly observed on the image but no problem was caused for practical use.

C: Contamination was posed a little.

D: Contamination was posed so as not to be acceptable for practical use.

(5) Light Fastness

As to the light fastness, density Ci of an image was measured just after printing and then the image was irradiated by xenon light (85,000 Lux) for 10 days by a weather meter Atlas C.165. After that the image density Cf was measured and the remaining ratio of the dye, {(Ci−Cf)/Ci}×100%, was calculated from the difference of the image density of before and that after the irradiation by xenon light. The image density was measured by a reflective densitometer X-Rite 310TR.

Evaluation results are listed in Tables 5 and 6.

TABLE 5

| | | | | | Light | |
|---|---|---|---|---|---|---|
| | | | | | fastness | |
| | | | | Anti- | (Dye | |
| Developer | Color | | Electric | offset | remaining | |
| No. | reproducibility | Transparency | chargeability | ability | ratio) | Remarks |
| 1 | C | C | C | C | 50 | Comp. |
| 2 | C | B | B | C | 53 | Comp. |
| 3 | A | B | B | B | 81 | Inv. |
| 4 | A | A | B | A | 83 | Inv. |
| 5 | B | B | B | A | 62 | Inv. |
| 6 | C | B | B | A | 58 | Inv. |
| 7 | B | B | B | A | 64 | Inv. |
| 8 | B | A | B | A | 72 | Inv. |
| 9 | B | A | B | A | 70 | Inv. |
| 10 | C | B | B | A | 59 | Inv. |
| 11 | A | A | B | A | 80 | Inv. |
| 12 | A | A | B | A | 75 | Inv. |
| 13 | B | B | B | A | 70 | Inv. |
| 14 | B | B | B | A | 72 | Inv. |
| 15 | B | B | B | A | 78 | Inv. |
| 16 | B | B | B | A | 72 | Inv. |
| 17 | B | B | B | A | 65 | Inv. |
| 18 | B | B | B | A | 70 | Inv. |
| 19 | A | A | B | A | 76 | Inv. |
| 20 | A | A | B | A | 90 | Inv. |
| 21 | A | A | B | A | 91 | Inv. |
| 22 | A | A | B | A | 86 | Inv. |
| 23 | A | A | B | A | 90 | Inv. |
| 24 | A | A | B | A | 85 | Inv. |
| 25 | A | A | B | A | 87 | Inv. |
| 26 | A | A | B | A | 86 | Inv. |
| 27 | A | A | B | A | 90 | Inv. |

Comp.: Comparative,
Inv.: Inventive

TABLE 6

| | | | | | Light | |
|---|---|---|---|---|---|---|
| | | | | | fastness | |
| | | | | Anti- | (Dye | |
| Developer | Color | | Electric | offset | remaining | |
| No. | reproducibility | Transparency | chargeability | ability | ratio) | Remarks |
| 28 | B | B | B | B | 52 | Comp. |
| 29 | B | B | A | A | 53 | Comp. |
| 30 | A | A | B | A | 83 | Inv. |
| 31 | A | A | A | A | 83 | Inv. |
| 32 | B | A | A | A | 65 | Inv. |
| 33 | B | A | A | A | 74 | Inv. |
| 34 | B | A | A | A | 73 | Inv. |
| 35 | B | B | A | A | 62 | Inv. |
| 36 | A | A | A | A | 81 | Inv. |
| 37 | A | A | A | A | 77 | Inv. |
| 38 | A | A | A | A | 82 | Inv. |
| 39 | B | A | A | A | 68 | Inv. |
| 40 | B | A | A | A | 70 | Inv. |
| 41 | B | A | A | A | 66 | Inv. |
| 42 | B | A | A | A | 73 | Inv. |
| 43 | B | B | A | A | 68 | Inv. |
| 44 | A | A | A | A | 86 | Inv. |
| 45 | A | A | A | A | 92 | Inv. |
| 46 | A | A | A | A | 91 | Inv. |
| 47 | A | A | A | A | 82 | Inv. |
| 48 | A | A | A | A | 92 | Inv. |
| 49 | A | A | A | A | 87 | Inv. |
| 50 | A | A | A | A | 91 | Inv. |
| 51 | B | A | B | A | 83 | Inv. |
| 52 | D | D | B | B | 85 | Comp. |
| 53 | D | D | B | B | 95 | Comp. |

Comp.: Comparative,
Inv.: Inventive

It is understood from the evaluation results that the toners of the invention containing the metal chelate formable dye represented by Formula 1 and the copper compound represented by Formula 2 are excellent in the transparency, anti-offset ability and light fastness so that the high quality images can be surly formed. Among them, Developers 3, 4, 11, 12, 19 to 27, 30, 31, 36 to 38 and 44 to 50 are superior in the color reproducibility.

Developers 20 to 27 and 44 to 50 each containing the metal chelate formable dye represented by Formula 18 are superior in the light fastness and display that the metal chelate dyes according to the invention are excellent in the light fastness.

1. An electrophotographic toner comprising a dye chelatable with a metal represented by the formula (1), a copper compound represented by the formula (2) and a thermoplastic resin: 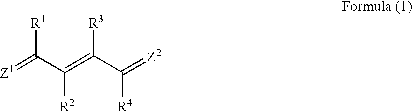
wherein R¹, R², R³, and R⁴ each represents a hydrogen atom or a substituent, Z¹ represents a 5 or 6-membered heterocyclic ring containing at least one nitrogen atom, provided that the heterocyclic ring may have a substituent or form a condensed ring, and Z² represents a 5 or 6-membered heterocyclic ring, provided that the heterocyclic ring may have a substituent or form a condensed ring;
Cu²⁺(X₁)ₘ(X₂)ₙ.W₁ Formula (2)
wherein X₁ and X₂ are each a monodentate or didentate ligand, provided that X₁ and X₂ may link with each other which may be the same or different from each other, n and m are each an integer of 0 to 2, and W₁ is a counter ion when a counter ion is required for neutralization of charge.

2. The electrophotographic toner of claim 1, wherein Z¹ is represented by formula (3) or formula (4), 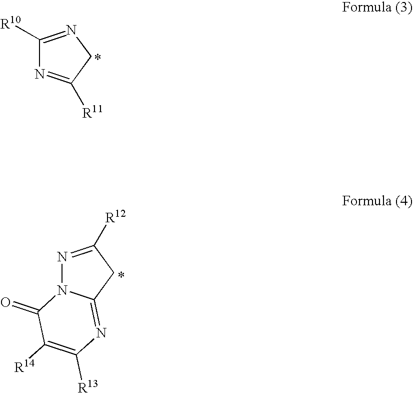
wherein R¹⁰, R¹¹, R¹², R¹³ and R¹⁴ each represents a hydrogen atom or a substituent, and at least one of R¹⁰ and R¹¹ is a group capable of forming a two- or more-dentate bond with a nitrogen atom in the formula (3), at least one of R¹² and R¹³ is a group capable of forming a two- or more-dentate bond with a nitrogen atom in the formula (4), and * shows a position to bond with a carbon atom bonding to the dye represented by formula (1).

3. The electrophotographic toner of claim 1, wherein Z¹ is represented by formula (5) or (6), 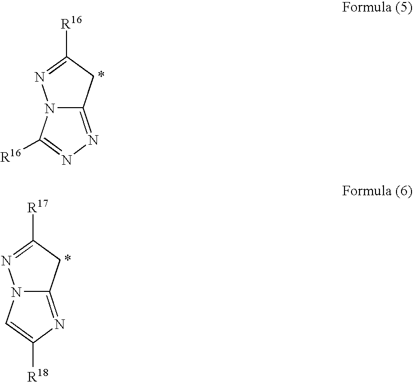
wherein R¹⁵, R¹⁶, R¹⁷ and R¹⁸ each represents a hydrogen atom or a substituent, and at least one of R¹⁵ and R¹⁶ is a group capable of forming a two- or more-dentate bond with a nitrogen atom in the formula (5), at least one of R¹² and R¹³ is a group capable of forming a two- or more-dentate bond with a nitrogen atom in the formula (6), and * shows a position to bond with a carbon atom bonding to the dye represented by formula (1).

4. The electrophotographic toner of claim 1, wherein Z¹ is represented by formula (5) or (6), 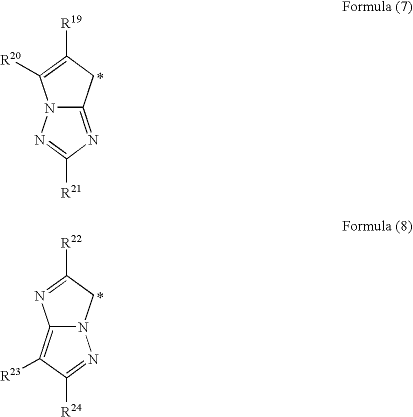
wherein R¹⁹, R²⁰, R²¹, R²², R²⁴ and R²⁴ each represents a hydrogen atom or a substituent, and at least one of R²⁰ and R²¹ is a group capable of forming a two- or more-dentate bond with a nitrogen atom in the formula (7), at least one of R²², R²³ and R²⁴ is a group capable of forming a two- or more-dentate bond with a nitrogen atom in the formula (6), and * shows a position to bond with a carbon atom bonding to the dye represented by formula (1).

5. The electrophotographic toner of claim 1, wherein Z¹ is represented by formula (9), 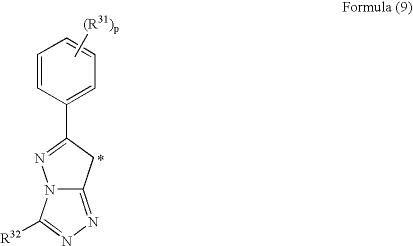
wherein R³¹ and R³² each represents a hydrogen atom or a substituent, and at least one of R³¹ and R³² is a group capable of forming a two- or more-dentate bond with a nitrogen atom in the formula (9), p is an integer of 0 to 5, and * shows a position to bond with a carbon atom bonding to the dye represented by formula (1).

6. The electrophotographic toner of claim 2, wherein the group capable of forming a two- or more-dentate bond with the nitrogen atom is represented by formula (10) or (11), 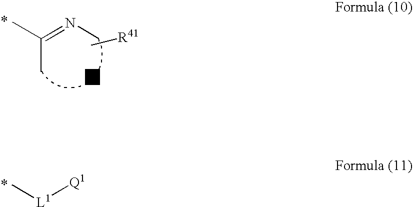
wherein Z³ is an atomic group necessary to form a 5- or 6-membered nitrogen-containing heterocyclic ring together with a nitrogen atom, R⁴¹ represents a hydrogen atom or a substituent, L¹ is a linkage group having one or two carbon atoms or a part of a ring structure, and Q¹ is a hydroxyl, alkoxy, aryloxy, alkylsulfonylamino, or arylsulfonylamino group.

7. The electrophotographic toner of claim 1, wherein Z² in the formula (1) is represented by the formula (12) to (16). 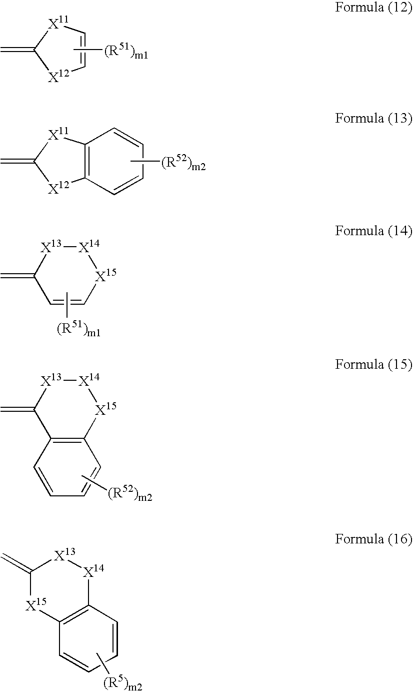
wherein R⁵¹ and R⁵² are each a hydrogen atom or a substituent, m1 is an integer of 0 to 2, m2 is an integer of 0 to 4, X¹¹ and X¹² are each an oxygen or sulfur atom, —(NR⁵³)— or —CR⁵⁴R⁵⁵—, at least one of X¹¹ and X¹² is —(NR⁵³)—, R⁵³, R⁵⁴ and R⁵⁵ each a hydrogen atom or a substituent, X¹³, X¹⁴ and X¹⁵ are each an oxygen or sulfur atom, —(NR⁵⁶)— or —C(R⁵⁷)═, at least one of X¹¹ and X¹² is an oxygen or sulfur atom, or —(NR⁵⁶)—, and R⁵⁶ and R⁵⁷ are each a hydrogen atom or a substituent.

8. The electrophotographic toner of claim 1, wherein R¹, R², R³, and R⁴ each represents a hydrogen or halogen atom, or an alkyl group having 1-8 carbon atoms, aryl group, heteroaryl group, acyl group, amino group or alkoxy group.

9. The electrophotographic toner of claim 1, wherein at least one of X1 and X2 is represented by the formula (17), 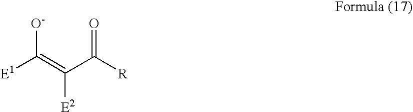
wherein E₁ and E₂ are each an electron-withdrawing group exhibiting a Hammett substituent constant (σp) of 0.1 to 0.9; and R is an alkyl group, an aryl group, a heterocyclic group, an alkoxy group or an amino group, which may be substituted with a substituent.

10. The electrophotographic toner of claim 9, wherein E₁ and E₂ are each an electron-withdrawing group exhibiting a Hammett substituent constant (σp) of 0.35 or more.

11. The electrophotographic toner of claim 9, wherein E¹ and E² is a halogenated alkyl group, carbonyl group, cyano group, alkoxycarbonyl group, alkylsulfonyl group or alkylsulfonyloxy group.

12. The electrophotographic toner of claim 9, wherein R is an alkyl group, alkoxy group, or amino group.

13. The electrophotographic toner of claim 12, wherein R is an alkyl group or alkoxy group.

14. The electrophotographic toner of claim 1, wherein the thermoplastic resin comprises colored microparticles dispersed in the thermoplastic resin, wherein the colored microparticles contain the dye chelatable with a metal represented by one of the formula (1) and the copper compound represented by the formula (2).

15. The electrophotographic toner of claim 14, wherein the colored microparticles further contains a resin which is different from the thermoplastic resin.

16. The electrophotographic toner of claim 14, wherein the colored microparticles comprise;
a core containing the dye chelatable with a metal represented by one of the formula (1), the copper compound represented by the formula (2), and a resin having different composition from the thermoplastic resin, and
a shell resin covering the core.

17. An image forming method comprising: developing an electrostatic latent image formed on an electrostatic latent image carrying body with a toner to form a toner image and transferring the toner image to a transfer material, wherein the toner is that of claim 1.

18. A dye chelatable with metal represented by formula (18). 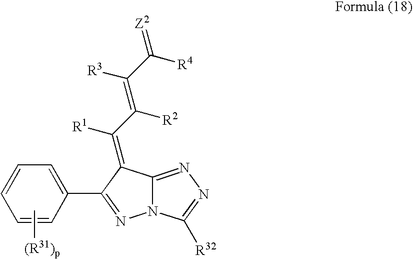
wherein R¹, R², R³, and R⁴ each represents a hydrogen atom or a substituent, Z¹ represents a 5 or 6-membered heterocyclic ring containing at least one nitrogen atom, which heterocyclic ring may have a substituent or form a condensed ring, R³¹ and R³² are each a substituent and at least one of R³¹ and R³² is a group capable of forming a two- or more-dentate bond with a nitrogen atom in the formula (18), and p is an integer of 0-5.

19. A metal chelate dye which contains the dye chelatable with metal represented by the formula (18) as at least one of a ligand.

20. The electrophotographic toner of claim 3, wherein the group capable of forming a two- or more-dentate bond with the nitrogen atom is represented by formula (10) or (11), 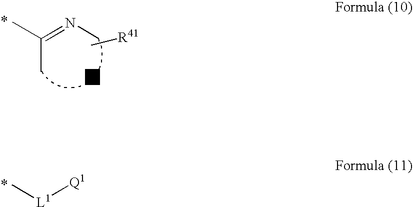
wherein Z³ is an atomic group necessary to form a 5- or 6-membered nitrogen-containing heterocyclic ring together with a nitrogen atom, R⁴¹ represents a hydrogen atom or a substituent, L¹ is a linkage group having one or two carbon atoms or a part of a ring structure, and Q¹ is a hydroxyl, alkoxy, aryloxy, alkylsulfonylamino, or arylsulfonylamino group.

21. The electrophotographic toner of claim 4, wherein the group capable of forming a two- or more-dentate bond with the nitrogen atom is represented by formula (10) or (11), 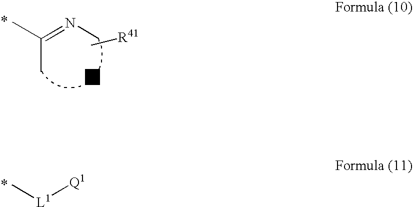
wherein Z³ is an atomic group necessary to form a 5- or 6-membered nitrogen-containing heterocyclic ring together with a nitrogen atom, R⁴¹ represents a hydrogen atom or a substituent, L¹ is a linkage group having one or two carbon atoms or a part of a ring structure, and Q¹ is a hydroxyl, alkoxy, aryloxy, alkylsulfonylamino, or arylsulfonylamino group.
